(19) United States
(12) Patent Application Publication
(10) Pub. No.: US 2017/0155905 A1
(43) Pub. Date: Jun. 1, 2017

(54) EFFICIENT INTRA VIDEO/IMAGE CODING USING WAVELETS AND VARIABLE SIZE TRANSFORM CODING

(71) Applicant: Intel Corporation, Santa Clara, CA (US)

(72) Inventors: Atul Puri, Redmond, WA (US); Neelesh N. Gokhale, Seattle, WA (US)

(21) Appl. No.: 14/954,710

(22) Filed: Nov. 30, 2015

(51) Int. Cl. H04N 19/13; H04N 19/122; H04N 19/129; H04N 19/159; H04N 19/63; H04N 19/169; H04N 19/119; H04N 19/124

(52) U.S. Cl. CPC H04N 19/13; H04N 19/119; H04N 19/122; H04N 19/124; H04N 19/159; H04N 19/63; H04N 19/1883; H04N 19/129

(57) ABSTRACT

Techniques related to intra video frame or image coding using wavelets and variable size transform coding are discussed. Such techniques may include wavelet decomposition of a frame or image to generate subbands and coding partitions of the frame or image or subbands based on variable size transforms.

### CROSS-REFERENCE TO RELATED APPLCATIONS

This application contains subject matter related to U.S. patent application Ser. No. __/______ (Docket No. 01. P91176), titled “EFFICIENT AND SCALABLE INTRA VIDEO/IMAGE CODING USING WAVELETS AND AVC, MODIFIED AVC, VPx, MODIFIED VPx, OR MODIFIED HEVC CODING” filed on Nov. 30, 2015, and U.S. patent application Ser. No. __/______ (Docket No. 01.P91182), titled “EFFICIENT, COMPATIBLE, AND SCALABLE INTRA VIDEO/IMAGE CODING USING WAVELETS AND HEVC CODING” filed on Nov. 30, 2015.

### BACKGROUND

An image or video encoder compresses image or video information so that more information can be sent over a given bandwidth. The compressed signal may then be transmitted to a receiver having a decoder that decodes or decompresses the signal prior to display.

This disclosure, developed in the context of advancements in image/video processing, addresses problem associated with performing improved coding of images and Intra frames of video. Such improved coding may include a combination of efficient coding as well as coding that supports basic scalability. For example, the term efficient coding refers to encoding that provides higher compression efficiency allowing either more images or Intra frames of video of certain quality to be stored on a computer disk/device or to be transmitted over a specified network or the same number (e.g., of images or Intra frames of video) but of higher quality to be stored or transmitted. Furthermore, the term scalable coding here refers to encoding of image or Intra frames of video such that from a single encoded bitstream subsets of it can then be decoded resulting in images or Intra frames of different resolutions. For example, the term basic scalability as it applies to this disclosure refers to the capability of decoding a subset of the bitstream resulting in lower resolution layer image or Intra frames in addition to the capability of decoding a full resolution version from the same bitstream.

With ever increasing demand for capture, storage, and transmission of more images and videos of higher quality with the added flexibility of scalability, it may be advantageous to provide improved compression techniques for images and Intra frames of video. It is with respect to these and other considerations that the present improvements have been needed.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1A illustrates an example application of an analysis filter;

FIG. 1B illustrates an example application of a synthesis filter;

FIG. 1C illustrates an example analysis filtering of a 2D signal;

FIG. 1D illustrates an example synthesis filtering;

FIG. 2A illustrates an example results of applying wavelet filtering to an image or video frame;

FIG. 2B illustrates an example two level decomposition of an image or video frame;

FIG. 3A is a block diagram wavelet based encoder/decoder system;

FIG. 3B illustrates a wavelet 3-level octave decomposition into 10 subbands;

FIG. 3C illustrates a spatial orientation tree;

FIG. 3D illustrates an example SPECK encoding process;

FIG. 3E illustrates an example division of an image or Intra frame;

FIG. 4 is a block diagram of an example JPEG2000 encoder;

FIG. 5A illustrates a block diagram of a next generation Intra coder referred to herein as an Adaptive Variable-size Transform (AVST) Intra Encoder;

FIG. 5B illustrates a block diagram of a standalone AVST Intra decoder corresponding to the AVST Intra encoder of FIG. 5A;

FIG. 6A illustrates a block diagram of an example coder without spatial directional prediction;

FIG. 6B illustrates a block diagram of an example decoder without spatial prediction;

FIG. 7A illustrates example features of an AVST encoder relevant to encoding of a wavelet LL subband;

FIG. 7B illustrates example features of an AVST* encoder relevant to encoding of HL, LH and HH subbands;

FIG. 7C illustrates example features of an AVST decoder relevant to decoding of wavelet LL subband;

FIG. 7D illustrates example features of an AVST* decoder relevant to decoding of wavelet HL, LH and HH subbands;

FIG. 8A illustrates a block diagram of an example combined wavelet AVST (WAVST) coder;

FIG. 8B illustrates a block diagram of another example combined wavelet AVST (WAVST) coder;

FIG. 8C illustrates a block diagram of another example combined wavelet AVST (WAVST) coder;

FIG. 9A illustrates an example one level decomposition using wavelet analysis filters of a frame of the “Foreman” video sequence into LL, HL, LH and HH subbands;

FIG. 9B illustrates, for each of the four bands, example AVST/AVST* block transform partitioning;

FIG. 10A illustrates a flowchart of an example process of WAVST Intra Encoding;

FIG. 10B illustrates a flowchart of an example process for WAVST Intra Decoding;

FIG. 11A illustrates a functional block diagram of an example WAVST Intra Encoder;

FIG. 11B illustrates a functional block diagram of an example functional standalone WAVST Intra Decoder;

FIG. 12 illustrates an example system 1201 including details of the “Wavelet Analysis Filter” in the WAVST Encoder of FIG. 11A and the “Wavelet Synthesis Filter” in the WAVST Decoder of FIG. 11B;

FIG. 13A illustrates an example system including details of the “Local Buffer and Prediction Analyzer and Generator” and interfaces to the rest of the WAVST Intra Encoder of FIG. 11A;

FIG. 13B illustrates an example system including details of the “Local Buffer and Prediction Generator” and interfaces to the rest of the WAVST Intra Decoder of FIG. 11B;

FIG. 14 illustrates an example system including details of the “Adaptive Square/Rectangular Variable Size Transform: DCT, PHT, DST” module of FIG. 11A and the “Adaptive Square/Rectangular Size Inverse Transform: DCT, PHT, DST” module of FIG. 11B;

FIG. 15A illustrates, for the LL band, zigzag scanning of 4×4 blocks of samples that are transformed to 4×4 blocks of transform coefficients;

FIG. 15B illustrates, for the HL band, zigzag scanning of 4×4 blocks of samples that are transformed to 4×4 blocks of transform coefficients;

FIG. 15C illustrates, for the LH band, zigzag scanning of 4×4 blocks of samples that are transformed to 4×4 blocks of transform coefficients;

FIG. 15D illustrates, for the HH band, zigzag scanning of 4×4 blocks of samples that are transformed to 4×4 blocks of transform coefficients;

FIG. 16 illustrates a block diagram of an example combined adaptive wavelet AVST (AWAVST) coder;

FIG. 17A illustrates a flowchart of an example process of AWAVST Intra Encoding;

FIG. 17B illustrates a flowchart of an example process for AWAVST Intra Decoding;

FIG. 18A illustrates a functional block diagram of an example AWAVST Intra Encoder;

FIG. 18B illustrates a functional block diagram of an example functional standalone AWAVST Intra Decoder;

FIG. 19 illustrates an example system including details of the “Adaptive Wavelet Analysis Filter” in the AWAVST Encoder of FIG. 18A and the “Wavelet Synthesis Filter” in the AWAVST Decoder of FIG. 18B;

FIG. 20A illustrates an example system including details of the “Local Buffer and Prediction Analyzer and Generator” and interfaces to the rest of the AWAVST Intra Encoder of FIG. 18A;

FIG. 20B illustrates an example system including details of the “Local Buffer and Prediction Generator” and interfaces to the rest of the WAVST Intra Decoder of FIG. 18B;

FIG. 21 illustrates an example system including details of the “Adaptive Square/Rectangular Variable Size Transform: DCT, PHT, DST” module of the AWAVST Intra encoder of FIG. 18A and the “Adaptive Square/Rectangular Size Inverse Transform: DCT, PHT, DST” module of the AWAVST decoder of FIG. 18B;

FIG. 22A illustrates a block diagram of an example transform and wavelet-transform combined coder referred to as an Adaptive Transform Wavelet Adaptive Transform (ATWAT) coder;

FIG. 22B illustrates a block diagram of an example transform and wavelet-transform combined coder referred to as Adaptive Transform Adaptive Wavelet Adaptive Transform (ATAWAT) coder;

FIG. 23A illustrates a flowchart of an example process for ATWAT/ATAWAT Intra Encoding using an Adaptive Transform Wavelet Adaptive Transform (ATWAT) coder or Adaptive Transform Adaptive Wavelet Adaptive Transform (ATAWAT) coder;

FIG. 23B illustrates a flowchart of an example process 2302 for ATWAT/ATAWAT Intra Decoding that inverts the process performed by ATWAT/ATAWAT Intra encoding;

FIG. 24 is an illustrative diagram of an example system for encoding and/or decoding;

FIG. 25 is an illustrative diagram of an example system; and

FIG. 26 illustrates an example small form factor device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as multi-function devices, tablets, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, (or “embodiments”, “examples”, or the like), etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to efficient intra video/image coding using wavelets and variable size transform coding.

Before discussing the details of various embodiments, the disclosure provides a discussion of wavelet based image coding. For example, the process of wavelet filtering of digital signals can be thought of as including two complementary processes, one, that de-composes the signal into low-pass and high-pass sub-set signals, and the reverse process that combines (re-composes) the low-pass and high-pass sub-set signals back into the original (or near-original) signal. The filters used for decomposition may be called analysis filters may be are applied first, and the filters used for re-composition may be called synthesis filters and may be applied to decomposed signal (other operations can be inserted between the analysis and synthesis filters). In some examples, the analysis and synthesis filters may be a complementary pair and may be required to satisfy certain mathematical properties to enable a final reconstruction of the signal to be similar to the original signal and of good quality. As an example of different classes/types of filters and properties they possess, the properties of orthogonal filter and bi-orthogonal filter classes as well as examples of specific filters or types of filters that fall into aforementioned classes are provided.

In some examples, orthogonal filters may be utilized. For example, orthogonal filters may include synthesis filters that are time reversed versions of their associated analysis filters, high pass filters that may be derived from low pass filters, and analysis filters that satisfy the orthogonally constraint. In other examples, bi-orthogonal filters may be utilized. For example, bi-orthogonal filters may include a Finite Impulse Response (FIR), a linear phase, and perfect reconstruction. However, bi-orthogonal filters may not be orthogonal.

An example bi-orthogonal class of wavelet filters include Haar wavelet filters, but higher quality filters of the same class include Cohen-Daubechies-Feauveau CDF 5/3, LeGall 5/3 filters, and CDF 9/7 filters. For example, CDF 5/3 or CDF 9/7 filters may be bi-orthogonal (e.g., providing FIR, linear phase, and perfect reconstruction but not being orthogonal), symmetrical, and may have an odd length.

An example of orthogonal wavelet filters include Quadrature Mirror filters (QMF) of various sizes. For example, QMF filters may provide FIR, linear phase, alias-free but not perfect reconstruction, and may be orthogonal.

In the following discussion, the abbreviations or terms lpaf, hpaf, lpsf, and hpsf respectively in Tables 1A-3, which illustrate example filters, and elsewhere herein represent low pass analysis filter, high pass analysis filter, low pass synthesis filter, and high pass synthesis filter, respectively.

Table 1A provides example coefficients of a 5 tap low pass analysis filter such that the filter is symmetric around the center coefficient 0.75 and coefficients of a 3 tap high pass analysis filter such that the filter is symmetric around the center coefficient 1.0.

TABLE 1A
Example CDF or LeGall 5/3 Analysis Filters

| | | | |
|---|---|---|---|
| lpaf | 0.75 | 0.25 | −0.125 |
| hpaf | 1.00 | −0.50 | |

Table 1B provides example coefficients of a 3 tap low pass synthesis filter such that the filter is symmetric around the center coefficient 1.0 and coefficients of a 5 tap high pass synthesis filter such that the filter is symmetric around the center coefficient 0.75.

TABLE 1B
Example CDF or LeGall 5/3 Synthesis Filters

| | | | |
|---|---|---|---|
| lpsf | 1.00 | 0.50 | |
| hpsf | 0.75 | −0.25 | −0.125 |

The example filter sets of Table 1A and Table 1B may be referred to as either Daubechies 5/3, CDF 5/3, or LeGall 5/3 filters.

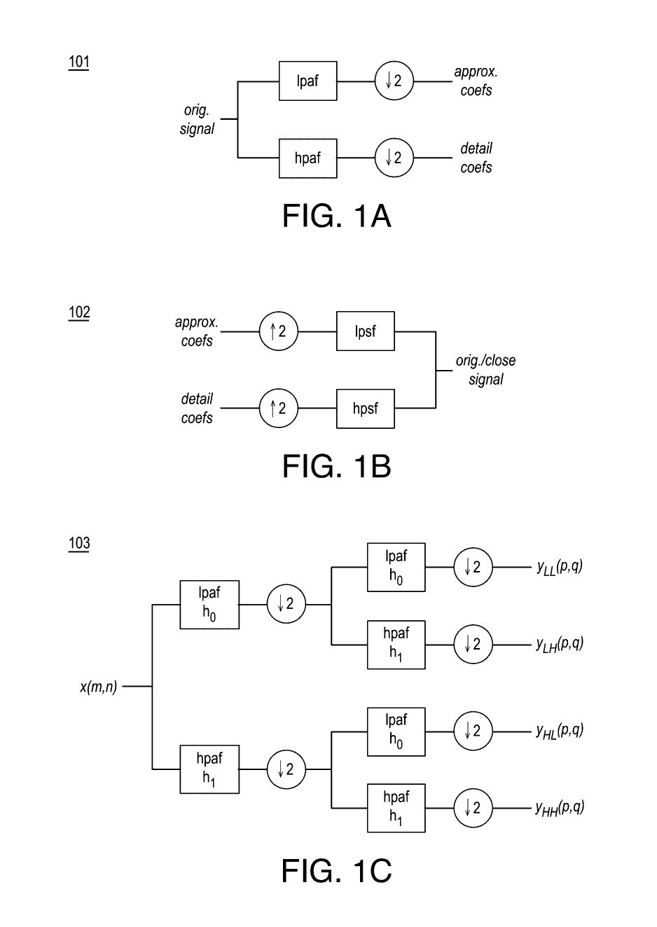

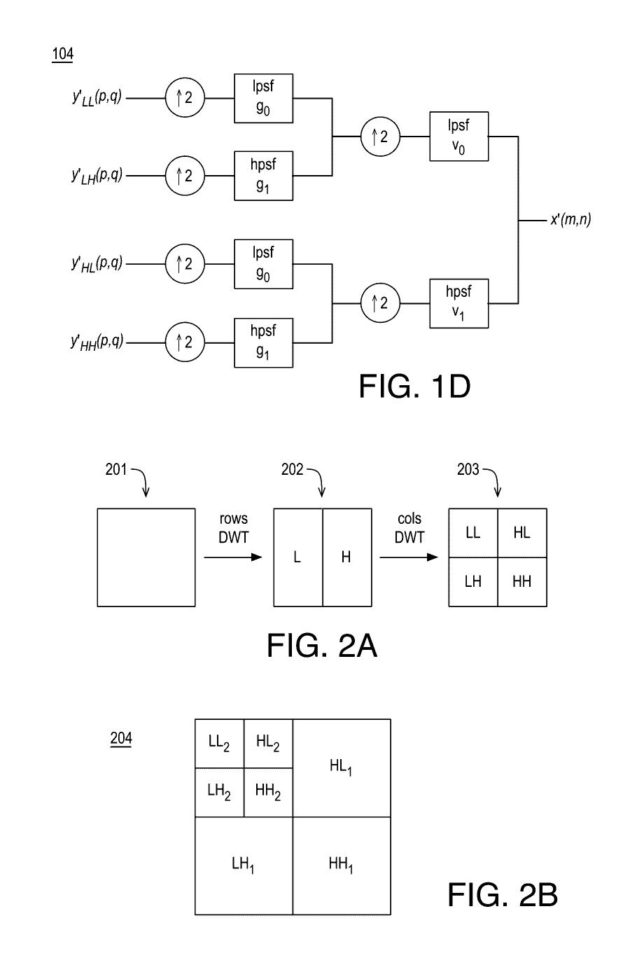

FIG. 1A illustrates an example application 101 of an analysis filter, arranged in accordance with at least some implementations of the present disclosure. As shown in FIG. 1A, an original 1D signal may undergo low pass analysis filtering (lpaf) resulting in a low pass 1D signal that is a downsampled by 2 subband of the input signal (e.g., approx. coefficients). In parallel, for example, the original 1D signal may also undergo high pass analysis filtering (hpaf) resulting in a high pass 1D signal that is a downsampled by 2 subband of the input signal (e.g., detail coefficients). In some examples, the analysis filter applied in FIG. 1A may be the analysis filter of Table 1A.

FIG. 1B illustrates an example application 102 of a synthesis filter, arranged in accordance with at least some implementations of the present disclosure. As shown in FIG. 1B, a synthesis filter that is complimentary with respect to the analysis filter applied in FIG. 1A may be applied. For example, the two downsampled signals (low pass and high pass subbands; e.g., approx. coefficients and detail coefficients) from analysis filtering may be filtered by a pair of synthesis filters referred to as low pass synthesis filter and high pass synthesis filter. The two outputs may be combined resulting in a reconstruction signal that is same (or nearly identical) as the 1D original signal at the input (e.g., orig./close signal). In some examples, the syntheses filter applied in FIG. 1B may be the syntheses filter of Table 1B. In the example of application of the 5/3 filters of Tables 1A and 1B, the output can be precisely identical as coefficients are powers of 2. However, in the application of other example filters, the output, due to slight rounding differences, may be very close if not exactly the same. In some examples, after analysis filtering, the resulting low pass and high pass subband pixels (also referred to as filtered coefficients) may be, during encoding, selectively reduced in precision by quantization and then entropy encoded resulting in compression. A decoder may then reverse the encoding process by performing entropy decoding and inverse quantization followed by synthesis filtering.

The discussed analysis/synthesis filtering process is not limited to the use of 5/3 filtering such as the filters of Tables 1A and 1B. For example, the discussed analysis/synthesis filtering process may be applicable to any analysis and systhesis filtres such as those discussed herien. For example, Tables 2A and 2B provide example CDF 9/7 filters. The low pass analysis filter of CDF 9/7 filters may be a 9 tap filter symmetric around the center coefficient 0.602949 and the high pass analysis filter may be a 7 tap filter symmetric around center coefficient 1.115087. Example complimentary low pass synthesis and high pass synthesis filters are provided in Table 2B with low pass synthesis filter of length 7 taps and high pass synthesis filter of length 9 taps.

TABLE 2A
Example CDF 9/7 Analysis Filters

| | | | | | |
|---|---|---|---|---|---|
| lpaf | 0.602949018 | 0.266864118 | −0.078223266 | −0.01686411 | 0.026748757 |
| hpaf | 1.115087052 | −0.591271763 | −0.057543526 | 0.091271763 | |

TABLE 2B
Example CDF 9/7 Synthesis Filters

| | | | | | |
|---|---|---|---|---|---|
| lpsf | 1.115087052 | 0.591271763 | −0.057543526 | −0.091271763 | |
| hpsf | 0.602949018 | −0.266864118 | −0.078223266 | 0.01686411 | 0.026748757 |

The previously discussed filter sets (e.g., the CDF (or LeGall) 5/3 filters and the CDF 9/7 filters) are examples of bi-orthogonal filters. However, the techniques discussed herein are also applicable to orthogonal filters such as QMF filters. For example, Table 3 provides example coefficients of a 13 tap QMF low pass and high pass analysis filters. The complimentary synthesis filters may be generated as time reversed versions of analysis filters.

TABLE 3
Example QMF 13 Analysis Filters (Synthesis Filters
are time reversed versions of the Analysis Filters)

| lpaf | hpaf |
|---|---|
| 0.7737113 | 0.7737113 |
| 0.42995453 | −0.42995453 |
| −0.057827797 | −0.057827797 |
| −0.0980052 | 0.0980052 |
| 0.039045125 | 0.039045125 |
| 0.021651438 | −0.021651438 |
| −0.014556438 | −0.014556438 |

The described techniques may provide 1D filtering of signals. Discussion now turns to 2D filtering as images are 2D signals and video can be thought of as composed of 2D frames plus a time dimension. For example, the 1D filtering techniques discussed so far may be extended to derive 2D filtering techniques as discussed further herein.

For example, wavelet filtering may decompose a 2D signal such as an image (or video frame) into subbands by different decomposition techniques including uniform band decomposition, octave band decomposition, and wavelet packet decomposition. For example, octave band decomposition may provide a non-uniform splitting technique that decomposes low frequency band into narrower bands wuch that the high frequency bands are left without further decomposition.

FIG. 1C illustrates an example analysis filtering 103 of a 2D signal, arranged in accordance with at least some implementations of the present disclosure. As shown in FIG. 1C, analysis filtering of 2D signals may include two stages, the first stage to perform filtering in one dimension (e.g., vertical) and the second stage to perform filtering in the second dimension (e.g., horizontal) to the output of the first stage. For example, analysis filtering 103 may provide analysis filtering of a 2D signal (e.g., an image or Intra frame). The analysis filters used in the first stage (e.g., a low analysis pass filter and a high analysis pass filter) and in the second stage may be the same. For example, in the first stage they may be applied on rows while in second stage they may be applied on columns. The entire 2 stage decomposition/analysis filtering process for 2D signals illustrated in FIG. 1C may provide filtering and subsampling by 2 operations and may result in 4 subbands referred to as Low-Low (LL), Low-High (LH), High-Low (HL), and High-High (HH). For example, FIG. 1C illustrates decomposing a 2D signal, x(m,n), into 4 subbands having samples represented by y_{LL}(p,q), y_{LH}(p,q), y_{HL}(p,q), and y_{HH}(p,q). In the example decomposition of FIG. 1C, each subband includes one-quarter of the number of samples (coefficients) of the original signal x(m,n).

FIG. 1D illustrates an example synthesis filtering 104, arranged in accordance with at least some implementations of the present disclosure. As shown in FIG. 1D, synthesis filtering 104 may include operations of interpolation by 2 and filtering applied on samples (e.g., coefficients) y′_{LL}(p,q), y′_{LH}(p,q), y′_{HL}(p,q), and y′_{HH}(p,q) representing each of four subbands to provide a re-composed version of the original signal (e.g., x′(m,n)). In examples where perfect filters with no quantization of subband coefficients, the final (e.g., re-composed) signal (e.g., x′(m,n)) may be exactly the same as the input signal provided to analysis filtering 103 (e.g., x(m,n); please refer to FIG. 1C).

FIG. 2A illustrates an example results 202, 203 of applying wavelet filtering to an image or video frame 201, arranged in accordance with at least some implementations of the present disclosure. As shown in FIG. 2A, wavelet filtering may be applied applied on the rows of image or video frame 201 resulting in decomposition of image or video frame 201 into results 202, which may include 2 subbands: a low frequency subband L and a high frequency subband H, which may each be of half size horizontally but full size vertically with respect to image or video frame 201. Wavelet filtering may be applied to columns of results 202 (e.g., to each of the two subbands, L and H) to decompose each subband further into two subbands each for a total of 4 subbands (e.g., LL, HL, LH, and HH subbands) as shown with respect to results 203. The process illustrated with respect to FIG. 2A may be referred to as a one level decomposition of image or video frame 201. For example, FIG. 2A may provide a one level discrete wavelet transform (DWT) decomposition.

FIG. 2B illustrates an example two level decomposition 204 of an image or video frame, arranged in accordance with at least some implementations of the present disclosure. As shown in FIG. 2B, the process of one level decomposition may be extended to two levels (e.g., which may be referred to as two level decomposition). The process of providing two level decomposition 204 may include performing a one level decomposition resulting in the 4 subbands discussed with respect to FIG. 2A and referred to in FIG. 2B as LL₁ (not shown in FIG. 2B due to subsequent decomposition), HL₁, LH₁, and HH₁ subbands. Furthermore, the low-low (LL₁) subband may be decomposed further by, in some embodiments, an identical process used for the one level decomposition. In other embodiments, the first and second decompositions may include different decompositions (e.g., filter types or the like). Such processing may provide for the decomposition of LL₁ subband further into 4 subbands that are referred to as LL₂, HL₂, LH₂, and HH₂, with LL₂ now being the low-low subband.

In some examples, such decomposition processing may be continued further with each iteration performing a quad-split of the low-low band from the previous iteration, which may provide in higher levels of decomposition.

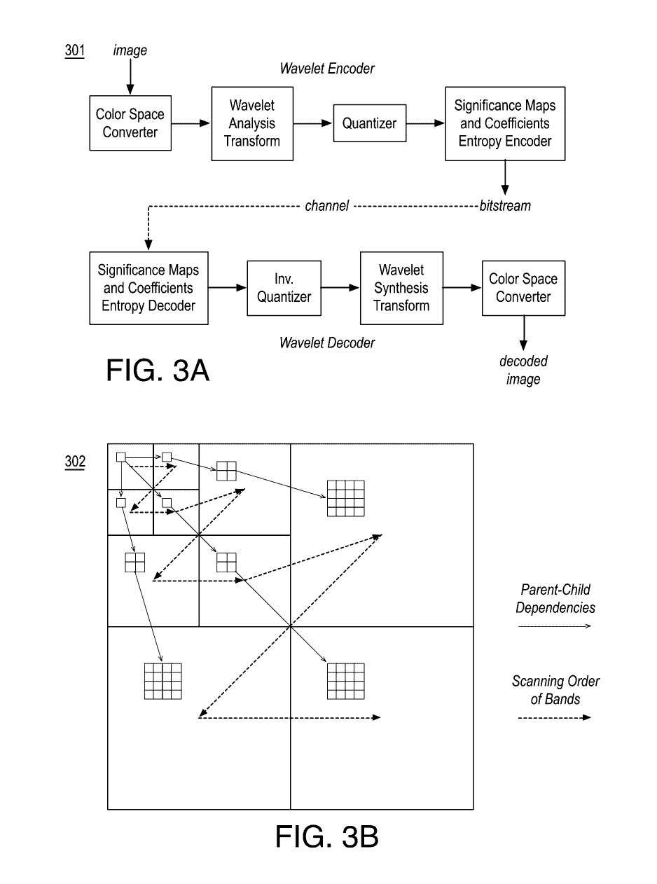

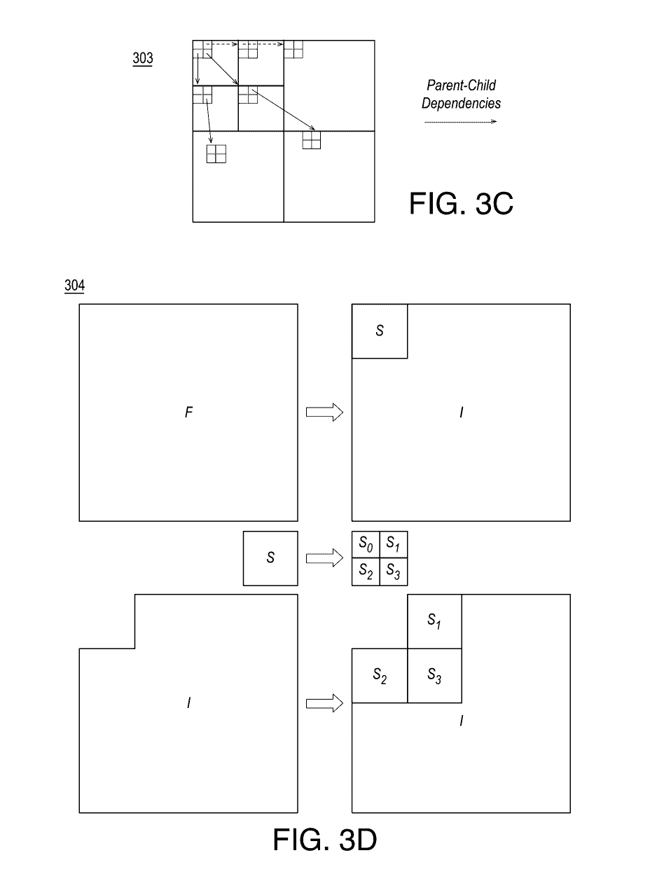

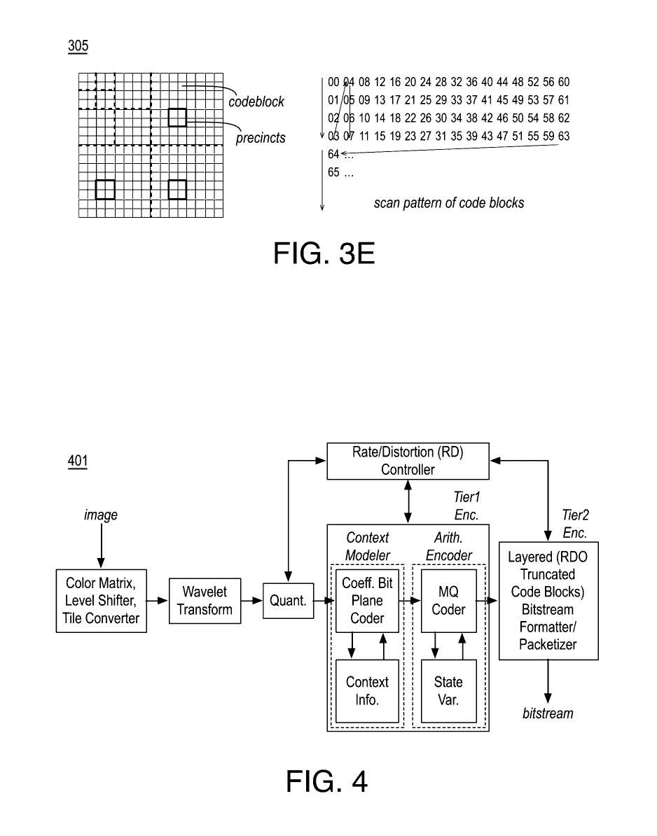

Discussion now turns to a wavelet based coder for coding of images or Intra frames of video. FIG. 3A is a block diagram wavelet based encoder/decoder system 301, arranged in accordance with at least some implementations of the present disclosure. As shown in FIG. 3A, an image to be encoded by a Wavelet Encoder of system 301 may be input to a Color Space Converter, which may, for example, convert an RGB image/frame to a YUV image/frame, which may be input to a Wavelet Analysis Transform module that may decompose the YUV image/frame into wavelet (e.g., subband) coefficients that may be quantized by a Quantizer, which may be followed by entropy coding of a map of a location of significant quantized coefficients and the quantized coefficients themselves by a Significance Maps and Coefficients Entropy Encoder to produce a coded bitstream for storage or transmission over a channel.

The coded bitstream from storage or transmission may, at a Wavelet Decoder of system 301, undergo entropy decoding of the significance maps as well as the coefficient themselves at a Significance Maps and Coefficients Entropy Decoder, followed by inverse quantization of quantized coefficients at an Inverse Quantizer, which may be input to a Wavelet Synthesis Transform module that may re-constitute from wavelet (e.g., subband) coefficients, the YUV image/frame, which may be converted by a Color Space Inverter to the desired (e.g., often, RGB) format to generate a decoded image.

Without any loss of generality it can be said that if the image to be coded is already in the color format used by the encoder, color space conversion is not necessary. Furthermore, the decoded image, if it can be consumed in the format decoded, may not require color space inversion. The encoding/decoding process discussed with respect to system 301 may be applied to images or frame(s) of video, which are referred to as Intra frame(s) herein.

Wavelet coders may provide different quality/complexity tradeoffs functionality/flexibility. For example, the wavelet decomposition where only the LL band is split into a quad such that each coefficient in a lower/coarser band has 4 coefficients corresponding to its spatial location in the next higher band. Thus there is unique spatial relationship between coefficients of one band with that of coefficients in a previous band. Furthermore, wavelet coders may exploit the unique structure of wavelet coefficients to provide additional functionality such as image decoding scalability or random access into the bitstream.

Example wavelet coders include an Embedded Zero-tree Wavelet (EZW) coder, a Set Partitioning in Hierarchical Trees (SPIHT) coder, a Set Partitioned Embedded BloCK (SPECK) coder, and an Embedded Block Coding with Optimized Truncation (EBCOT) coder. Table 3 provides examples of significance map coding and entropy coding techniques employed by such wavelet image coders.

TABLE 3
Wavelet based image coders and their
coefficient encoding strategies

| Wavelet Image | Significance | Coefficient structures, and |
|---|---|---|
| Coder | map coding | Entropy coding |
| EZW, SPIHT | Zero-trees | Cross scale trees of coefficients |
| | | and arithmetic coding |
| SPECK | Set Partitioning | Splitting of a set into subsets |
| | | and arithmetic coding |
| EBCOT, | Conditional | Multi-context arithmetic |
| JPEG2000 | Coding | coding of small coefficient |
| | | blocks. Arithmetic coding. |
| | | Optimal block truncation |

For example, EZW may be based on the principles of embedded zero tree coding of wavelet coefficients. One of the beneficial properties of wavelet transform is that it compacts the energy of input signal into small number of wavelet coefficients, such as for natural images, most of the energy is concentrated in LLₖ band (where k is level of decomposition) as well as remaining energy in High frequency bands (HLᵢ, LHᵢ, HHᵢ) is also contracted in small number of coefficients. For example, after wavelet transformation, there may be few higher magnitude coefficients that are sparse but most coefficients are relatively small (and carry relatively small amount of energy) and thus such coefficients after quantization quantize to zero. Also, co-located coefficients across different bands are related. EZW exploits these properties by using two main concepts, coding of significance maps using zero-trees and successive approximation quantization. For example, EZW may exploit the multi-resolution nature of wavelet decomposition.

FIG. 3B illustrates a wavelet 3-level octave decomposition 302 into 10 subbands, arranged in accordance with at least some implementations of the present disclosure. For example, wavelet 3-level octave decomposition 302 is one more level of decomposition than discussed earlier. As shown in FIG. 3B, a spatial structural relationship between coefficients may be provided in each subband level. For example, each subband coefficient shown by a square in HL₃, LH₃, and HH₃ bands may correspond to a co-located square of 2×2 coefficients in HL₂, LH₂, and HH₂ bands and/or a co-located square of 4×4 subband coefficients in HL₁, LH₁, and HH₁ bands. One way of benefitting from such a structure, for example, is that if a wavelet subband coefficient in a coarser scale (e.g. level 3) is insignificant or zero with respect to a threshold, wavelet coefficients of a same orientation in finer scales (e.g. levels 2 and 1) may also be likely to be insignificant or zero with respect to the same threshold. This allows for forming zero trees (e.g., trees of zero symbols represented by end-of-block indicating zero coefficients across subband scales) that can be very efficiently represented. Such relationships are shown in FIG. 3B as parent-child dependencies between solid line arrows. FIG. 3B also shows (by thick dashed line arrows) an example order of zigzag scanning of subband coefficients across different scales. For example, a zero tree structure may allow for many small coefficients across finer resolution subbands (smaller level number) to be discarded, which may provide significant savings as the tree grows by powers of 4. Furthermore, EZW coding may encodes the obtained tree structure producing bits in order of their importance resulting in embedded coding where an encoder can terminate encoding at any point to meet an encoding target bitrate or the decoder may stop the decoding at any point resulting in a viable but lower quality decoded image at lower than full bitrate.

Furthermore, SPIHT may be based on the principles of set partitioning in hierarchical trees. For example, SPIHT may take advantages of coding principles such as partial ordering by magnitude with a set partitioning sorting algorithm, ordered bitplane transmission, and exploitation of self similarity across different image scales. In some implementations, SPIHT coding may be more efficient than EZW coding. In SPIHT coding, an image may be decomposed by wavelet transform resulting in wavelet transform coefficients that may be grouped into sets such as spatial orientation trees. Coefficients in each spatial orientation tree may be coded progressively from most significant bit planes to least significant bit planes starting with coefficients of highest magnitude. As with EZW, SPIHT may involve two passes: a sorting pass and a refinement pass. After one sorting pass and one refinement pass, which forms a scan pass, the threshold may be halved and the process repeated until a desired bitrate is reached.

Due to spatial similarity between subbands, coefficients are better magnitude ordered when one moves down in the pyramid. For example, a low detail area may be likely to be identifiable at the highest level of the pyramid and may be replicated in lower levels at the same spatial location. FIG. 3C illustrates a spatial orientation tree 303, arranged in accordance with at least some implementations of the present disclosure. For example, spatial orientation tree 303 may be a tree structure that defines spatial relationships on the hierarchical tree. In some examples, a spatial orientation tree may be defined in a pyramid created with recursive four band splitting such that each node of a tree defines a pixel and its descendants correspond to pixels of the same spatial orientation in next finer level of pyramid. For example, the tree may be defined in a manner that each node has either no child or four children that form a group of 2×2 adjacent pixels.

Additionally, SPECK coding may be based on the principle of coding sets of pixels in the form of blocks that span wavelet subbands. For example, SPECK may differ from EZW or SPIHT, which instead use trees. SPECK may perform wavelet transformation of an input image or Intra frame and code in 2 phases including a sorting pass and a refinement pass that may be iteratively repeated. In addition to the 2 phases, SPECK may perform an initialization phase. In some examples, SPECK may maintain two linked lists: a list of insignificant sets (LISs) and a list of significant pixels (LISPs).

FIG. 3D illustrates an example SPECK encoding process 304, arranged in accordance with at least some implementations of the present disclosure. As shown in FIG. 3D, in an initialization phase an input image (e.g., F) may be partitioned into two sets, a set S, and a set I. Set S may represent the root and may be added to LIS. Set I may represent the remaining portion (e.g., F-S). In the sorting pass phase, a significance test may be performed against a current threshold to sort each block of type S in LIS. If S block is significant, it is divided by quadtree partitioning into four subsets, and each subset is treated as a set of type S and processed recursively until the pixel level is reached. The insignificant sets are moved to LIS for further processing. Once the processing of set S is achieved, a significance test is performed against I blocks using the same threshold. If an I block is significant it is divided into four sets, one set having the same type I, and the other sets having the type S. A refinement pass is performed for LSP pixels such that the n^{th} most significant bit is output except for pixels that have been added during the last sorting pass. Furthermore, the threshold may be halved and the coding process may be repeated until an expected bitrate is reached.

Furthermore, EBCOT may include embedded block coding of wavelet subbands that may support features such as spatial scalability (e.g., the ability to decode pictures of various spatial resolutions) and SNR scalability (e.g., the ability to decode pictures of various qualities) from a single encoded bitstream. While the requirement for SNR scalability can also be addressed by EZW and SPIHT coding which do successive approximation or bit plane encoding, both EZW and SPIHT if required to provide spatial scalability would have to modify encoding/bitstream but the resulting bitstream would then not be SNR scalable due to downward inter dependencies between subbands. In some examples, EBCOT addresses these shortcomings by coding each band independently. Furthermore, the coding is made more flexible by partitioning subband samples into small blocks referred to as code blocks with the size of code blocks determining the coding efficiency achievable. For example, independent processing of code blocks may provide for localization and may be useful for hardware implementation.

FIG. 3E illustrates an example division 305 of an image or Intra frame, arranged in accordance with at least some implementations of the present disclosure. As shown in FIG. 3E, an image or Intra frame to be coded may be divided into tiles with each tile wavelet transformed and partitioned into packet partition locations called precincts such that each precinct contains three spatially consistent rectangles one from each subband at each resolution level. Each precinct may be further divided into code blocks that form input to an entropy coder. Within a stripe (e.g., a stripe may be 4 consecutive rows of pixel bits in code block bit plane), samples may be scanned column by column. FIG. 3E also shows, for code blocks that are 16 wide by n high, an example code block scanning process. Starting from top left, a first four bits of a first column may be scanned until the width of the code block is covered. Then, the second four bits of the first column of a next strip may be scanned, and so on.

FIG. 4 is a block diagram of an example JPEG2000 encoder 401, arranged in accordance with at least some implementations of the present disclosure. In some examples, JPEG2000 encoder 401 may be based on EBCOT techniques discussed herein. As shown in FIG. 4, an image or Intra frame (image) to be encoded may undergo preprocessing in a Color Matrix, Level Shifter, Tile Converter” module that may shift pixel values by 128, perform color format conversion, and partition the image into fixed size tiles. Furthermore, a “Wavelet (Analysis) Transform” module may perform 2D wavelet decomposition into bands and coefficients of each subband may be quantized by a “Quantizer” and entropy encoded and layered using a 2 tier encoder. For example, a “Tier 1 Encoder” may include a “Context Modeler” (e.g., including a “Coefficient Bit Plane Coder” and a “Context Information” module) followed by an “Arithmetic Encoder” (e.g., including an “MQ Coder” and a “State Variable” module) and “Tier 2 Encoder” may include a “Layered (RDO Truncated Code Blocks) Bitstream Formatter/Packetizer” that may generate an embedded/scalable bitstream that is then packetized.

An example JPEG 2000 decoder (not shown) may reverse the order of operations of the encoder, starting with a bitstream to be decoded input to “Tier 2 Decoder” including a “DePacketizer and Bitstream Unformatter” followed by entropy decoding in a “Tier 1 (Arithmetic) Decoder”, the output of which may be provided to an “Inverse Quantizer” and then to a “Wavelet (Synthesis) Transform” module and then to a “Tiles Unformatter, Level Unshifter, and Color Inverse Matrix” postprocessor that may output the decoded image.

JPEG2000 was finalized in 2000 by the ISO/WG1 committee. The original JPEG image coding standard was developed in 1992 as ITU-T Rec. T.81 and later adopted in 1994 by the same ISO committee. While the JPEG2000 standard provided significant improvements over the original JPEG standard, it may include shortcomings such as complexity, limited compression performance, difficulties in hardware implementation, and scalability at the expense of compression efficiency. Furthermore, the original JPEG standard that uses fixed block size transform coding is still the prevalent image coding standard in use to this day. However, the original JPEG standard has shortcomings such as limited compression performance.

Techniques discussed herein may provide for highly efficient coding of images or Intra frames of video. Some of the techniques also provides basic scalability (of image/Intra frame of video) to one-quarter resolution without imposing any additional compression penalty. In some examples, highly adaptive/spatially predictive transform coding may be applied directly on images or Intra frames of video. In some examples, highly adaptive/spatially predictive transform coding may be applied to a fixed or an adaptive wavelet decomposition of images or Intra frames of video.

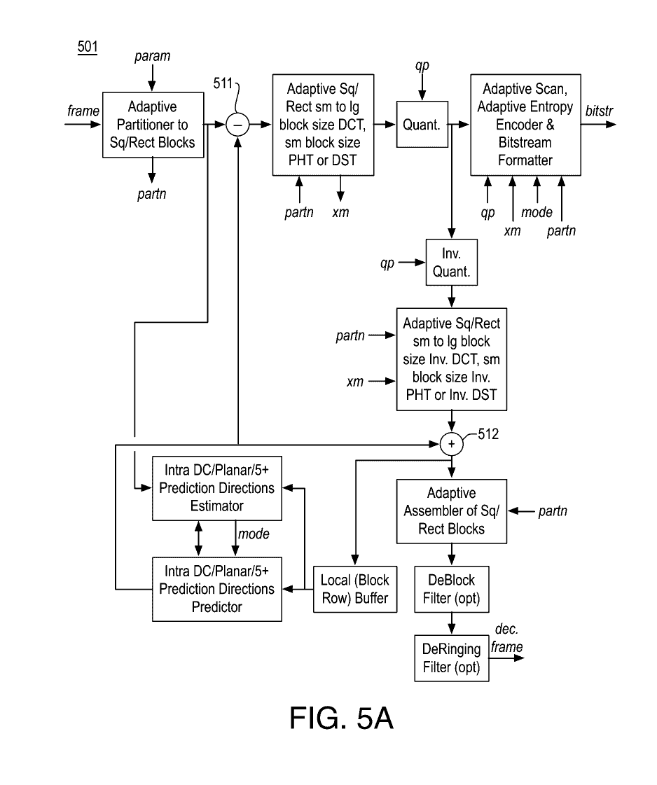

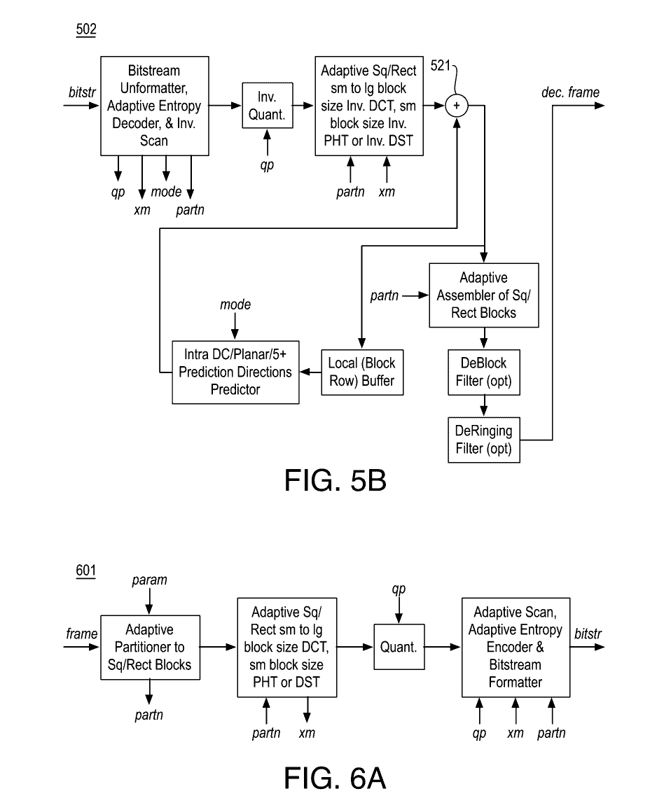

FIG. 5A illustrates a block diagram of a next generation Intra coder 501 referred to herein as an Adaptive Variable-size Transform (AVST) Intra Encoder, arranged in accordance with at least some implementations of the present disclosure. For example, the encoder of FIG. 5A may be an AVST intra encoder (e.g., excluding RDO and rate control) that may be used for transform encoding of blocks of pixels or transform encoding of blocks of wavelet LL band data. As shown in FIG. 5A, an original YUV frame or YUV image (frame, e.g. image in RGB format converted to YUV format) may be input to an “Adaptive Partitioner to Square/Rectangular Blocks” that may partition the image or frame to fixed, large size blocks (e.g., 32×32 or 64×64) that may be referred to herein as tiles and then optimally partition each tile adaptively into variable size smaller rectangular or square blocks either based efficient coding criteria (not shown in FIG. 5A) such as such as Rate Distortion Optimization (RDO) or content analysis or both. While, in general, the blocks resulting from subpartitioning can be of any size, for practical reasons of implementation complexity, in some embodiments, horizontal sizes and vertical sizes of such blocks may typically be of powers of 2 (e.g., 64×64, 64×32, 32×64, 3×32, 32×16, 16×32, 32×8, 8×32, 16×16, 16×8, 8×16, 16×4, 4×16, 8×8, 8×4, 4×8, 4×4, etc.). In some embodiments, such blocks may even be limited to square blocks (e.g., 32×32, 1616, 8×8, 4×4, etc.). The chosen partition size for each partition may be indicated by the partn signal and may be included in the bitstream. Since in 4:2:0 YUV image or frame chroma examples resolution is one quarter of luma resolution, the chroma block sizes may be half in each dimension of luma block sizes (as discussed). In any case, the partitioned blocks may be input to a differencer at the other input of which may be a spatial prediction of the same block generated from using pixels of previous neighboring decoded blocks.

The process for generating a spatial prediction may include estimating if the block can be predicted using either the directional prediction (e.g., with a choice of at least 5 directions), dc prediction, or planar prediction, and may be indicated as the best chosen mode for making predictions using neighboring decoded blocks as determined by an “Intra DC/Planar/5+ Prediction Direction Estimator” and an “Intra DC/Planar/5+ Predictions Directions Predictor”. Prediction difference block(s) at the output of differencer 511 may be converted to transform coefficient block(s) by an “Adaptive Square/Rectangular small to large block size DCT, small block size PHT or DST” module based on an orthogonal block transform of the same or smaller size. Examples of orthogonal transforms include actual DCT, integer approximation of DCT, DCT-like integer transform, the Parametric Haar Transform (PHT), or the DST transform. In some embodiments, such transforms may be applied in a 2D separable manner, (e.g., a horizontal transform followed by a vertical transform (or vice versa)). The selected transform for this partition (e.g., a current partition) may be indicated by the xm signal in the bitstream. For example, the transform may be an adaptive parametric transform or an adaptive hybrid parametric transform such that the adaptive parametric transform or the adaptive hybrid parametric transform includes a base matrix derived from decoded pixels neighboring the transform partition.

Next, the transform coefficients may be quantized by a “Quantizer” (e.g., a quantizer module), scanned and entropy encoded to generate a bitstream by an “Adaptive Scan, Adaptive Entropy Encoder, and Bitstream Formatter” that may provide a zigzag scan or an adaptive scan and an arithmetic encoder such as CABAC encoder. The value of the chosen quantizer may be indicated by the qp parameter, which may change on an entire frame basis, on a one or more rows of tiles (slice) basis, on a tile basis, or on a partition basis and which may be included in the bitstream. The quantized coefficients at the encoder may also undergo decoding in a local feedback loop in order to generate prediction. For example, the quantized coefficients may be decoded by an “Inverse Quantizer” and then inverse transformed by an “Adaptive Square/Rectangular small to large block size Inverse DCT, small block size Inverse PHT or Inverse DST” module which may provide an operation that performs an inverse of the forward transform resulting in blocks of decoded pixel differences to which the prediction signal is then added via an adder 512 resulting in a reconstructed version of the block. The reconstructed blocks of the same row as well as the previous row of blocks may be saved in a local buffer (e.g., at a “Local (Block Row) Buffer”) such that they are available for spatial prediction of any block of the current row. While it is not necessary at the encoder to generate a full reconstructed image or Intra frame, if desired such a frame may be generated by assembling reconstructed blocks at an “Adaptive Assembler of Square/Rectangular Blocks” module and by optionally applying deblock filtering via a “DeBlock Filtering” module and/or de-ringing via a “DeRinging Filtering” module.

For example, coder 501 may receiving an original image, frame, or block of a frame for intra coding (frame). The original image, frame, or block may be partitioned into multiple partitions for prediction by the “Adaptive Partitioner to Square/Rectangular Blocks” including at least a square partition and a rectangular partition. Furthermore, the partitions for prediction may be partitioned into multiple transform partitions by the “Adaptive Partitioner to Square/Rectangular Blocks” including at least a square partition and a rectangular partition. The partitions for prediction may be differenced with corresponding predicted partitions from “Intra DC/Planar/5+ Predictions Directions Predictor” by differencer 511 to generate corresponding prediction difference partitions. For example, the transform partitions in this context may be comprise partitions of the prediction difference partitions. Furthermore, the transform partitions may be of equal or smaller size with respect to their corresponding prediction difference partitions.

An adaptive parametric transform or an adaptive hybrid parametric transform may be performed on at least a first transform partition of the multiple transform partitions and a discrete cosine transform on at least a second transform partition of multiple transform partitions to produce corresponding first and second transform coefficient partitions such that the adaptive parametric transform or the adaptive hybrid parametric transform comprises a base matrix derived from decoded pixels neighboring the first transform partition. In an embodiment, the first transform partition has a partition size that is within a small partition size subset of available partition sizes and the second transform partition has a partition size that is within the available partition sizes. In an embodiment, the first transform partition has a size of 4×4 pixels, 8×4 pixels, 4×8 pixels, or 8×8 pixels. In an embodiment, the first transform partition has a size not greater than 8×8 pixels and the second transform partition has a size not less than 8×8 pixels.

The first and second transform coefficient partitions may be quantized by the “Quantizer” to produce quantized first and second transform coefficient partitions and the quantized first and second transform coefficient may be scanned and entropy encoded by the “Adaptive Scan, Adaptive Entropy Encoder, and Bitstream Formatter” into a bitstream (bitstr).

FIG. 5B illustrates a block diagram of a standalone AVST Intra decoder 502 corresponding to the AVST Intra encoder of FIG. 5A, arranged in accordance with at least some implementations of the present disclosure. For example, the decoder of FIG. 5B may decode AVST intra encoded bitstreams. For example, as discussed, the encoder of FIG. 5A includes a similar local decoding loop. As shown, an AVST encoded bitstream (bitstr) may undergo bitstream unformatting, entropy (e.g. CABAC) decoding, and inverse scan of quantized coefficients in a “Bitstream Unformatter, Adaptive Entropy Decoder & Adaptive Inverse Scan” module and the quantized transform coefficients at the output of that module may be inverse quantized (e.g., based on quantizer qp) via an “Inverse Quantizer” and sent for inverse transform at an “Adaptive Square/Rectangular small to large block size Inverse DCT, small block size Inverse PHT or Inverse DST” module that may generate blocks of decoded difference pixels. To the blocks of decoded difference pixels, corresponding spatial directional or DC or planar prediction (e.g., based on decoded mode information) may be determined by an “Intra DC/Planar/5+ Prediction Directions Predictor” and applied via adder 521 resulting in reconstructed blocks that may stored in a “Local (Block Row) Buffer” and assembled by an “Adaptive Assembler of Square/Rectangular Blocks” module to form a complete image or Intra frame that may be filtered for blockiness via a “Deblock Filtering” module and/or filtered to reduce ringing via a “Deringing Filtering” module and sent to display as a decoded image or frame (dec. frame).

For example, while the use of spatial directional prediction in image or Intra coding may allow for increased coding efficiency, there are some cases where no spatial prediction may be sufficient such as when lower complexity is desirable or when encoding may be applied not on original pixels but on a difference signal in some form.

For example, decoder 502 may receive multiple transform coefficient partitions, such that the transform coefficient partitions include a square partition and a rectangular partition, at the “Adaptive Square/Rectangular small to large block size Inverse DCT, small block size Inverse PHT or Inverse DST”, which may perform an inverse adaptive parametric transform or an inverse adaptive hybrid parametric transform on at least a first transform coefficient partition of the multiple transform partitions and an inverse discrete cosine transform on at least a second transform coefficient partition of the multiple transform partitions to produce corresponding first and second transform partitions. In an embodiment, the inverse adaptive parametric transform or the inverse adaptive hybrid parametric transform may include a base matrix derived from decoded pixels neighboring the first transform partition. For example, in this context, the transform partitions may be prediction difference partitions The transform partitions (e.g., prediction difference partitions) may be added via adder 521 with corresponding predicted partitions from “Intra DC/Planar/5+ Prediction Directions Predictor” to generate reconstructed partitions. A decoded image, frame or block may be generated based at least in part on the first and second transform partitions and their corresponding reconstructed partitions. For example, the reconstructed partitions may be assembled by “Adaptive Assembler of Square/Rectangular Blocks” and optional deblocking and/or deringing may be applied to generate a decoded or reconstructed image, frame or block (dec. frame). In an embodiment, the first transform partition comprises a partition size that is within a small partition size subset of available partition sizes and the second transform partition has a partition size that is within the available partition sizes. In an embodiment, the first transform partition has a size of 4×4 pixels, 8×4 pixels, 4×8 pixels, or 8×8 pixels. In an embodiment, the first transform partition has a size not greater than 8×8 pixels and the second transform partition has a size not less than 8×8 pixels.

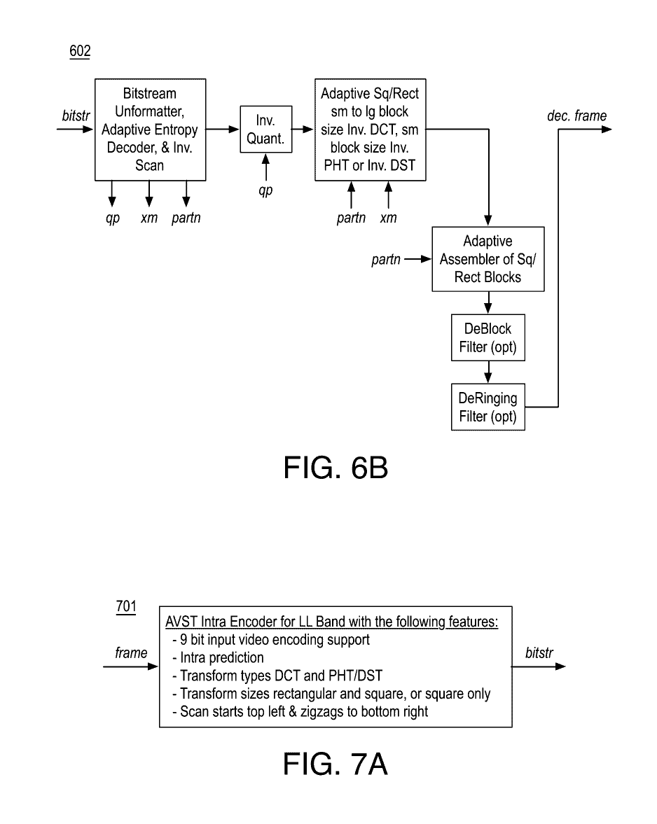

FIG. 6A illustrates a block diagram of an example coder 601 without spatial directional prediction, arranged in accordance with at least some implementations of the present disclosure. For example, coder 601 may not perform spatial directional prediction but coder 601 may include functionality associated with an “Adaptive Partitioner to Square/Rectangular Blocks” module, an “Adaptive Square/Rectangular small to large block size DCT, small block size PHT or DST” module, a “Quantizer”, and an “Adaptive Scan, Adaptive Entropy Encoder & Bitstream Formatter” module. The operations of such modules has been discussed with respect to FIG. 5A and will not be repeated for the sake of brevity. The encoder of FIG. 6A is referred to herein as an AVST* Encoder. For example, the encoder of FIG. 6A may be an AVST intra encoder with removed intra prediction but including automatic selection of transform type, directional transform size, and scan starting corner and direction. AVST* encoding may be customized to coding of wavelet bands such as AVST^{HL} for HL band, AVST^{LH} for LH band, and AVST^{HH} for HH band (e.g., *=HL, LH, or HH). For example, the encoder of FIG. 6A and the decoder of FIG. 6B may be referred to herein as AVST* Intra Encoders and AVST* Intra Decoders.

For example, coder 601 may receiving an original image, frame, or block of a frame for intra coding (frame). The original image, frame, or block may be partitioned into multiple transform partitions by the “Adaptive Partitioner to Square/Rectangular Blocks” including at least a square partition and a rectangular partition. For example, the transform partitions in this context may be comprise partitions of original image, frame, or block.

An adaptive parametric transform or an adaptive hybrid parametric transform may be performed on at least a first transform partition of the multiple transform partitions and a discrete cosine transform on at least a second transform partition of multiple transform partitions to produce corresponding first and second transform coefficient partitions such that the adaptive parametric transform or the adaptive hybrid parametric transform comprises a base matrix derived from decoded pixels neighboring the first transform partition. In an embodiment, the first transform partition has a partition size that is within a small partition size subset of available partition sizes and the second transform partition has a partition size that is within the available partition sizes. In an embodiment, the first transform partition has a size of 4×4 pixels, 8×4 pixels, 4×8 pixels, or 8×8 pixels. In an embodiment, the first transform partition has a size not greater than 8×8 pixels and the second transform partition has a size not less than 8×8 pixels.

The first and second transform coefficient partitions may be quantized by the “Quantizer” to produce quantized first and second transform coefficient partitions and the quantized first and second transform coefficient may be scanned and entropy encoded by the “Adaptive Scan, Adaptive Entropy Encoder, and Bitstream Formatter” into a bitstream (bitstr).

FIG. 6B illustrates a block diagram of an example decoder 602 without spatial prediction, arranged in accordance with at least some implementations of the present disclosure. For example, the decoder of FIG. 6B may correctly decode bitstreams produced by the encoder of FIG. 6A. For example, the decoder of FIG. 6B may not include spatial prediction but may provide functionality associated with all the other components of the decoder of FIG. 5B such as a “Bitstream Unformatter, Adaptive Decoder & Adaptive Inverse Scan” module, an “Inverse Quantizer”, an “Adaptive Square/Rectangular small to large block size Inverse DCT, small block size Inverse PHT or Inverse DST” module, an “Adaptive Assembler of Square/Rectangular Blocks”, a “Deblock Filtering” module, and a “DeRinging Filtering” module. The operations of such modules has been discussed with respect to FIG. 5B and will not be repeated for the sake of brevity.

For example, decoder 602 may receive multiple transform coefficient partitions, such that the transform coefficient partitions include a square partition and a rectangular partition, at the “Adaptive Square/Rectangular small to large block size Inverse DCT, small block size Inverse PHT or Inverse DST”, which may perform an inverse adaptive parametric transform or an inverse adaptive hybrid parametric transform on at least a first transform coefficient partition of the multiple transform partitions and an inverse discrete cosine transform on at least a second transform coefficient partition of the multiple transform partitions to produce corresponding first and second transform partitions. In an embodiment, the inverse adaptive parametric transform or the inverse adaptive hybrid parametric transform may include a base matrix derived from decoded pixels neighboring the first transform partition. For example, in this context, the transform partitions may be reconstructed partitions A decoded image, frame or block may be generated based at least in part on reconstructed partitions. For example, the reconstructed partitions may be assembled by “Adaptive Assembler of Square/Rectangular Blocks” and optional deblocking and/or deringing may be applied to generate a decoded or reconstructed image, frame or block (dec. frame). In an embodiment, the first transform partition comprises a partition size that is within a small partition size subset of available partition sizes and the second transform partition has a partition size that is within the available partition sizes. In an embodiment, the first transform partition has a size of 4×4 pixels, 8×4 pixels, 4×8 pixels, or 8×8 pixels. In an embodiment, the first transform partition has a size not greater than 8×8 pixels and the second transform partition has a size not less than 8×8 pixels.

The AVST encoder/decoder discussed (e.g., with respect to FIGS. 5A and 5B) may be used for encoding an image or a video frame or for encoding an image or a video frame that has undergone wavelet subband decomposition into various bands. As discussed, a one-level wavelet decomposition of an image/video frame results in 4 subbands (e.g., LL, HL, LH and HH subbands) each of one-quarter size such that LL subband is a low pass version of the original frame, and HL, LH and HH subbands are vertically oriented, horizontally oriented, and diagonally oriented difference signals.

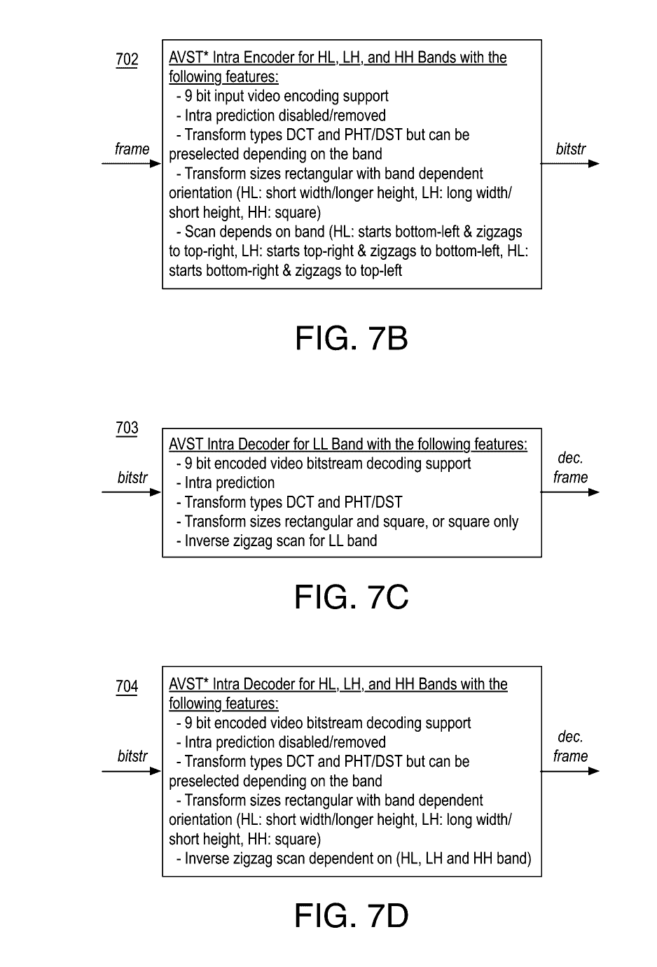

FIG. 7A illustrates example features 701 of an AVST encoder relevant to encoding of a wavelet LL subband, arranged in accordance with at least some implementations of the present disclosure. For example, efficient LL band encoding may require the ability to handle 9 bit input (e.g., instead of 8 bit input), the ability to have dc/planar/directional intra prediction (e.g., as the LL band may be similar to an original signal) to reduce redundancy, a good choice of transform types and transform sizes, and efficient scanning of resulting transform coefficients. For example, all of these features may be enabled in AVST encoding of LL bands.

FIG. 7B illustrates example features 702 of an AVST* encoder relevant to encoding of HL, LH and HH subbands, arranged in accordance with at least some implementations of the present disclosure. For example, efficient HL, LH and HH band coding may require the ability to handle 9 bit input (e.g., instead of 8 bit input), the ability to disable intra prediction, the ability to select transform types and sizes, and support of a transform coefficient scan pattern based on the band (e.g., due to directional nature of structures in each of HL, LH and HH bands).

FIG. 7C illustrates example features 703 of an AVST decoder relevant to decoding of wavelet LL subband, arranged in accordance with at least some implementations of the present disclosure. For example, an AVST decoder may include the same or similar features as those present in the complementary encoder of FIG. 7A. For example, an AVST decoder may be capable of decoding a bitstream generated by an AVST encoder.

FIG. 7D illustrates example features 704 of an AVST* decoder relevant to decoding of wavelet HL, LH and HH subbands, arranged in accordance with at least some implementations of the present disclosure. For example, an AVST* decoder may include the same or similar features as those present in the complementary encoder of FIG. 7C. For example, an AVST* decoder may be capable of decoding a bitstream generated by an AVST* encoder.

As discussed, an AVST intra codec and/or an AVST* intra codec may be applied to coding wavelet subbands. Discussion now turns to a combined wavelet subband AVST codec.

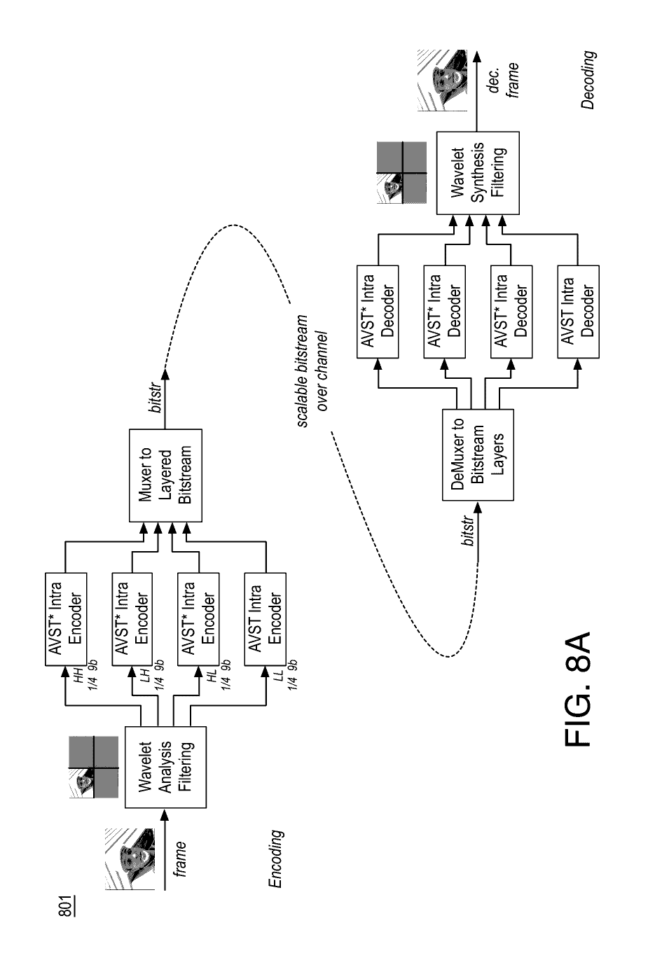

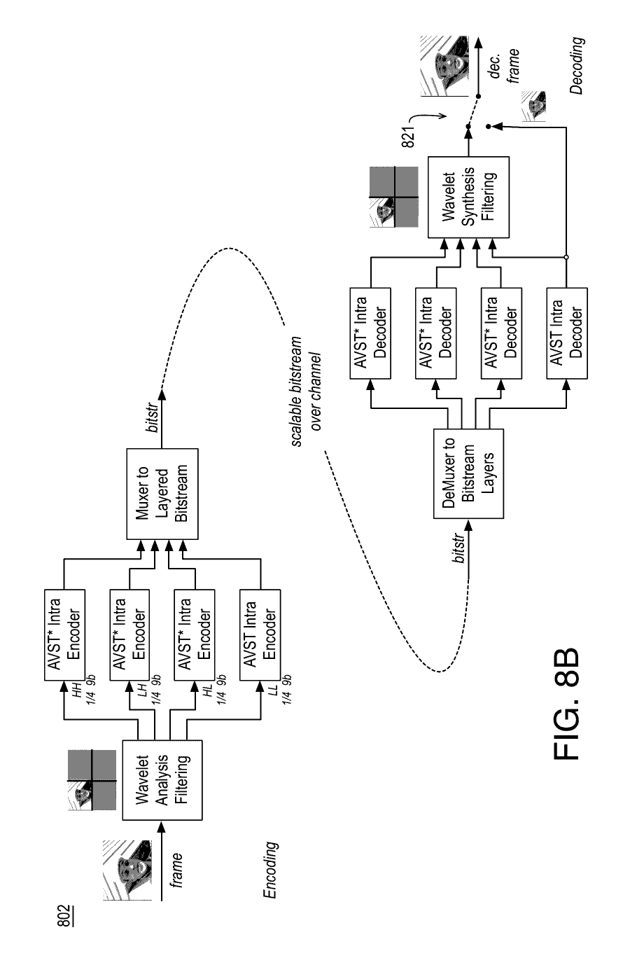

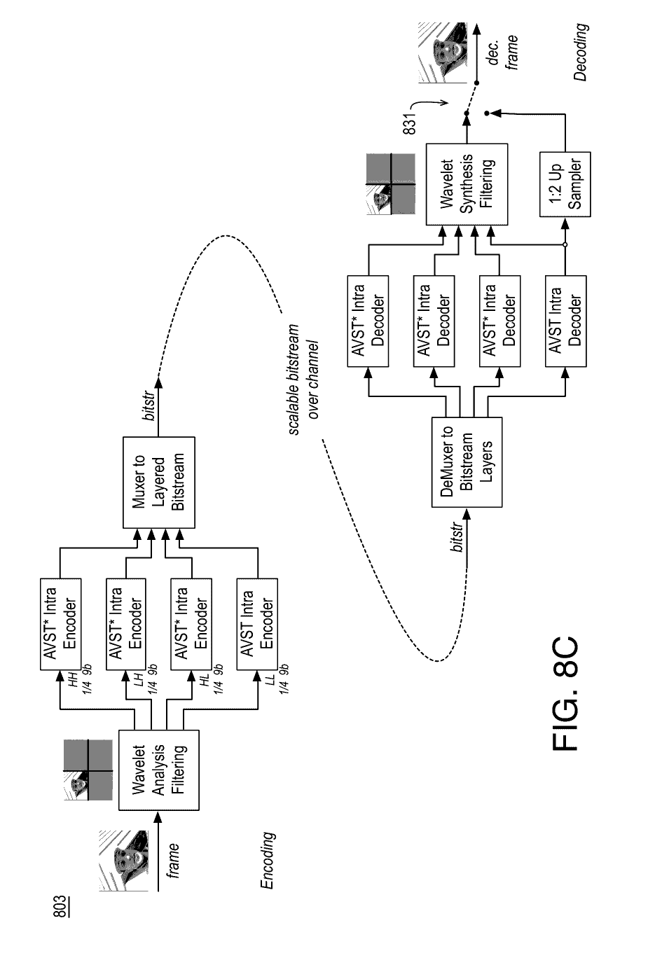

FIG. 8A illustrates a block diagram of an example combined wavelet AVST (WAVST) coder 801, arranged in accordance with at least some implementations of the present disclosure. For example, the coder of FIG. 8A may combine wavelet analysis/synthesis filtering with an efficient and flexible transform (AVST/AVST* where *=HL, LH, or HH) codec that may code a YUV frame or image and generate a decoded version of the YUV frame or image. As shown, at the encoding side, input video (or image converted to YUV) frame (e.g., a frame) may undergo wavelet decomposition in a “Wavelet Analysis Filtering” module resulting in its one level decomposition into LL, HL, LH, and HH subbands, each of which may be one-quarter in size and may have a bit depth of 9 bits (assuming 8 bit input video or image). The LL subband may then be encoded by an AVST Encoder (“AVST Intra Encoder”) with features such as described by FIG. 7A and the HL, LH, and HH subbands may be encoded with individual customized AVST* encoders (“AVST* Intra Encoder”) with features described by FIG. 7B. The outcome of the encoding process includes four individual bitstreams such as an LL bitstream, an HL bitstream, an LH bitstream, and an HH bitstream that may be multiplexed into a single scalable bitstream by a “Muxer to Layered Bitstream” for storage or transmission over the channel. The channel of FIG. 8A or any channel discussed herein may be any suitable communications channel or memory device or the like.

For example, at the encoder side, an original image or frame (frame) may be received for intra coding, wavelet decomposition may be performed by the “Wavelet Analysis Filtering” on the original image or intra frame to generate multiple subbands of the original image or intra frame, a first subband of the multiple subbands may be partitioned into multiple partitions for prediction (as discussed with respect to coder 501), each of the partitions for prediction may be differenced with corresponding predicted partitions to generate corresponding prediction difference partitions (as discussed with respect to coder 501), the prediction difference partitions may be partitioned into multiple first transform partitions for transform coding (as discussed with respect to coder 501) such that the first transform partitions are of equal or smaller size with respect to their corresponding prediction difference partitions, and a second subband of the plurality of subbands may be partitioned into multiple second transform partitions for transform coding (as discussed with respect to coder 502). In an embodiment, the wavelet decomposition comprises wavelet analysis filtering. In an embodiment, the plurality of partitions for prediction comprise at least a square partition and a rectangular partition. In an embodiment, the transform partitions may include at least a square partition and a rectangular partition. For example, the first subband may be an LL subband and the second subband may be at least one of an HL, LH, or HH subband as discussed herein. In an embodiment, an adaptive parametric or adaptive hybrid parametric transform may be performed on at least a first transform partition of the multiple first transform partitions and a discrete cosine transform on at least a second transform partition of the plurality of first transform partitions such that the first transform partition is smaller than the second transform partition and the adaptive parametric transform or the adaptive hybrid parametric transform comprises a base matrix derived from decoded pixels neighboring the first transform partition. In an embodiment, the first and second subbands have a bit depth of 9 bits when the original image or frame has a bit depth of 8 bits.

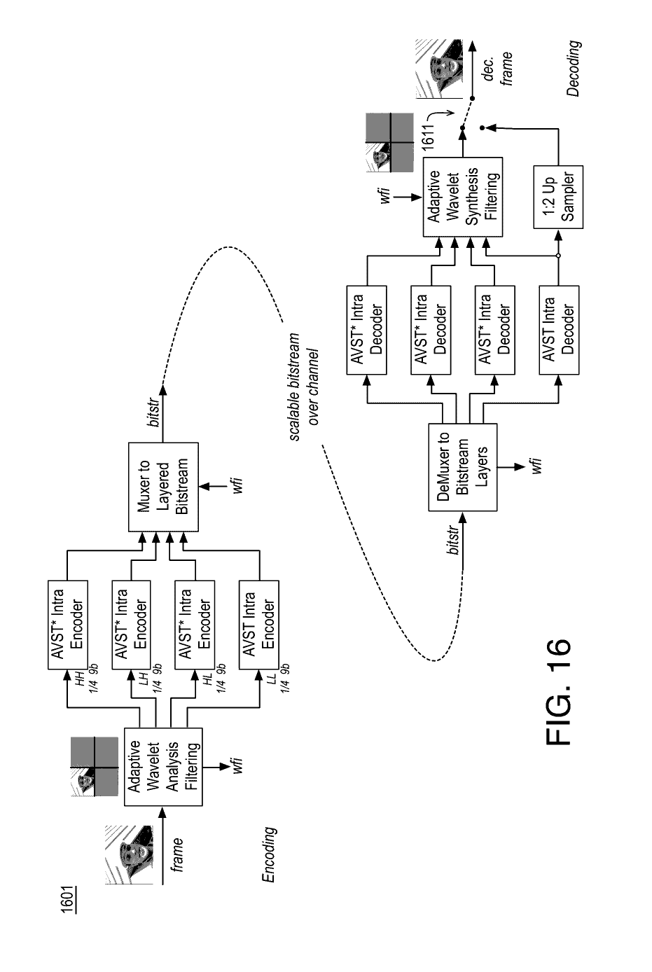

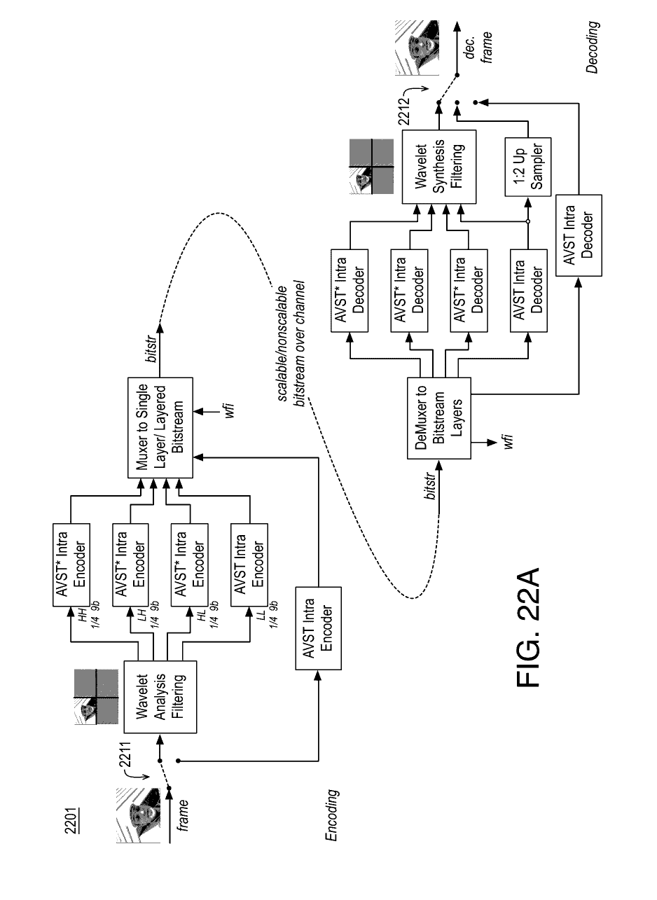

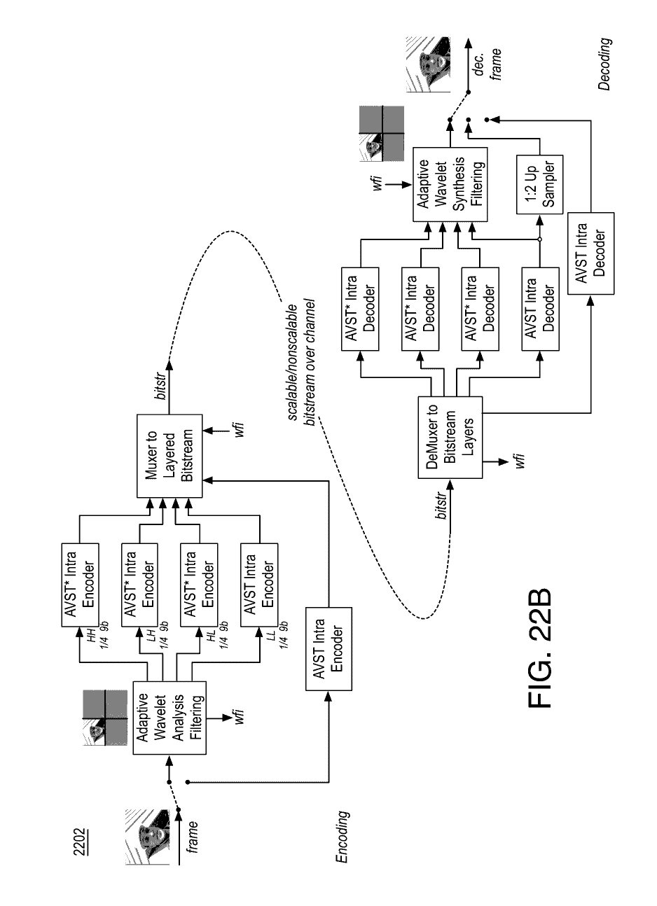

Such processing may be performed at the encoder side of FIG. 8A, 8B, 8C, 16, 22A, or 22B, for example. In the context of FIGS. 8A, 8B, 8C, and 22A, the wavelet decomposition filtering may be fixed wavelet analysis filtering. In the context of FIGS. 16 and 22B, the wavelet decomposition may be adaptive wavelet analysis filtering based on at least one of content characteristics of the original image or frame, a target resolution, or an application parameter such as a target bitrate. In such embodiments, the adaptive wavelet analysis filtering may include selection of a selected wavelet filter set from a plurality of available wavelet filter sets. In such embodiments, the adaptive wavelet analysis filtering may further include inserting a selected wavelet filter set indicator associated with the selected wavelet filter set for the original image or frame being intra coded, into a bitstream.

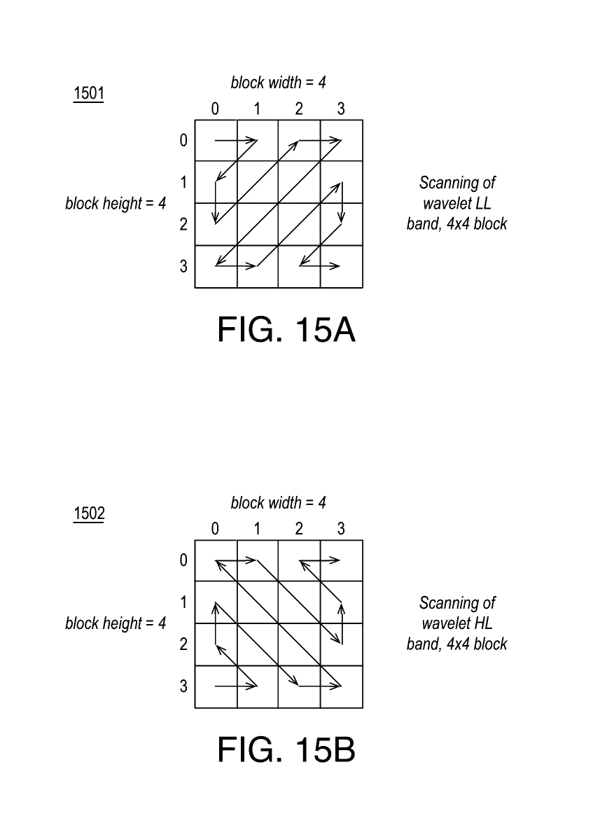

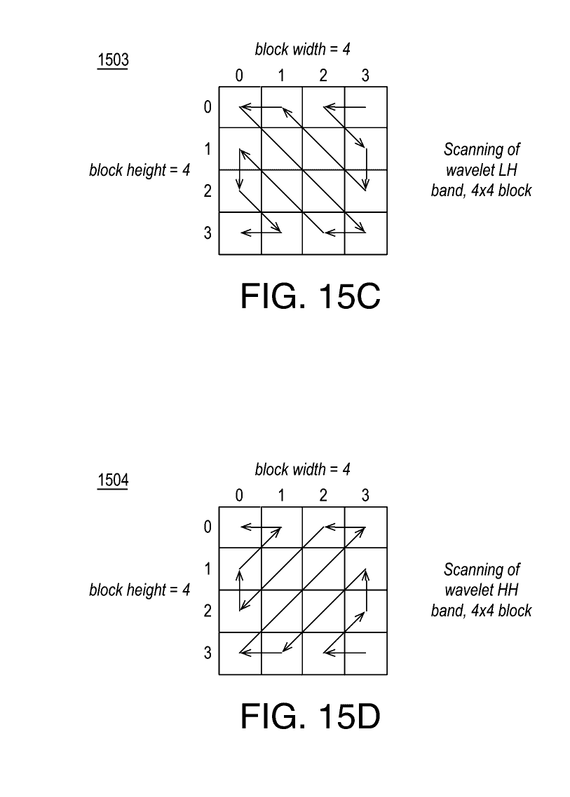

In any event, such techniques may further included transforming a first transform partition of the second partitions and scanning coefficients of the transformed first transform partition such that: when the second subband comprises an HL subband, scanning the coefficients comprises scanning the coefficients in a zigzag pattern from a bottom-left corner to a top-right corner of the transformed first transform partition, when the second subband comprises an LH subband, scanning the coefficients comprises scanning the coefficients in a zigzag pattern from a top-right corner to a bottom-left corner of the transformed first transform partition, and, when the second subband comprises an HH subband, scanning the coefficients comprises scanning the coefficients in a zigzag pattern from a bottom-right corner to a top-left corner of the transformed first transform partition, as is discussed further herein with respect to FIGS. 15A-15D.

As also shown in FIG. 8A, at the decoding side, the multiplexed bitstream may be demultiplexed by a “DeMuxer to Bitstream Layers” into individual LL, HL, LH, and HH bitstreams that may then be sent to corresponding AVST or individual custom AVST* decoders. For example, the LL subband may be sent to an “AVST Intra Decoder” and the HL, LH, and HH bitstreams may be sent to corresponding “AVST* Intra Decoders”. The resulting four, quarter size decoded subbands may be composed by a “Wavelet Synthesis Filtering” module to provide a full resolution/size final reconstructed video (or image) frame (dec. frame) for display. Although the bitstream is scalable, the use case described with respect to FIG. 8A may provide for reconstruction for display of only a single full size video (or image) frame.

For example, at the decoder side, a scalable bitstream may be demultiplexed by “DeMuxer to Bitstream Layers” to generate multiple bitstreams each associated with a subband of a plurality of wavelet subbands, multiple transform coefficient partitions, including at least a square partition and a rectangular partition, for a first subband of the multiple wavelet subbands may be generated (as discussed with respect to decoder 502), an inverse adaptive parametric transform or an inverse adaptive hybrid parametric transform may be performed on at least a first transform coefficient partition of the plurality of transform partitions and an inverse discrete cosine transform may be performed on at least a second transform coefficient partition of the plurality of transform partitions to produce corresponding first and second transform partitions (as discussed with respect to decoder 502), and a decoded image, frame or block may be generated based at least in part on the first and second transform partitions.

The decoded image, frame or block may be generated based on decoding the first subband based at least in part on the first and second transform partitions (by the “AVST Intra Decoder”), decoding remaining subbands of the plurality of wavelet subbands (by the “AVST* Intra Decoders”), and performing wavelet synthesis filtering on the first and the remaining subbands (by the “Wavelet Synthesis Filtering” module) to generate a reconstructed image or frame. Such processing may be performed as discussed with respect to FIGS. 8A, 8B (when an output selection is full resolution), 8C (when an output selection is full resolution), or 16 (when an output selection is full resolution).

In other contexts a low resolution output selection may be made and generating the decoded image, frame, or block may include decoding the first subband only as discussed with respect to FIG. 8B and/or with optional upsampling as discussed with respect to FIG. 8C and FIG. 16.

Furthermore, such wavelet synthesis filtering may be fixed (as discussed with respect to FIGS. 8A-8C) or adaptive (as discussed with respect to FIG. 16. In the context of adaptive wavelet synthesis filtering, a selected wavelet filter set indicator may be determined from the scalable bitstream and associated with a selected wavelet filter set from a plurality of available wavelet filter sets such that the selected wavelet filter set is used for wavelet synthesis filtering.

As discussed herein, in an embodiment, the first subband may be an LL subband and the remaining subbands may be at least one of an HL, LH, or HH subband. In an embodiment, the adaptive parametric transform or the adaptive hybrid parametric transform comprises a base matrix derived from decoded pixels neighboring the first transform partition.

FIG. 8B illustrates a block diagram of another example combined wavelet AVST (WAVST) coder 802, arranged in accordance with at least some implementations of the present disclosure. For example, the coder of FIG. 8B may combine wavelet analysis/synthesis filtering with an efficient and flexible transform (AVST/AVST* where *=HL, LH, or HH) codec that may code a YUV frame or image that may generate two decoded versions of the YUV frame: (1) ¼-size/resolution YUV decoded LL band and (2) a full size/full quality YUV frame or image by synthesis of all 4 decoded bands. As shown, the encoding side of FIG. 8B is the same as the encoding side of FIG. 8A and will not be discussed further for the sake of brevity. On the decoding side, the multiplexed bitstream (bitstr) may be demultiplexed by a “DeMuxer to Bitstream Layers” into individual LL, HL, LH, and HH bitstreams that may then be sent to corresponding AVST or individual custom AVST* decoders. For example, the LL subband may be sent to an “AVST Intra Decoder” and the HL, LH, and HH bitstreams may be sent to “AVST* Decoders” resulting in four, quarter size decoded subbands. If a quarter size video (or image) frame is sufficient, as selected by switch 821, in place of a full size video (or image) frame, just the LL decoded output of the AVST Intra decoder (e.g., after bit depth limiting to 8 bits—not shown) may be sent to display. If full size video (or image) frame is needed, as selected by switch 821, the four, quarter size decoded subbands may be composed by a “Wavelet Synthesis Filtering” module resulting in a full resolution/size reconstructed video (or image) frame. The selection between low size/resolution or full size/resolution for the generation of the image or frame (dec. frame) may be made using any suitable technique or techniques. In an embodiment, a user requirement of which video (or image) frame to display may be translated into a control signal that controls the operation of the switch, as shown, that may route the appropriate video (or image) frame for display.

The structure of FIG. 8B illustrates the use of scalability allowing a smaller picture to be extracted, decoded, and displayed from a single encoded bitstream without the necessity of having to decode a full size frame. Such structures or techniques may be important in cases where decoding resources are limited or the like.

FIG. 8C illustrates a block diagram of another example combined wavelet AVST (WAVST) coder 803, arranged in accordance with at least some implementations of the present disclosure. For example, the coder of FIG. 8C may combine wavelet analysis/synthesis filtering with an efficient and flexible transform (AVST/AVST* where *=HL, LH, or HH) codec that may code a YUV frame or image that may generate two decoded versions of the YUV frame: (1) a full size but lower quality YUV frame obtained from upsampling a ¼-resolution YUV decoded LL band and (2) a full size/full quality YUV frame or image by synthesis of all 4 decoded bands. As shown, the encoding side of FIG. 8C is the same as the encoding side of FIGS. 8A and 8B and will not be discussed further for the sake of brevity. Furthermore, most of the decoding side is the same as the decoding side of FIG. 8B (and will not be discussed with respect to FIG. 8C) except that switch 831 controls three options for display with the two being substantially the same (e.g., ¼ size decoded LL and full resolution/size decoded) frame with a third choice now including being able to display a 2:1 upsampled in each direction version of LL reconstructed frame that is quarter-resolution/full size for display. For example, a selection may be made from the output of the AVST Intra Decoder to upsample, via a “1:2 Upsampler” the ¼ size decoded LL subband to full size.

For example, FIG. 8C may illustrate the capability of scalability that is similar to the coder of FIG. 8B and decoder side scaling to generate a full size video (or image) frame. For the case of one level decomposition discussed herein, such techniques may be effective as the LL band from one level decomposition may contain quite a bit of aggregate frequency information as compared to a spatially downsampled image.

Although discussed with respect to single level decomposition, the combined wavelet subband AVST coding architecture described herein is extendable to two level decomposition. As discussed herein, two level decomposition may produce 7 subbands as the LL subband from the first level decomposition may undergo another level of decomposition into four subbands. The processes and structures discussed herein are also extensible to higher levels of decomposition.

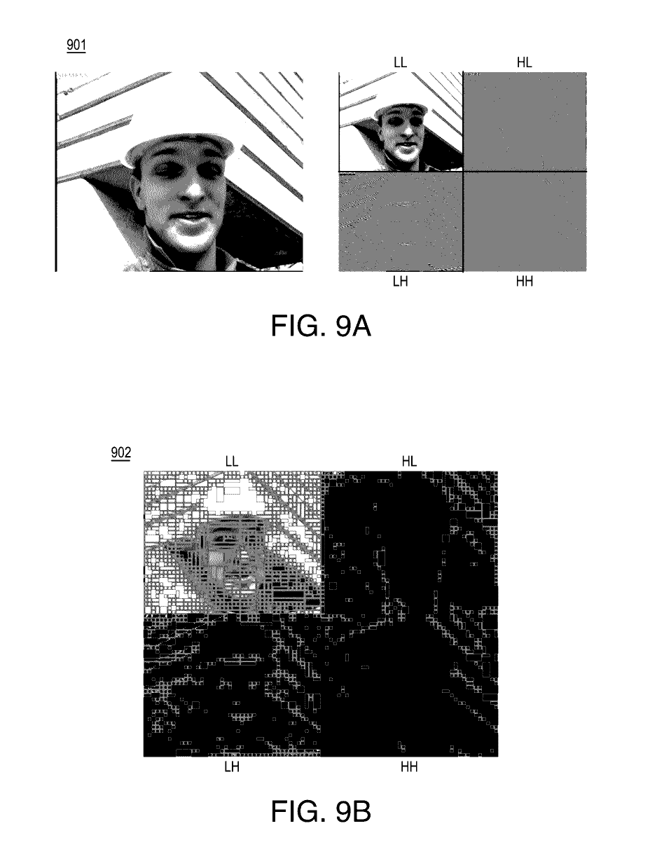

FIG. 9A illustrates an example one level decomposition 901 using wavelet analysis filters of a frame of the “Foreman” video sequence into LL, HL, LH and HH subbands, arranged in accordance with at least some implementations of the present disclosure. As shown, the LL subband may look like the original video frame (on the left), whereas the HL, LH and HH signals may represent differences and may be much smaller magnitude (e.g., hardly visible in FIG. 9A).

FIG. 9B illustrates, for each of the four bands, example AVST/AVST* block transform partitioning 902, arranged in accordance with at least some implementations of the present disclosure. For example, the block transform partitioning of FIG. 9B may provide for coding using a number of block sizes as well as blocks of rectangular and square shapes. As shown, partitioning for the HL band may be horizontally shorter but vertically longer blocks that correspond to vertical edges, whereas for the LH band, horizontally long and vertically short blocks may be provided. Furthermore, both the LL band and the HH band may mostly use square blocks. The regions not covered by overlaid blocks may be a very predictable and may be predicted from neighbors for example.

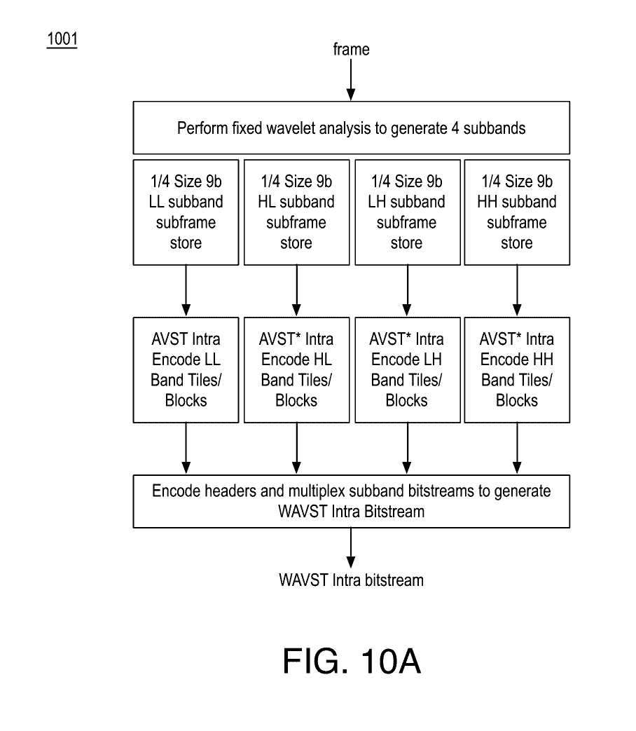

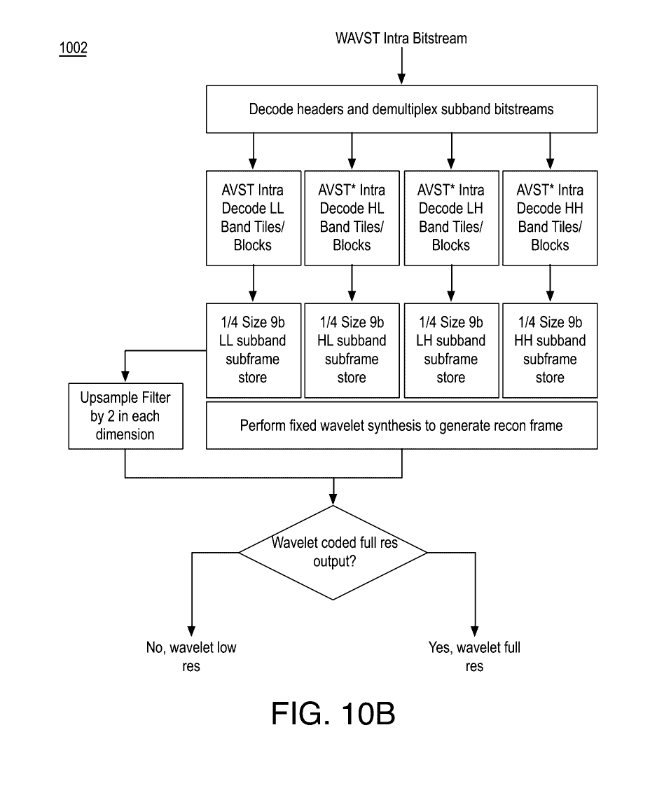

FIG. 10A illustrates a flowchart of an example process 1001 of WAVST Intra Encoding, arranged in accordance with at least some implementations of the present disclosure. As shown, Input video (or an image) frame (labeled as “frame”) may undergo one-level wavelet analysis filtering (at the operation labeled “Perform fixed wavelet analysis to generate 4 subbands”) to generate 4 subbands with each subband being ¼^{th} the size of the input frame and including subband coefficients (also referred to as subband pixels or samples) that may be 9 bit in accuracy when pixels of the input frame are of 8 bit accuracy. Each of the generated subbands may then be stored in respective one-quarter size subframe stores (at the operations labeled “¼ Size 9b LL/HL/LH/HH subband subframe store”). The subbands may then be partitioned into tiles and blocks that may be input to a corresponding AVST Intra (LL) encoder or AVST* Intra (HL, LH or HH) encoders that may encode the subband tiles and blocks (at the operations labeled “AVST Intra Encode LL Band Tiles/Blocks” and “AVST* Intra Encode HL/LH/HH Band Tiles/Blocks”). The individual generated bitstreams from these AVST/AVST* encoders may then be combined with headers and multiplexed to generate a single WAVST coded bitstream (at the operation labeled “Encode headers and multiplex subband bitstreams to generate WAVST Intra Bitstream” to generate a “WAVST Intra bitstream”) for storage or transmission. The coding method may generate a scalable bitstream in which the LL subband bitstream can be decoded independently or all four subbands may be decoded together.

FIG. 10B illustrates a flowchart of an example process 1002 for WAVST Intra Decoding, arranged in accordance with at least some implementations of the present disclosure. As shown, process 1002 may invert the process performed by WAVST Intra encoding. For example, headers of a WAVST Intra bitstream (labeled “WAVST Intra Bitstream”) may be decoded and the remaining bitstream may be demultiplexed into each of individual LL, HL, LH, and HH bitstreams (at the operation labeled “Decode headers and demultiplex subband bitstreams”). As shown, if the user (or the system or the like) requests low resolution output (at the decision operation labeled “Wavelet coded full res output?”), the decoded LL subband signal may be bit depth limited (not shown) and optionally upsampled (at the operation labeled “Upsample Filter by 2 in each dimension”) to generate a low resolution upsampled video/image frame and sent to output to display (labeled as “No, wavelet low res”). If the user (or the system or the like) requests full resolution output, each of the four subbands may be decoded by appropriate decoders (at operations labeled “AVST Intra Decode LL Band Tiles/Blocks” and “AVST* Intra Decode HL/LH/HH Band Tiles/Blocks”). For example, the LL subband may be decoded by an AVST decoder and the HL, LH, and HH subbands may be decoded by respective AVST* decoders. The decoded subbands may be stored in sub-frame stores (at the operations labeled “¼ Size 9b LL/HL/LH/HH subband subframe store”). The decoded LL, HL, LH, and HH subbands from sub-frame stores may undergo frame synthesis filtering (e.g., via wavelet synthesis filters at the operation labeled “Perform fixed wavelet synthesis to generate recon frame”) to combine the decoded subbands resulting in a full reconstructed video/image frame (labeled as “Yes, wavelet full res”) that may be output to display. As discussed, such conditional decoding where either the low resolution output or full resolution output is decoded from the same bitstream depending on user request or other signaling (such as due to decoding resource limitations, etc.) may be referred to as scalable decoding and may be possible due to scalable (also called embedded) encoding that can be performed more efficiently due to wavelet coding. The illustrated type of scalability may provide 2 layers: a quarter resolution layer and a full resolution layer. In other examples, wavelet coding may provide many layer scalability but with some loss in compression efficiency. For example, two layer scalability (that may be referred to as basic scalability) does not incur compression efficiency costs.

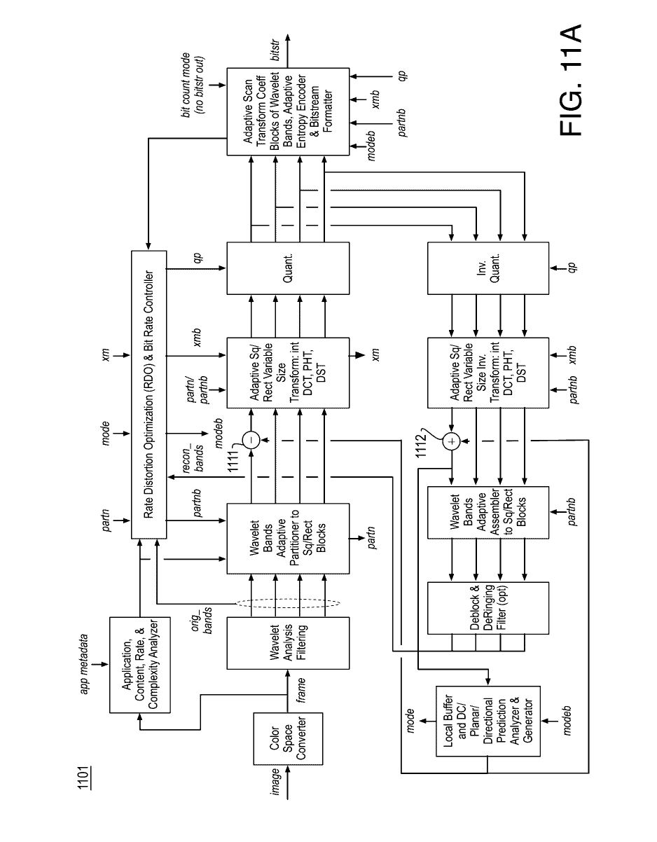

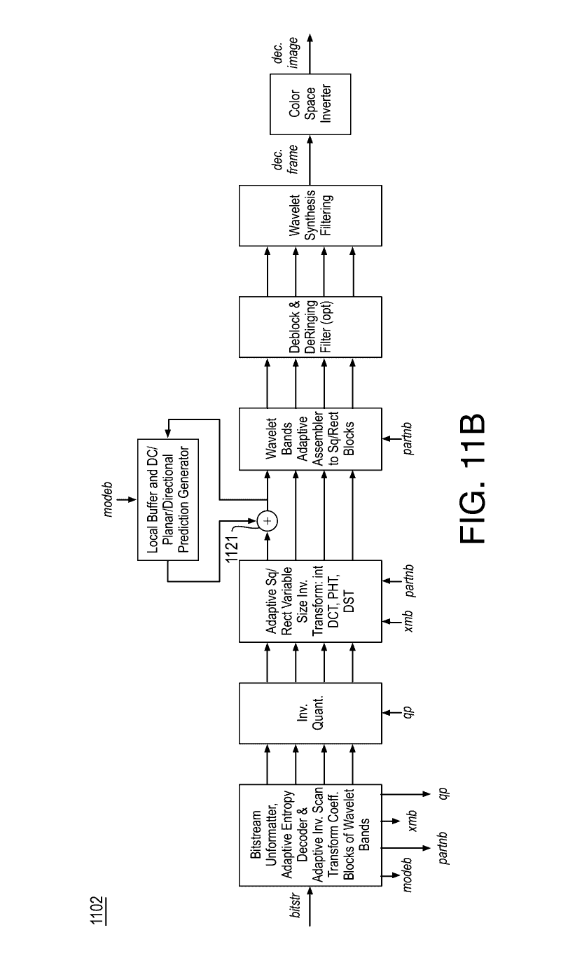

FIG. 11A illustrates a functional block diagram of an example WAVST Intra Encoder 1101, arranged in accordance with at least some implementations of the present disclosure. As shown, an input image or frame (image) may be color converted from RGB to a YUV frame (if the input is a YUV video frame rather than an RGB image then conversion may not be needed) via a “Color Space Converter” to generate a color converted image or frame (frame). Furthermore, without loss of generality it is assumed that a YUV frame is of 4:2:0 format (e.g., the U and V resolutions are one-half of that of Y in both the horizontal and vertical directions). Based on evaluation of application parameters (e.g., image/frame resolution, bitrate) and content (e.g., complexity) by an “Application, Content, Rate & Complexity Analyzer,” quality and rate targets may be set, partitioning of bands may be regulated, and bitrate control may be performed. Such processes are described further herein.

As shown, the YUV frame may undergo one level decomposition into LL, HL, LH, and HH subbands as performed by a “Wavelet Analysis Filtering” module and then the content of each tile of each band may be partitioned under control of a “Rate Distortion Optimization & Bit Rate Controller” module (that may provide for a best selection of partition size, prediction mode, and transform type) into variable size blocks that may be of square shape only or a combination of square and rectangular shapes by a “Wavelet Bands Adaptive Partitioner to Square/Rectangular Blocks.” The outcome of such processing is many candidate partitions (partn) of each tile.

Furthermore, for each LL band tile partition, several candidate intra (DC, planar, and directional) prediction modes (mode) may be generated using decoded neighboring blocks by a “Local Buffer and DC/Planar/Directional Prediction Analyzer & Generator”. For example, for other (HL, LH, HH) band tile partitions, intra prediction is not performed.

As shown in FIG. 11A, LL band tile partition samples may differenced with candidate prediction partition samples (from a “Deblock & DeRinging Filtering” module) by differencer 1111 to determine candidate difference partitions that may be transformed by an “Adaptive Square/Rectangular Variable Size Transform: DCT, PHT, DST” module resulting in candidate transform coefficient blocks. For other bands, no predictions are needed and thus the prediction partition/blocks samples are directly transformed resulting in transform coefficient blocks. All transform coefficient blocks may be quantized by a “Quantizer” and entropy encoded. All bit costs such as transform coefficients entropy coding bit costs, partitioning bit costs, prediction mode bit costs, and transform selection bit costs may be determined by an “Adaptive Scan Transform Coefficient Blocks of Wavelet Bands, Adaptive Entropy Encoder & Bitstream Formatter” module. Thus for a combination (partition size, prediction mode, transform choice, transform coefficients block) not only cost may be determined but also reconstructed partition and thus the distortion. These costs and distortions are used in rate distortion optimization as follows.

Given a set of candidate partitions (partn) of each tile, candidate intra prediction modes (mode), candidate transforms (xm), and potential quantizer values (Q), the “Rate Distortion Optimization & Bit Rate Controller” may make decisions using the bitrate (from bit costs provided by entropy encoder) and using distortion (from a difference of the original and the reconstructed subband portions) measures on the best encoding strategy by determining the best partitionings (partnb), the best intra prediction mode (modeb) for each partition, the best transform (xmb) to use for coding of each partition, and the quantizer (qp) that will allow achieving the best (e.g., RD tradeoff) quality results under constraint of the available bitrate. These selections of partnb, modeb, xmb, and qp may be sent via a bitstream to the decoder.

The process of forming predictions from neighbors requires reconstruction of neighboring blocks and requiring a decoding loop at the encoder. Furthermore, it is noted that a “reconstructed partition” may be generated for use by RDO. For example, quantized coefficient blocks of each band at encoder 1101 may go through dequantization at an “Inverse Quantizer,” followed by inverse transform with the appropriate transform in an “Adaptive Square/Rectangular Variable Size Inverse Transform: DCT, PHT, DST” module resulting in blocks of reconstructed samples of HL, LH, and HH bands, and interim blocks of reconstructed samples of the LL band. For the LL band, a prediction mode may be used to acquire the prediction block to add to the LL band interim reconstructed block to generate a final reconstructed block. Reconstructed LL band blocks may also be saved in a local buffer and used for current block prediction by the “Local Buffer and DC/Planar/Directional Prediction Analyzer & Generator” with the predicted block forming one input to adder 1112, at the other input of which is the current partition/block being coded. Also, since full reconstruction of all bands may be needed for the purpose of computing distortion, the reconstructed LL band and the other (HL, LH, HH) band blocks may be assembled to form tiles by a “Wavelet Bands Adaptive Assembler to Square/Rectangular Blocks” module and then may undergo optional deblocking and deringing by the “Deblock & DeRinging Filtering” module resulting in reduced artifacts in reconstructed LL, HL, LH, and HH bands that may be input to RDO for use in computing distortion.

FIG. 11B illustrates a functional block diagram of an example functional standalone WAVST Intra Decoder 1102, arranged in accordance with at least some implementations of the present disclosure. For example, much of the discussion of FIG. 11A associated with the decoding loop in WAVST Intra Encoder may be applicable to the discussion of decoder 1102 (with exception of the “Wavelet Synthesis Filtering” module and the “Color Space Inverter” much of the functionality of decoder 1102 has been discussed). As shown, an encoded WAVST bitstream (bitstr) may be decoded by a “Bitstream Unformatter, Adaptive Entropy Decoder & Adaptive Inverse Scan Transform Coefficient Blocks of Wavelet Bands” module resulting in selected partitioning info (partnb), selected intra pred mode info (modeb) and selected transform info (xmb), selected quantizer (qp), as well as quantized transform coefficient blocks. The transform coefficient blocks may be dequantized using quantizer qp by an “Inverse Quantizer” and inverse transformed using the transform indicated by xmb, by an “Adaptive Square/Rectangular Variable Size Inverse Transform: DCT, PHT, DST” module resulting in blocks of reconstructed samples of the HL, LH and HH bands, and blocks of interim samples for the LL band. As discussed, by adding prediction blocks (generated using prediction modeb info by a “Local Buffer and DC/Planar/Directional Prediction Generator”) via adder 1121 to decoded interim blocks, final blocks of LL band may be generated. All partitions/blocks of each wavelet band are assembled into tiles and thus to full bands by the “Wavelet Bands Adaptive Assembler to Square/Rectangular Blocks” and may undergo optional deblocking and deringing by a “Deblock & DeRinging Filter” module to reduce coding artifacts and may be input to a “Wavelet Synthesis Filtering” module that may use filters that are complimentary to the wavelet analysis filters to perform synthesis filtering that combines all 4 bands to generate a decoded YUV frame. Depending on the application either this frame itself (dec. frame) may be sufficient or it may need to be converted to RGB format image (dec. image) by optional processing by a “Color Space Inverter.”

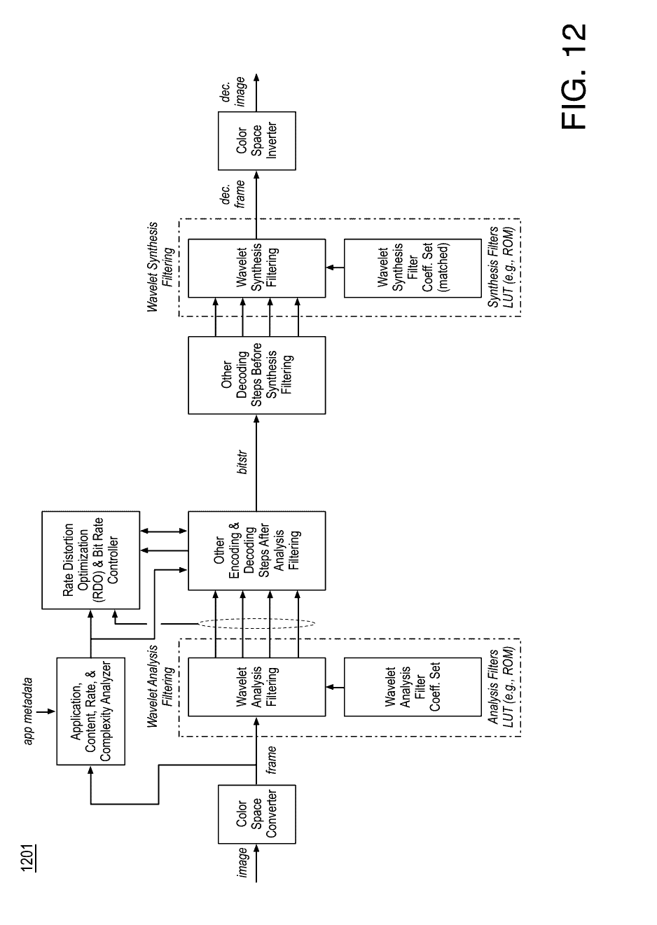

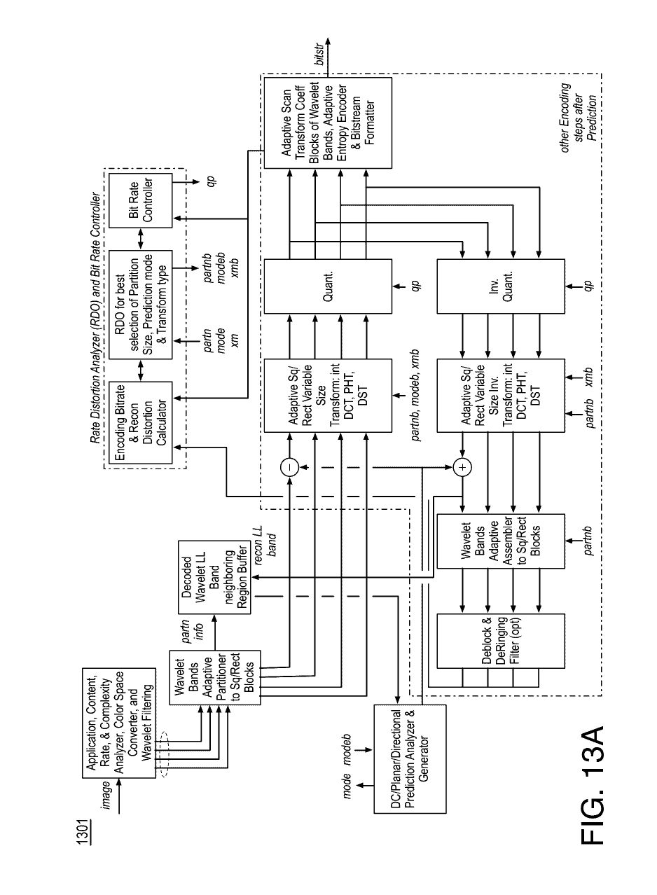

FIG. 12 illustrates an example system 1201 including details of the “Wavelet Analysis Filter” in the WAVST Encoder of FIG. 11A and the “Wavelet Synthesis Filter” in the WAVST Decoder of FIG. 11B, arranged in accordance with at least some implementations of the present disclosure. Furthermore, FIG. 12 illustrates interfaces to the rest of the encoder and decoder. For example, FIG. 12 shows some actual blocks or modules (“Color Space Converter”, “Application, Content, Rate & Complexity Analyzer”, “Rate Distortion Optimization (RDO) & Bit rate Controller”, and “Color Space Inverter”) and some bundled blocks (“Other Encoding & Decoding Steps After Analysis Filtering” and “Other Decoding Steps Before Synthesis Filtering”) that either interface with the “Wavelet Analysis Filter” module or the “Wavelet Synthesis Filter” module. As shown, in an embodiment, the “Wavelet Analysis Filter” module may be composed of two modules (e.g., a “Wavelet Analysis Filter Coefficient Set” and a “Wavelet Analysis Filtering” unit). For example, the “Wavelet Analysis Filter Coefficient Set” may be a lookup table (LUT) of a filter set such that the first filter in the set may be used for low pass analysis filtering (lpaf) and the second filter in the set may be used for high pass analysis filtering (hpaf) as discussed herein. The “Wavelet Analysis Filtering” module may use the aforementioned filter sets to perform subband decomposition at an encoder. Furthermore, FIG. 12 shows a “Wavelet Synthesis Filter” including a “Wavelet Synthesis Filtering” unit and a “Wavelet Synthesis Filter Coefficient Set”. The “Wavelet Synthesis Filter Coefficient Set” may be a lookup table (LUT) of a set of filters with a first filter in the set used for low pass synthesis filtering (lpsf) and a second filter in the set used for high pass synthesis filtering (hpsf) as discussed herein. For example the lpsf and hpsf may be corresponding matching filters to the lpaf and hpaf filters. For example, the “Wavelet Synthesis Filtering” module may use the aforementioned filter set to perform subband re-composition at the decoder.

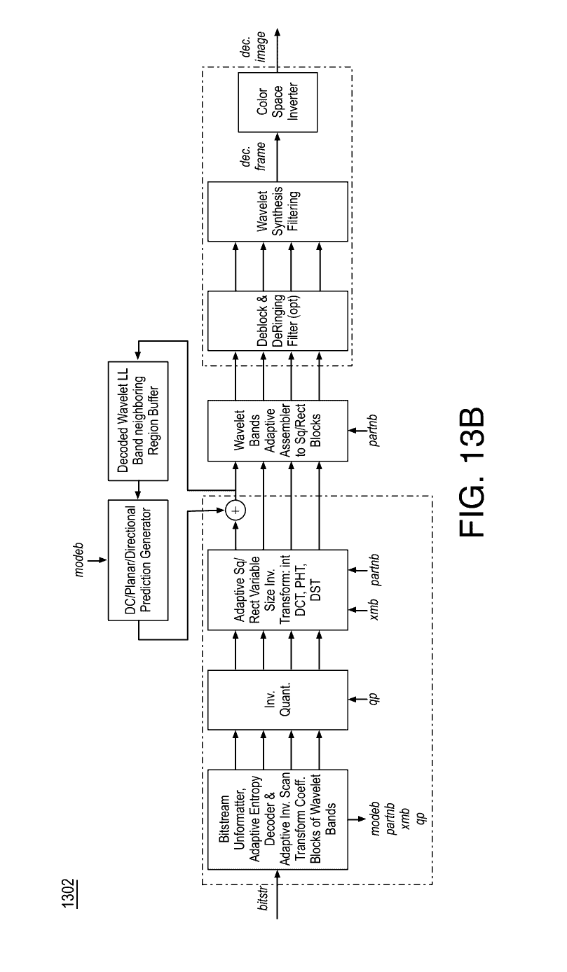

FIG. 13A illustrates an example system 1301 including details of the “Local Buffer and Prediction Analyzer and Generator” and interfaces to the rest of the WAVST Intra Encoder of FIG. 11A, arranged in accordance with at least some implementations of the present disclosure. For clarity in terms of other blocks or modules, FIG. 13A illustrates a bundled block (“Application, Content, Rate & Complexity Analyzer, Color Space Converter, and Wavelet Analysis Filtering”) that is a combination of three modules, an unbundled block “Rate Distortion Analyzer (RDO) and Bit Rate Controller” that is shown split into 3 modules, and other blocks (“Wavelet Bands Adaptive Partitioner to Square/Rectangular Blocks”, “Differencer”, “Adaptive Square/Rectangular Variable Size Transform”, “Quantizer”, “Adaptive Scan Transform Coefficient Blocks of Wavelet Bands, Adaptive Entropy Encoder & Bitstream Formatter”, “Inverse Quantizer”, “Adaptive Square/Rectangular Variable Size Inverse Transform”, “Adder”, “Wavelet Bands Adaptive Assembler of Square/Rectangular Blocks”, and “Deblock & DeRinging Filter”) as in FIG. 11A with interfaces to “Local Buffer and Prediction Analyzer & Generator.” Furthermore, the “Local Buffer and Prediction Analyzer and Generator” module is shown divided into two units: a “Decoded Wavelet LL band neighboring Region Buffer” and a “DC/Planar/Directional Prediction Analyzer & Generator”. For example, the decoded previous blocks that are used for forming intra prediction may be stored in the “Decoded Wavelet LL band neighboring Region Buffer”. The intra prediction may be formed on a partition/block basis using the neighboring block region by generating many candidate predictions (modes) using DC prediction, planar prediction and many angles based directional prediction that are analyzed by RDO to determine the best prediction mode (modeb).

FIG. 13B illustrates an example system 1302 including details of the “Local Buffer and Prediction Generator” and interfaces to the rest of the WAVST Intra Decoder of FIG. 11B, arranged in accordance with at least some implementations of the present disclosure. Besides the blocks within the “Local Buffer and Prediction Generator” module, all other blocks (“Bitstream Unformatter, Adaptive Entropy Decoder & Adaptive Inverse Scan Transform Coefficient Blocks of Wavelet Bands”, “Inverse Quantizer”, “Adaptive Square/Rectangular Variable Size Inverse Transform”, “Adder”, “Wavelet Bands Adaptive Assembler of Square/Rectangular Blocks”, “Deblock & DeRinging Filter”, “Wavelet Synthesis Filtering”, and “Color Space Inverter”) are shown here from FIG. 11B and serve to show interfaces to this block or module. Also, the “Local Buffer and Prediction Generator” is divided into two units: a “Decoded Wavelet LL Band neighboring Region Buffer” and a “DC/Planar/Directional Prediction Generator”). The “Decoded Wavelet LL Band neighboring Region Buffer” serves to save neighboring blocks needed for making prediction by the “DC/Planar/Directional Prediction Generator”, which may use modeb to determine the best prediction mode and creates prediction for that mode only.

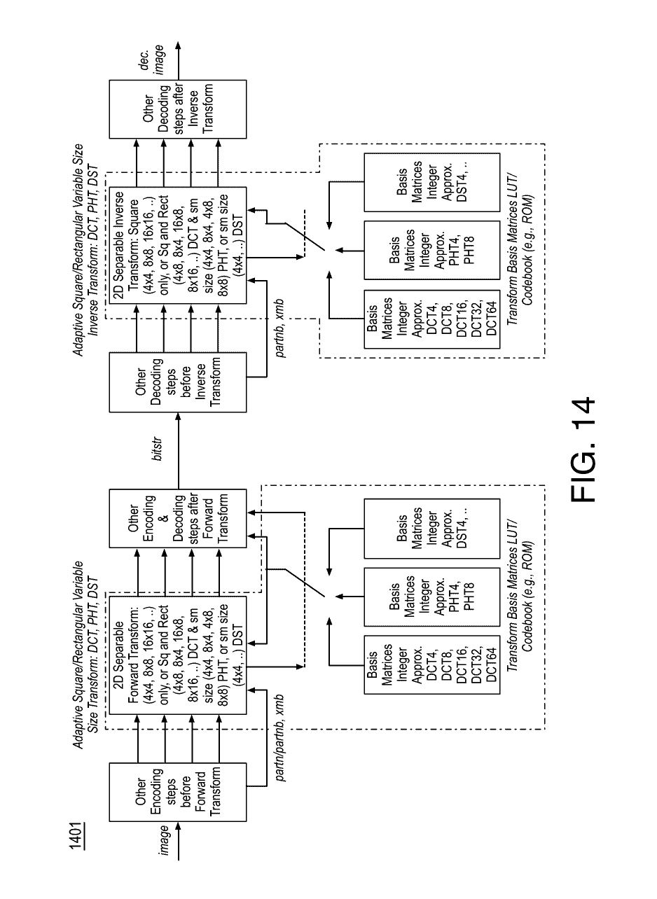

FIG. 14 illustrates an example system 1401 including details of the “Adaptive Square/Rectangular Variable Size Transform: DCT, PHT, DST” module of FIG. 11A and the “Adaptive Square/Rectangular Size Inverse Transform: DCT, PHT, DST” module of FIG. 11B, arranged in accordance with at least some implementations of the present disclosure. In the illustrated example, on the encoding side, FIG. 14 shows some bundled blocks (“Other Encoding steps before Forward Transform” and “Other Encoding & Decoding steps after Forward Transform”) that interface with the “Adaptive Square/Rectangular Variable Size Transform: DCT, PHT, DST” module, which itself includes two components” a “2D Separable Forward Transform: Square (4×4,8×8,16×16, . . . ) only, or Square and Rectangular (4×8, 8×4, 16×8, 8×16, . . . ) DCT & small size (4×4, 8×4, 4×8, 8×8) PHT, or small size (4×4, . . . ) DST” module and a “Transform Basis Matrices LUT/Codebook” module. For example, the supported choices for forward transform for square blocks sizes may be 4×4, 8×8, 16×16, 32×32, and 64×64 integer DCT approximation, for square and rectangular blocks including the square block sizes just listed and rectangular blocks may be 4×8, 8×4, 16×8, 8×16, 32×8, 8×32, 32×16, 16×32, 16×64, 64×16, 64×32, 32×64, . . . integer DCT approximation, for smaller block sizes (e.g., 4×4, 4×8, 8×4, and 8×8) integer PHT, and for very small block sizes (e.g., 4×4) integer DST approximation. For example, the transforms may include an adaptive parametric transform or an adaptive hybrid such that the adaptive parametric transform or the adaptive hybrid parametric transform include a base matrix derived from decoded pixels neighboring transform partition, as discussed herein.

Furthermore, the encoder may send a number of control signals via the bitstream it generates (e.g., bitstr). The bitstream formatting process is not shown explicitly but is incorporated in the bundled block “Other Encoding & Decoding steps after Forward Transform”. Such control signals carry information such as best partitioning for a tile (partnb), the best mode decision per partition (modeb), and the best transform per partition (xmb). Such control signals at the decoder may be decoded by a bundled block “Other Decoding steps before Inverse Transform” that may perform bitstream unformatting among other operations and such control signals may control the decoding process at the decoder.

Furthermore, on the decoding side, FIG. 14 shows several bundled blocks (“Other Decoding steps before Inverse Transform” and “Other Decoding steps after Inverse Transform”) that interface with the “Adaptive Square/Rectangular Variable Size Inverse Transform: DCT, PHT, DST” module, which itself includes two components : a“2D Separable Inverse Transform: Square (4×4, 8×8, 16×16, . . . ) only, or Square and Rectangular (4×8, 8×4, 16×8, 8×16, . . . ) DCT & small size (4×4, 8×4, 4×8, 8×8) PHT, or small size (4×4, . . . ) DST” module and a “Transform Basis Matrices LUT/Codebook” module (e.g., as on the encoder side). For example, the supported choices for inverse transform may be the same as those discussed with respect to the forward transform.

Next, FIGS. 15A, 15B, 15C, and 15D correspondingly show by example using 4×4 transform blocks (although the principle is valid for all block sizes, and shapes—whether square or rectangular), improved scanning for transform block coefficients in LL, HL, LH, and HH bands.

FIG. 15A illustrates, for the LL band, zigzag scanning 1501 of 4×4 blocks of samples that are transformed to 4×4 blocks of transform coefficients, arranged in accordance with at least some implementations of the present disclosure. For example, FIG. 15A illustrates scanning of LL band 4×4 block transform coefficients in WAVST/AWAVST intra coding. As shown, since LL band samples behave like the original signal, the zigzag scan for LL band may be the same as the zigzag scan pattern for blocks of pixels with the scan starting from DC coefficient at top-left corner, and moving to the next higher frequency horizontally, and then diagonally down to the same frequency vertically, and then moving down to next higher frequency vertically, before moving diagonally upward, scanning intermediate coefficients, on to the same frequency horizontally, and so on, until the scanning reaches the highest frequency coefficient at bottom right-hand corner of the block.

FIG. 15B illustrates, for the HL band, zigzag scanning 1502 of 4×4 blocks of samples that are transformed to 4×4 blocks of transform coefficients, arranged in accordance with at least some implementations of the present disclosure. For example, FIG. 15B illustrates scanning of HL band 4×4 block transform coefficients in WAVST/AWAVST intra coding. As shown, for the HL band, 4×4 blocks of samples that are transformed to 4×4 blocks of transform coefficients may be zigzag scanned starting from a bottom-left corner (e.g., rather than top-left) and proceeding in zigzag manner to a top-right corner where the highest frequency for the HL band resides. For example, when the subband comprises an HL subband, scanning coefficients may include scanning the coefficients in a zigzag pattern from a bottom-left corner to a top-right corner of the transformed transform partition.

FIG. 15C illustrates, for the LH band, zigzag scanning 1503 of 4×4 blocks of samples that are transformed to 4×4 blocks of transform coefficients, arranged in accordance with at least some implementations of the present disclosure. For example, FIG. 15B illustrates modified scanning of HL band 4×4 block transform coefficients in WAVST/AWAVST intra coding. As shown, for the LH band, 4×4 blocks of samples that are transformed to 4×4 blocks of transform coefficients may be zigzag scanned starting from a top-right corner (e.g., rather than top-left) and proceeding in zigzag manner to a bottom-left corner where the highest frequency for the LH band resides. For example, when the subband comprises an LH subband, scanning coefficients may include scanning the coefficients in a zigzag pattern from a top-right corner to a bottom-left corner of the transformed transform partition.

FIG. 15D illustrates, for the HH band, zigzag scanning 1504 of 4×4 blocks of samples that are transformed to 4×4 blocks of transform coefficients, arranged in accordance with at least some implementations of the present disclosure. For example, FIG. 15C illustrates modified scanning of HH band 4×4 block transform coefficients in WAVST/AWAVST intra coding. As shown, for the HH band, 4×4 blocks of samples that are transformed to 4×4 blocks of transform coefficients may be zigzag scanned starting from a bottom-right corner (e.g., rather than top-left) and proceeding in zigzag manner to a top-left corner where the highest frequency for HH band resides. For example, when the subband comprises an HH subband, scanning coefficients may include scanning the coefficients in a zigzag pattern from a bottom-right corner to a top-left corner of the transformed transform partition.

FIG. 16 illustrates a block diagram of an example combined adaptive wavelet AVST (AWAVST) coder 1601, arranged in accordance with at least some implementations of the present disclosure. For example, the coder of FIG. 16 may combine adaptive wavelet analysis/synthesis filtering with an efficient and flexible transform (AVST/AVST* where *=HL, LH, or HH) codec that may code a YUV frame or image to generate two decoded version of the YUV frame or image: (1) a full size but lower quality YUV frame or image obtained from upsampling a quarter resolution YUV decoded LL band and (2) a full size and full quality YUV frame obtained by synthesis of all 4 decoded subbands. As shown, at the encoding side, the input video (or image) YUV frame (frame) may undergo adaptive wavelet decomposition by an “Adaptive Wavelet Analysis Filtering” module using a filter set from a codebook of filter-sets with selection of filter based on application (e.g., resolution, content, and/or bitrate). Using the selected filter set, the process of analysis filtering may be performed for one level decomposition that may covert the frame into LL, HL, LH, and HH subbands, each of which are one-quarter in size and with bit depth of 9 bits (assuming 8 bit input video or image). The LL subband may be encoded by an “AVST Intra Encoder” and the HL, LH, and HH subbands may be encoded with individual customized “AVST* Intra Encoders”. The outcome of the encoding process includes four individual bitstreams such as an LL bitstream, an HL bitstream, an LH bitstream, and an HH bitstream that may be multiplexed (by a “Muxer to Layered Bitstream”) into a single scalable bitstream (bitstr) along with headers including that which carries index of selected analysis filter set.

Also shown in FIG. 16, at the decoding side, the headers including the one that carries an index of the selected filter set (e.g., a selected wavelet filter set indicator associated with the selected wavelet filter set) may be decoded and the multiplexed the bitstream (bitstr) may be demultiplexed by a “DeMuxer to Bitstream Layers” into individual LL, HL, LH, and HH bitstreams. The decoded LL bitstream may be sent to a “AVST Intra Decoder” and, depending on the user input or a system indicator or the like as implemented by switch 1611, its low resolution decoded video frame or image (after optional upsampling by 2 in each dimension by a “1:2 Up Sampler”) may be sufficient for display (dec. frame). However, if the user or system or the like desires full resolution video frames or image(s) as implemented by switch 1611, the remaining 3 (e.g., HL, LH and HH) bands may be sent to corresponding custom “AVST* Intra Decoders”. The four, quarter size decoded subbands may then be combined using a filter set that is complimentary to the analysis filter set (e.g., indicated by the index decoded from the bitstream).The process of combination of bands, which may be characterized as synthesis filtering may be performed by an “Adaptive Wavelet Synthesis Filtering” module and results in full resolution/size final reconstructed video frame(s) or image(s) (dec. frame) for display.

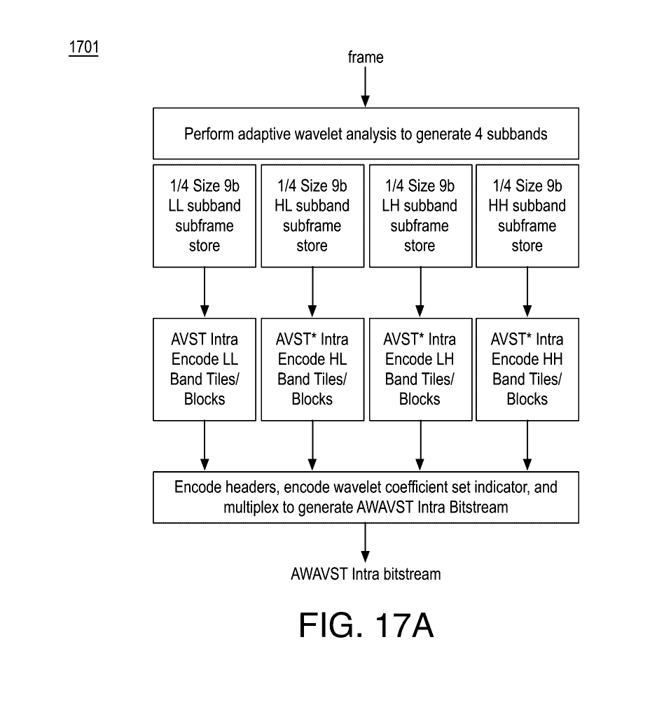

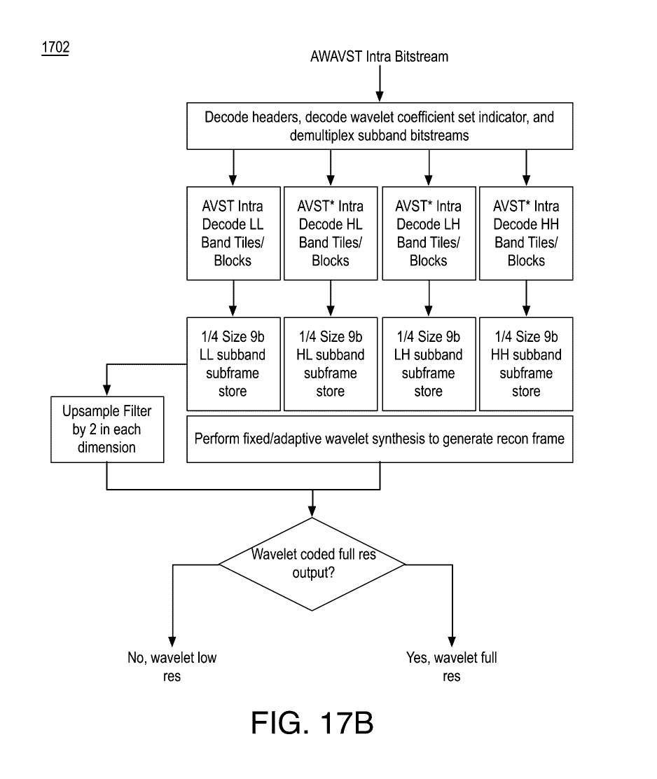

FIG. 17A illustrates a flowchart of an example process 1701 of AWAVST Intra Encoding, arranged in accordance with at least some implementations of the present disclosure. As shown, an input video (or image) frame (labeled as “frame”) may undergo one-level adaptive wavelet analysis filtering that may allow (e.g., by selecting a filter set from multiple filter sets) for choice of a best suited filter set depending on the application (e.g., resolution, content and/or bitrate). The analysis filtering process (performed at the operation labeled “Perform adaptive wavelet analysis to generate 4 subbands”) may result in four subbands with each subband being a quarter in size of the input frame and including subband coefficients (also referred to as subband pixels or samples) that are of 9 bit in accuracy when pixels of input frame are of 8 bit accuracy. Each of the generated subbands may then be stored in respective one-quarter size subframe stores (at the operations labeled “¼ Size 9b LL/HL/LH/HH subband subframe store”) and partitioned into tiles and blocks that are input to a corresponding AVST Intra Encoder (e.g., for the LL subband) and/or AVST* Intra Encoders (e.g., for the HL, LH or HH subbands), which may perform encoding (at operations labeled “AVST Intra Encode LL Band Tiles/Blocks” and “AVST* Intra Encode HL/LH/HH Band Tiles/Blocks”) to generate corresponding bitstreams. The individual generated bitstreams from these AVST/AVST* encoders may then be combined with headers, including a header or indicator that signals the wavelet filter set used for analysis, and multiplexed (at the operation labeled “Encode headers, encode wavelet coefficient set indicator, and multiplex to generate AWAVST Intra Bitstream”) to generate a single AWAVST coded bitstream (labeled “AWAVST Intra bitstream”) for storage or transmission. The encoding process of FIG. 17A may generate a scalable bitstream in which the LL subband bitstream may be decoded independently or all four subbands may be decoded together.

FIG. 17B illustrates a flowchart of an example process 1702 for AWAVST Intra Decoding, arranged in accordance with at least some implementations of the present disclosure. For example, process 1702 for AWAVST Intra Decoding may invert the process performed by the AWAVST Intra encoding process of FIG. 17A. As shown, an AWAVST Intra bitstream's (labeled as “AWAVST Intra Bitstream”) headers may be decoded including decoding information on the wavelet filter set that was used for analysis at the encoder. The remaining bitstream may then be demultiplexed (at the operation labeled “Decode headers, decode wavelet coefficient set indicator, and demultiplex subband bitstreams”) into each of individual LL, HL, LH, and HH bitstreams. If the user or system requested just low resolution output (at provided at the decision operation labeled “Wavelet coded full res output?”), the decoded LL subband signal (as decoded at the operation labeled “AVST Intra Decode LL Band Tiles/Blocks”) may be bit depth limited and optionally upsampled (at the operation labeled “Upsample Filter by 2 in each dimension”) to generate low resolution upsampled video/image frame that may be sent to output (labeled as “No, wavelet low res”). If the user or system requests full resolution output, each of the four subbands may be decoded by appropriate decoders (at operations labeled as “AVST Intra Decode LL Band Tiles/Blocks” and “AVST* Intra Decode HL/LH/HH Band Tiles/Blocks”), for example, the LL subband may be decoded by an AVST decoder, and HL, LH, and HH subbands may be decoded by AVST* decoders and all four subbands are stored in sub-frame stores (at operations labeled “¼ Size 9b LL/HL/LH/HH subband subframe store”). Based on the discussed decoded headers regarding wavelet analysis filters used at the encoder, a matching set of filters for synthesis filtering may be determined. The decoded LL, HL, LH, and HH subbands from sub-frame stores may undergo frame synthesis using the determined filters to combine the decoded subbands (at the operation labeled “Perform fixed/adaptive wavelet synthesis to generate recon frame”) resulting in full reconstructed video/image frame that may be output to display (labeled as “Yes, wavelet full res”). As discussed, this type of conditional decoding where either the low resolution output or full resolution output is decoded from the same bitstream depending on user request (such as due to decoding resource limitations etc.) may be referred to as scalable decoding and may be possible due to scalable (also called embedded) encoding that can be performed more efficiently due to wavelet coding. For example, the type of scalability illustrated may provide 2 layers: a quarter resolution layer and a full resolution layer.

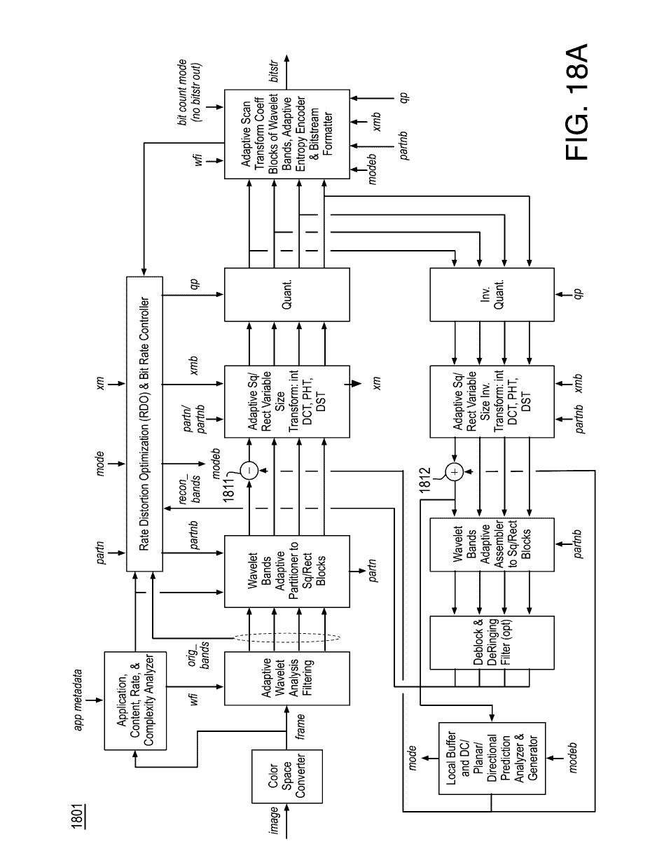

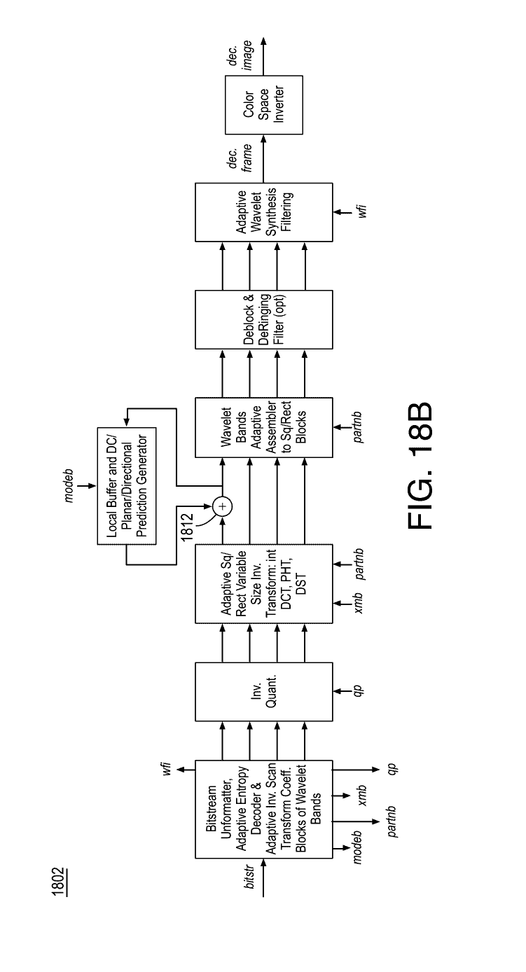

FIG. 18A illustrates a functional block diagram of an example AWAVST Intra Encoder 1801, arranged in accordance with at least some implementations of the present disclosure. As shown, an input image or frame (image) may be first color converted from RGB to a YUV image or frame (if the input is a YUV video frame rather than an RGB image then this step is not needed) (frame). Furthermore, without loss of generality, it is assumed that a YUV frame is of 4:2:0 format (e.g., U and V resolutions are one half of that of Y both in the horizontal and vertical directions). Based on evaluation of application parameters (e.g., image/frame resolution and/or bitrate) and content (e.g., complexity) by an “Application, Rate, Content & Complexity Analyzer,” a choice of a wavelet filter set (wfi) to use for analysis may be determined, quality and rate targets may be set, partitioning of bands may be regulated, and bitrate control may be performed Examples of such processes are described herein.

As shown, the YUV frame may undergo one level decomposition into LL, HL, LH, and HH subbands by an “Adaptive Wavelet Analysis Filtering” module, and the content of each tile of each band may be partitioned under control of a “Rate Distortion Optimization & Bit Rate Controller” module into variable size blocks that may be of square shape only or a combination of square and rectangular shapes by a “Wavelet Bands Adaptive Partitioner to Square/Rectangular Blocks” module. For example, the “Rate Distortion Optimization & Bit Rate Controller” may determine a best selection of partition size, prediction mode, and transform type. The result of such processing is many candidate partitions (partn) of each tile. Unlike the case of WAVST where a fixed set of wavelet filters, first filter of the set for low pass analysis filtering and the second filter of the set for high pass analysis filtering may be employed regardless of resolution, bitrates, or content characteristics, in the embodiment of FIG. 18A, a codebook of wavelet filter sets (or multiple filter sets) is available to choose from for analysis, and information about the selected filter set (wfi) is included in the bitstream (bitstr).

Furthermore, for each LL band tile partition, several candidate intra (e.g., DC, planar, and directional) prediction modes (mode) are generated using decoded neighboring blocks by a “Local Buffer and DC/Planar/Directional Prediction Analyzer & Generator”. As shown, for other (HL, LH, HH) band tile partitions, intra prediction is not performed.

Also as shown, the LL band tile partition samples may be differenced with candidate prediction partition samples by a Differencer 1811 to compute candidate difference partitions that are then transformed by an “Adaptive Square/Rectangular Variable Size Transform: DCT, PHT, DST” module resulting in candidate transform coefficient blocks. For other bands, no predictions are needed and the prediction partition/blocks samples are directly transformed resulting in transform coefficient blocks. All transform coefficient blocks may be quantized by a “Quantizer” and entropy encoded. All bit costs such as transform coefficients entropy coding bit costs, partitioning bit costs, prediction mode bit costs, and transform selection bit costs may be determined by an “Adaptive Scan Transform Coefficient Blocks of Wavelet Bands, Adaptive Entropy Encoder & Bitstream Formatter” module. Thus for a combination (e.g., partition size, prediction mode, transform choice, transform coefficients block) not only cost can be calculated but also reconstructed partition and thus the distortion. These costs and distortions are used in rate distortion optimization as follows.

Given a set of candidate partitions (partn) of each tile, candidate intra prediction modes (mode), candidate transforms (xm), and potential quantizer values (q), the “Rate Distortion Optimization & Bit Rate Controller” module may make decisions using the bitrate (from bit costs provided by entropy encoder) and using distortion (from difference of the original and the reconstructed subband portions) measures on the best encoding strategy by determining the best partitionings (partnb), the best intra prediction mode (modeb) for each partition, the best transform (xmb) to use for coding of each partition, and the quantizer (qp) that will allow achieving the best (RD tradeoff) quality results under constraint of available bitrate. These selections of partnb, modeb, xmb, and qp, along with selected wfi are sent via bitstream (bitstr) to the decoder.

The process of forming predictions from neighbors requires reconstruction of neighboring blocks which requires a decoding loop at the encoder. Furthermore, as has been discussed, a “reconstructed partition” may be generated for use by RDO, which is described herein and may require decoding at encoder 1801. For example, as shown, quantized coefficient blocks of each band at encoder 1801 may go through dequantization at an “Inverse Quantizer,” followed by an inverse transform with the appropriate transform at an “Adaptive Square/Rectangular Variable Size Inverse Transform: DCT, PHT, DST” module resulting in blocks of reconstructed samples of the HL, LH, and HH bands, and interim blocks of reconstructed samples of the LL band. For the LL band a prediction mode may be used to acquire a corresponding prediction block to add to the LL band interim reconstructed block at adder 1812 to generate a final reconstructed block. Reconstructed LL band blocks are also saved in local buffer and used for current block prediction by the “Local Buffer and DC/Planar/Directional Prediction Analyzer & Generator,” with the predicted block forming one input to the differencer, at the other input of which is the current partition/block being coded. Furthermore, since full reconstruction of all bands is needed for the purpose of computing distortion, the reconstructed LL band and the other (e.g., HL, LH, and HH) band blocks are assembled to form tiles and then undergo optional deblocking and deringing at a “Deblock & DeRinging Filter” module resulting in reduced artifacts in the reconstructed LL, HL, LH, and HH bands that are input to RDO for use in computing distortion.

FIG. 18B illustrates a functional block diagram of an example functional standalone AWAVST Intra Decoder 1802, arranged in accordance with at least some implementations of the present disclosure. For example, much of the discussion of FIG. 18A associated with the decoding loop in WAVST Intra Encoder may be applicable to the discussion of decoder 1802 (with the exception of the “Adaptive Wavelet Synthesis Filtering” and the “Color Space Inverter”). As shown, an encoded AWAVST bitstream (bitstr) may be decoded by a “Bitstream Unformatter, Adaptive Entropy Decoder & Adaptive Inverse Scan Transform Coefficient Blocks of Wavelet Bands” module resulting in selected partition info (partnb), selected intra pred mode info (modeb), best transform info (xmb), selected quantizer (qp), selected wavelet filter set index (wfi), and quantized transform coefficient blocks. The transform coefficient blocks may be dequantized using quantizer (qp) by an “Inverse Quantizer” and inverse transformed using the transform indicated by xmb, by an “Adaptive Square/Rectangular Variable Size Inverse Transform: DCT, PHT, DST” module resulting in blocks of reconstructed samples of the HL, LH and HH bands and blocks of interim samples for the LL band. As discussed, by adding prediction blocks (generated using prediction modeb info by a “Local Buffer and DC/Planar/Directional Prediction Generator”) to decoded interim blocks via adder 1821, final blocks of LL band may be generated. All partitions/blocks of each wavelet band may be assembled into tiles and thus to full bands by a “Wavelet Bands Adaptive Assembler to Square/Rectangular Blocks”. The assembled tiles may undergo optional deblocking and deringing in a “Deblock & DeRinging Filter” module to reduce coding artifacts and then may be input to an “Adaptive Wavelet Synthesis Filtering” that uses decoded filter set index (wfi) to obtain from a codebook the needed filters for synthesis filtering to combine all 4 bands to generate a decoded YUV frame (dec. frame). Depending on the application either this frame itself may be sufficient or it may need to be converted to RGB format image (dec. image) by optional processing by a “Color Space Inverter”.

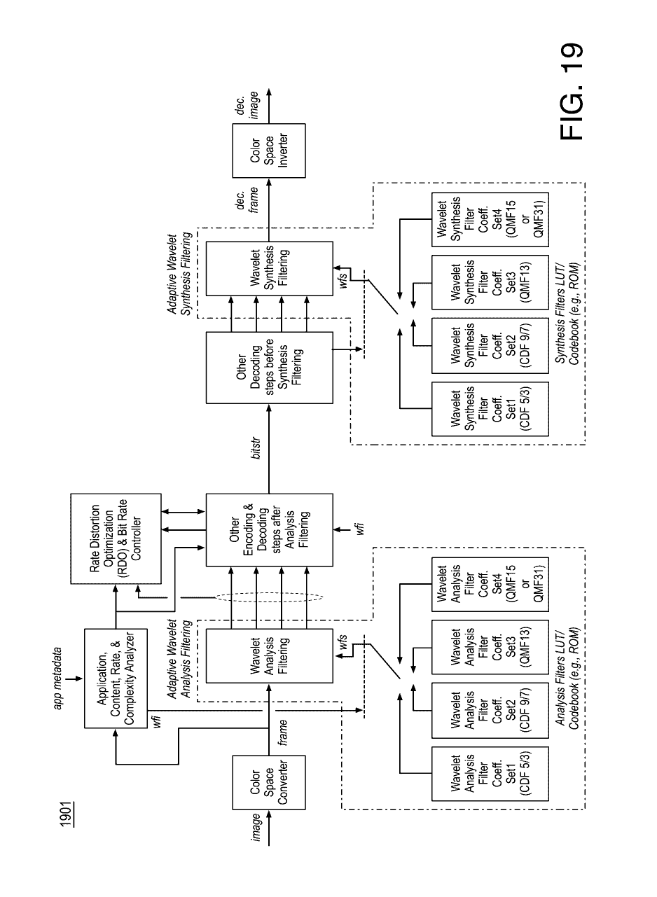

FIG. 19 illustrates an example system 1901 including details of the “Adaptive Wavelet Analysis Filter” in the AWAVST Encoder of FIG. 18A and the “Wavelet Synthesis Filter” in the AWAVST Decoder of FIG. 18B, arranged in accordance with at least some implementations of the present disclosure. Furthermore, FIG. 19 illustrates interfaces to rest of the encoder and decoder. For instance the figure shows some actual blocks (“Color Space Converter”, “Application, Content, Rate & Complexity Analyzer”, “Rate Distortion Optimization (RDO) & Bit rate Controller”, and “Color Space Inverter”) and some bundled blocks (“Other Encoding & Decoding steps after Analysis Filtering” and “Other Decoding steps before Synthesis Filtering”) that either interface with the “Adaptive Wavelet Analysis Filter” or the “Adaptive Wavelet Synthesis Filter”. The “Adaptive Wavelet Analysis Filter” is shown including two blocks or modules (e.g., an “Adaptive Wavelet Analysis Filter Coefficient Sets” (including Set 1(CDF 5/3), Set 2 (CDF 9/7), Set 3 (QMF13), and Set 4 (QMF15 or QMF31) module and “a Wavelet Analysis Filtering” module. The “Adaptive Wavelet Analysis Filter Coefficient Sets” may be a codebook of multiple filter sets, such that the first filter of the set is used for low pass analysis filtering (lpaf) and the second filter of the set is used for high pass analysis filtering (hpaf) as discussed herein. Based on application (e.g., high quality/fast processing), resolution (e.g., 1080p or less), and content (e.g., high contrast/blurry) a filter set may be chosen and signaled via wavelet filter set index (wfi) in the bitstream. The “Wavelet Analysis Filtering” module may use the selected filter set from the codebook (indexed by wfi) to perform subband decomposition at the encoder.

Furthermore, FIG. 19 illustrates the “Adaptive Wavelet Synthesis Filter” including a “Wavelet Synthesis Filtering” module and an “Adaptive Wavelet Synthesis Filter Coefficient Sets” (including Set 1(CDF 5/3), Set 2 (CDF 9/7), Set 3 (QMF13), and Set 4 (QMF15 or QMF31) module. The “Adaptive Wavelet Synthesis Filter Coefficient Sets” may be a codebook of multiple filter sets, where the first filter of the set is used for low pass synthesis filtering (lpsf) and the second filter of the set is used for high pass synthesis filtering (hpsf) as discussed herein. The lpsf and hpsf are corresponding matching filters to lpaf and hpaf filters. The “Wavelet Synthesis Filtering” may use the decoded wavelet filter set index in the codebook to determine the filter set to use to perform subband recomposition at the decoder.

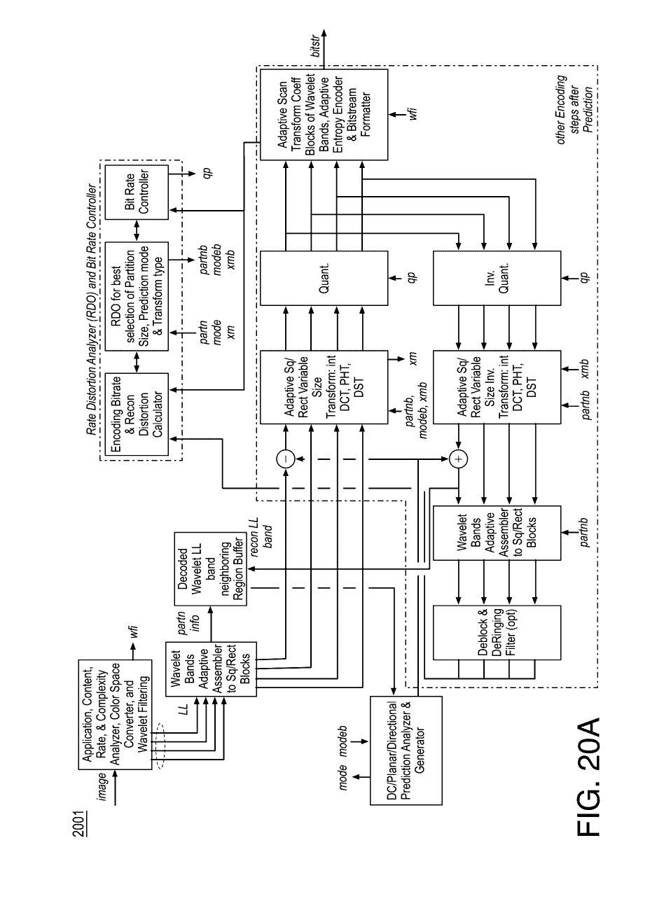

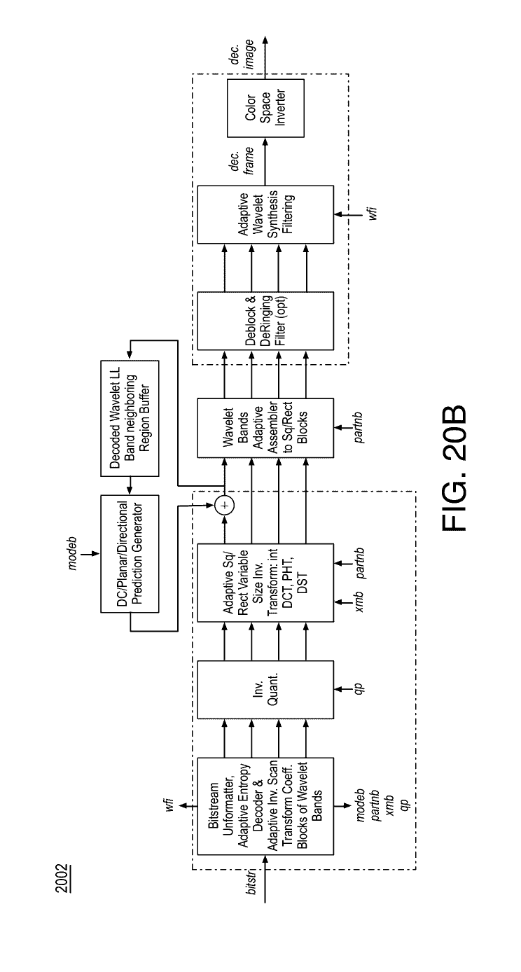

FIG. 20A illustrates an example system 2001 including details of the “Local Buffer and Prediction Analyzer and Generator” and interfaces to the rest of the AWAVST Intra Encoder of FIG. 18A, arranged in accordance with at least some implementations of the present disclosure. For the sake of clarity of presentation, FIG. 20A shows a bundled block (“Application, Content, Rate & Complexity Analyzer, Color Space Converter, and Wavelet Analysis Filtering” module) that is a combination of three blocks, an unbundled block “Rate Distortion Analyzer (RDO) and Bit Rate Controller” module including 3 blocks or modules, and other blocks (“Wavelet Bands Adaptive Partitioner to Square/Rectangular Blocks”, “Differencer”, “Adaptive Square/Rectangular Variable Size Transform: DCT, PHT, DST” module, “Quantizer”, “Adaptive Scan Transform Coefficient Blocks of Wavelet Bands, Adaptive Entropy Encoder & Bitstream Formatter” module, “Inverse Quantizer”, “Adaptive Square/Rectangular Variable Size Inverse Transform: DCT, PHT, DST” module, “Adder”, “Wavelet Bands Adaptive Assembler of Square/Rectangular Blocks”, and “Deblock & DeRinging Filter” module) as they are and show interfaces to a “Local Buffer and Prediction Analyzer and Generator.” Furthermore, the “Local Buffer and Prediction Analyzer and Generator” module is illustrated divided into two units: a “Decoded Wavelet LL band neighboring Region Buffer” and a “DC/Planar/Directional Prediction Analyzer & Generator” module. The decoded previous blocks that are used for forming intra prediction may be stored in the “Decoded Wavelet LL band neighboring Region Buffer”. The intra prediction may be performed on a partition/block basis using the neighboring block region by generating many candidate predictions (modes) using DC prediction, planar prediction, and many angles based directional prediction that are analyzed by RDO to determine the best prediction mode (modeb). Besides the modeb signal, the encoded bitstream generated by the “Adaptive Scan Transform Coefficient Blocks of Wavelet Bands, Adaptive Entropy Encoder & Bitstream Formatter” carries other signals including the wavelet filter set selection index, wfi.

FIG. 20B illustrates an example system 2002 including details of the “Local Buffer and Prediction Generator” and interfaces to the rest of the WAVST Intra Decoder of FIG. 18B, arranged in accordance with at least some implementations of the present disclosure. Besides the blocks within the “Local Buffer and Prediction Generator” component, all other blocks or modules (“Bitstream Unformatter, Adaptive Entropy Decoder & Adaptive Inverse Scan Transform Coeffcient Blocks of Wavelet Bands” module, “Inverse Quantizer”, “Adaptive Square/Rectangular Variable Size Inverse Transform” module, “Adder”, “Wavelet Bands Adaptive Assembler of Square/Rectangular Blocks” module, “Deblock & DeRinging Filter” module, “Wavelet Synthesis Filtering” module, and “Color Space Inverter”) are shown here from FIG. 18B and serve to show interfaces to this block or module. Also, the “Local Buffer and Prediction Generator” is divided into two units (e.g., a “Decoded Wavelet LL Band neighboring Region Buffer” and a “DC/Planar/Directional Prediction Generator”. The “Decoded Wavelet LL Band neighboring Region Buffer” serves to save neighboring blocks needed for making prediction by the “DC/Planar/Directional Prediction Generator”, which uses modeb to determine the best prediction mode and creates prediction for that mode only. The decoded wavelet filter set index (wfi) may be used by the “Adaptive Wavelet Synthesis Filtering” module to select a matching filter set for synthesis.

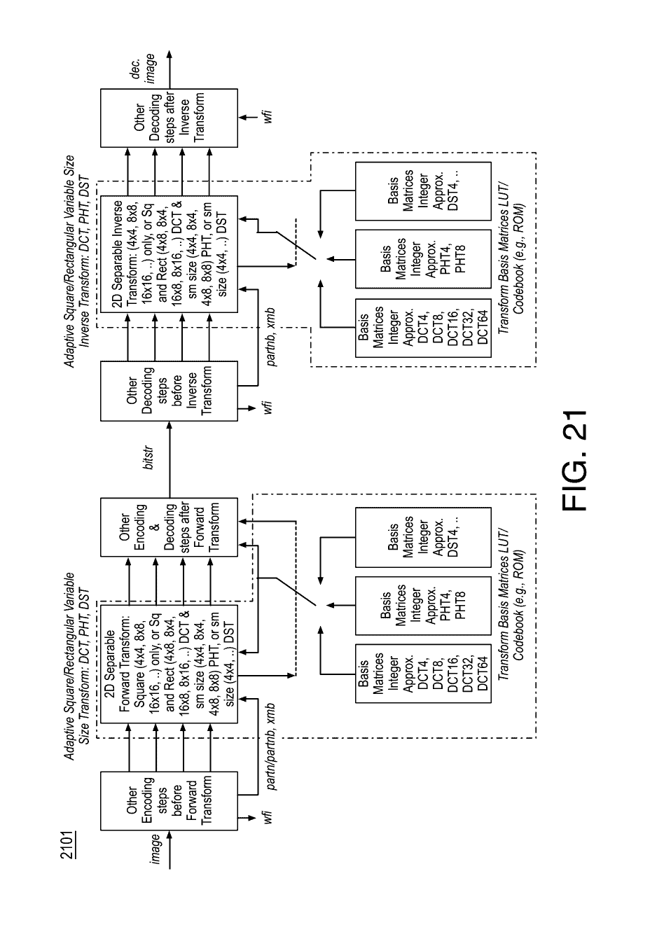

FIG. 21 illustrates an example system 2101 including details of the “Adaptive Square/Rectangular Variable Size Transform: DCT, PHT, DST” module of the AWAVST Intra encoder of FIG. 18A and the “Adaptive Square/Rectangular Size Inverse Transform: DCT, PHT, DST” module of the AWAVST decoder of FIG. 18B, arranged in accordance with at least some implementations of the present disclosure. In the illustrated example, on the encoding side, FIG. 21 shows some bundled blocks (“Other Encoding steps before Forward Transform” and “Other Encoding & Decoding steps after Forward Transform”) that interface with the “Adaptive Square/Rectangular Variable Size Transform: DCT, PHT, DST” module, which itself consists of two components or modules: a “2D Separable Forward Transform: Square (4×4,8×8,16×16, . . . ) only, or Square and Rectangular (4×8, 8×4, 16×8, 8×16, . . . ) DCT & small size (4×4, 8×4, 4×8, 8×8) PHT or small size (4×4, . . . ) DST” module and a “Transform Basis Matrices LUT/Codebook” module. The supported choices for forward transform for the case of square blocks sizes are 4×4, 8×8, 16×16, 32×32, and 64×64 integer DCT approximation, for square and rectangular blocks the square sizes just listed and rectangular blocks may be 4×8, 8×4, 16×8, 8×16, 32×8, 8×32, 32×16, 16×32, 16×64, 64×16, 64×32, 32×64, . . . integer DCT approximation, for smaller block sizes (such as 4×4, 4×8, 8×4, and 8×8) integer PHT, and for very small block sizes (e.g. 4×4) integer DST approximation. For example, the transforms may include an adaptive parametric transform or an adaptive hybrid such that the adaptive parametric transform or the adaptive hybrid parametric transform include a base matrix derived from decoded pixels neighboring transform partition, as discussed herein.

Furthermore, the encoder may send a number of control signals via the bitstream it generates (e.g., bitstr). The bitstream formatting process is not shown explicitly but is incorporated in the bundled block “Other Encoding & Decoding steps after Forward Transform”. Such control signals may carry information such as best partitioning for a tile (partnb), the best mode decision per partition (modeb), the best transform per partition (xmb), as well as an index to the chosen wavelet filter set (wfi). Such control signals at the decoder may be decoded by a bundled block “Other Decoding steps before Inverse Transform” that may perform bitstream unformatting among other operations and such control signals may control the decoding process at the decoder.

Furthermore, on the decoding side, FIG. 21 illustrates bundled blocks (“Other Decoding steps before Inverse Transform” and “Other Decoding steps after Inverse Transform”) that interface with the “Adaptive Square/Rectangular Variable Size Inverse Transform: DCT, PHT, DST” component which itself consists of two components “2D Separable Inverse Transform: Square (4×4,8×8, 16×16, . . . ) only, or square, and Rectangular (4×8, 8×4, 16×8, 8×16, . . . ) DCT & small size (4×4, 8×4, 4×8, 8×8) PHT, or small size (4×4, . . . ) DST” module and a “Transform Basis Matrices LUT/Codebook” module (e.g., as on the encoder side). For example, the supported choices for inverse transform may be the same as those discussed with respect to the forward transform.

Discussion now turns to a hybrid technique that may result from a combination of the two Intra video/image coding techniques (AVST and WAVST/AWAVST) discussed herein. For example, there may be two embodiments of a hybrid technique: a first that combines AVST with WAVST as illustrated with respect to FIG. 22A and a second that combines AVST with AWAVST and is illustrated with respect to FIG. 22B.

For example, in a video encoding system employing interframe block motion compensated transform coding, the system may need to naturally support efficient (and possibly scalable 2 layer) intra coded pictures. In some examples, intra coding may be performed on a frame or picture level. In some examples, either in addition or in the alternative, intra coding may be a block based available mode even in motion compensated transform coding such that issues including uncovered background where motion compensation does not work well may be dealt with. However, sometimes full pictures need to be coded as Intra pictures and the encoding algorithm in such cases may not need to be the same as the encoding technique used for intra blocks in inter (e.g., Predictive (P) or Bidirectionally Predictive (B) pictures). Introducing full intra pictures (as compared to a few intra blocks within an inter frame) in video may break interframe coding dependency, which is necessary for being able to random access in compressed stored bitstream such as for Digital Video Disc (DVD) or Blu-ray Disc (BD), or for channel surfing of broadcast video.

FIG. 22A illustrates a block diagram of an example transform and wavelet-transform combined coder 2201 referred to as an Adaptive Transform Wavelet Adaptive Transform (ATWAT) coder, arranged in accordance with at least some implementations of the present disclosure. For example, the coder of FIG. 21A may combine Adaptive Variable Size Transform (AVST) Intra coding with Wavelet Adaptive Variable Size Transform (WAVST) Intra coding. As shown, at the encoding side, assuming one or more Intra Tiles or blocks of a video frame are to be coded as intra, a switch 2211 may be placed in a position (e.g., in a slightly downward position in FIG. 21A) that allows a tile or block of a tile to be intra coded. For example, the tile or block (e.g., a portion of frame) may be input to an “AVST Intra Encoder” (e.g., at the bottom of the encoder side) that may perform intra encoding of some portions of a video frame, the remaining portions of which may be inter coded (not shown in FIG. 21A). The bitstream of encoded Intra tiles or blocks may be multiplexed with other bitstream portions (e.g., related to inter coded blocks) at a “Muxer to Single Layer/Layered Bitstream” module for storage or transmission over the channel or the like.

On the other hand, if a full frame is to be coded as Intra, switch 2211 is placed in a position (e.g., in a slightly upward position in FIG. 21A, as shown via a dotted line) that allows an input video frame or image to undergo wavelet decomposition at a “Wavelet Analysis Filtering” module resulting in its one level decomposition into LL, HL, LH, and HH subbands, each of which is one-quarter in size and with bit depth of 9 bits (assuming 8 bit input video or image). As shown, the LL subband may be encoded by an “AVST Intra Encoder” with features such as those discussed with respect to FIG. 7A. Furthermore, the HL, LH, and HH subbands may be encoded by “AVST* Intra Encoders” with features such as those discussed with respect to FIG. 7B. The result of the encoding process may include four individual bitstreams such as an LL bitstream, an HL bitstream, an LH bitstream, and an HH bitstream that may then be multiplexed to a single bitstream (bitstr) by the “Muxer to Single Layer/Layered Bitstream” for storage or transmission over the channel.

Also shown in FIG. 22A, at the decoding side, the multiplexed bitstream (bitstr) may be demultiplexed by a “DeMuxer to Bitstream Layers” into either the single layered bitstream that may be further separated into intra or inter portions with intra portions being sent to an “AVST Intra Decoder” (e.g., shown at the bottom of the decode side in FIG. 22A) for decoding of such tiles or blocks that are combined with other inter decoded tiles or blocks (not shown) composing a full frame that may be sent for display (as discussed below). Alternatively, on the decoding side of FIG. 22A, the multiplexed bitstream may result in individual LL, HL, LH, and HH bitstreams that may be sent to an “AVST Intra Decoder” (e.g., for the LL bitstream) or “AVST* Intra Decoders” (e.g., for the HL, LH, and HH bitstreams) with the resulting four, quarter size decoded subbands being composed by a “Wavelet Synthesis Filtering” module resulting in a full resolution/size final reconstructed video frame or image (dec. frame) that may then be sent to display (as discussed below).

For example, depending on a user or system requirements as, decoder processing available, or other characteristics, one of the three outputs may be shown at a display implemented by a switch 2212 such as a low resolution Intra video frame (formed from the upsampled decoded LL subband as provided by the LL band “AVST Intra Decoder” and upsampled by a “1:2 Up Sampler” module), a full resolution decoded Intra video frame (formed from synthesis of all four decoded subbands as discussed), or a full resolution Intra/Inter decoded video frame in which some tiles or blocks were coded intra by AVST Intra coding while other tiles or blocks were coded inter by other means (formed, in part, by the AVST Intra Decoder at the bottom of the decode side in FIG. 22A).

In another variation of the discussed system of FIG. 22A, instead of coding only some tiles or blocks as intra by AVST intra encoding and coding remaining portions of video frame as inter by other means, the remaining portions of the video frame may be coded by wavelet based WAVST encoding. An example use case, for example, may involve segmentation of a video frame into foreground/background where the background may be coded by WAVST and the foreground may be coded with AVST encoding, or vice versa. In another variation of the system of FIG. 22A, some entire intra frames may be coded by AVST encoding, while other intra frames may be coded by WAVST coding. The headers in the multiplexed bitstream may carry information regarding the encoding variation used and the header information may be decoded on the decoding side and may control further multiplexing and decoding operations for correct decoding of the encoded bitstream.

For example, multiple frames may be received such that at least a portion of a frame of the plurality of frames is to be intra coded. A determination may be made that a first frame of the multiple frames is to be intra coded in the using wavelet based coding, a second frame is to be intra coded using spatial domain based coding, and a third frame is to be coded based on a hybrid of wavelet analysis filter based coding (e.g., at last a block or tile or the like is to be intra coded in the wavelet domain) and spatial domain based coding (e.g., at least a block or tile or the like is to be intra or inter coded in the spatial domain). The second frame may be intra coding using an AVST intra encoder such as encoder as discussed with respect to FIG. 5A. For example, the second frame may be partitioned into multiple partitions for prediction, the partitions for prediction may be differenced with corresponding predicted partitions to generate prediction difference partitions, and the prediction difference partitions may be partitioned into multiple transform partitions. Wavelet decomposition may be performed on the first frame to generate multiple subbands of the first frame, a first (e.g., LL) subband of the multiple subbands may be partitioned into multiple second partitions for prediction, the second partitions for prediction may be differenced with corresponding second predicted partitions to generate second prediction difference partitions, and the second prediction difference partitions may be partitioned into multiple second transform partitions. Furthermore, the a second subband (e.g., an HL, LH, or HH subband) of multiple subbands may be partitioned into a plurality of third transform partitions. In an embodiment, the partitions for prediction may include a square partition and a rectangular partition. Also, an adaptive parametric transform or an adaptive hybrid parametric transform may be performed on at least a first transform partition of the multiple transform partitions and a discrete cosine transform may be performed on at least a second transform partition of the plurality of transform partitions such that the adaptive parametric transform or the adaptive hybrid parametric transform includes a base matrix derived from decoded pixels neighboring the first transform partition. For example, the first transform partition may be smaller than the second transform partition. In an embodiment, the multiple transform partitions may include at least a square partition and a rectangular partition.

For the third frame, a first tile or block of the third frame may be partitioned into multiple third partitions for prediction, the third partitions for prediction may be differenced with associated third predicted partitions to generate third prediction difference partitions, and the third prediction difference partitions may be partitioned into a plurality of third transform partitions. Furthermore, wavelet decomposition may be performed on a second tile or block of the third frame to generate a second plurality of subbands, a first subband of the second plurality of subbands may be partitioned into multiple third partitions for prediction, the third partitions for prediction may be differenced with associated third predicted partitions to generate third prediction difference partitions, and the third prediction difference partitions may be partitioned into multiple third transform partitions. Furthermore, a second subband of the second multiple subbands may be partitioned into a plurality of fourth transform partitions. For example, the third frame may be coded using hybrid coding. In an embodiment, such as the context of FIG. 22A, the discussed wavelet decomposition may be fixed wavelet decomposition. In other embodiments, such as in the context discussed with respect to FIG. 22B, the wavelet decomposition may be adaptive wavelet decomposition. Such adaptive wavelet decomposition may be performed at the frame level or the tile level or the like. For example, the wavelet decomposition on the first tile or block of the third frame may be adaptive wavelet analysis filtering. In an embodiment, the wavelet decomposition may include adaptive wavelet analysis filtering based on at least one of content characteristics of the first frame, a target bitrate, or an application parameter comprising a target bitrate. For example, the adaptive wavelet analysis filtering may include selection of a selected wavelet filter set from a plurality of available wavelet filter sets.

FIG. 22B illustrates a block diagram of an example transform and wavelet-transform combined coder 2202 referred to as Adaptive Transform Adaptive Wavelet Adaptive Transform (ATAWAT) coder, arranged in accordance with at least some implementations of the present disclosure. For example, the system of FIG. 22B may operate similarly (as well as supports the same variations) with respect to the system of FIG. 22A (and such operations will not be repeated for the sake of brevity) except that on the encoding side, instead of fixed Wavelet Analysis Filtering, Adaptive Analysis Filtering is used as implemented by an “Adaptive Wavelet Analysis Filtering” module and correspondingly on the decoding side, instead of fixed Wavelet Synthesis Filtering, Adaptive Synthesis Filtering is used as implemented by an “Adaptive Wavelet Synthesis Filtering” module. For example, the content of each video sequence (e.g., frame, tile, block, or the like) may be examined for the best choice of filter set to use for analysis decomposition at the decoder side and a matching filter set for synthesis re-composition at the decoder side. For example, the wfi signal carries information about a selected wavelet filter set used for analysis and is encoded and carried by headers in the multiplexed bitstream (bitstr). The wavelet filter set selection information (wfi) is then decoded from the headers and employed by the “Adaptive Wavelet Synthesis Filtering” module to determine the matching filter set to use for decoding.

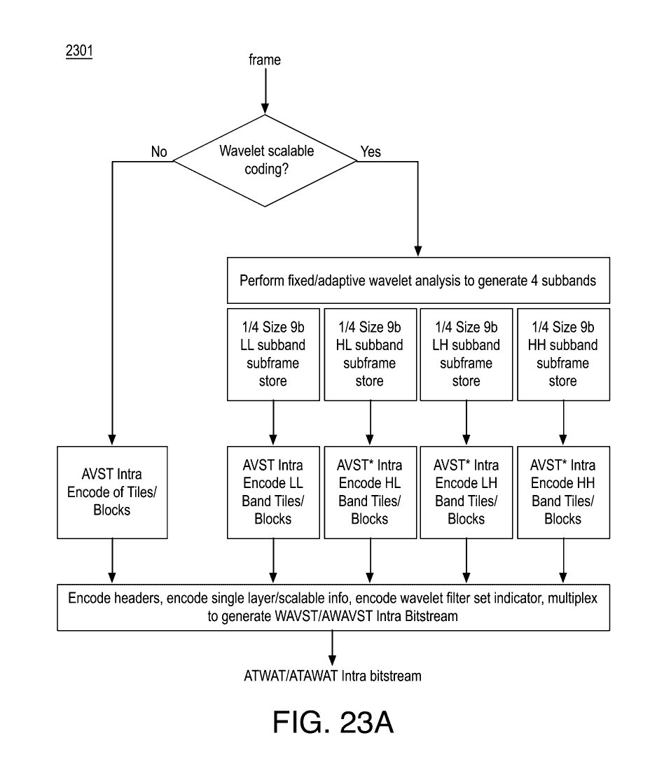

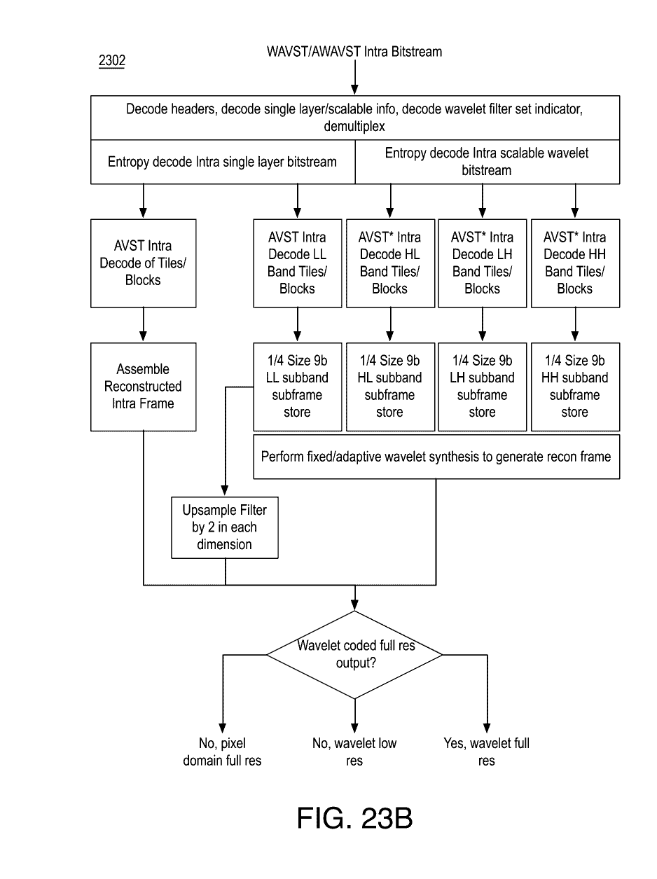

FIG. 23A illustrates a flowchart of an example process 2301 for ATWAT/ATAWAT Intra Encoding using an Adaptive Transform Wavelet Adaptive Transform (ATWAT) coder or Adaptive Transform Adaptive Wavelet Adaptive Transform (ATAWAT) coder, arranged in accordance with at least some implementations of the present disclosure. For example, process 2301 may provide an encoding flowchart for the system of FIG. 22A or the system of FIG. 22B. As shown, for a video frame being input (“frame”), a decision may be made (at the decision operation labeled “Wavelet scalable coding”) as to whether the frame or image (or some tiles or blocks thereof) should be coded with wavelet based coding such as WAVST or AWAVST or if it should be coded with transform based coding such as AVST. If the frame, image, or block is to be coded by transform coding, it may proceed to a processing operation (labeled “AVST Intra Encode of Tiles/Blocks”) for AVST Intra encode of Tiles/Blocks and the resulting bitstream may be multiplexed with headers resulting in non-scalable bitstream for storage or transmission (at the operation labeled “Encode headers, encode single layer/scalable info, encode wavelet filter set indicator, multiplex to generate WAVST/AWAVST Intra Bitstream”). If the frame or image is to be processed by wavelet coding it may proceed to a wavelet analysis processing operation (labeled “Perform fixed/adaptive wavelet analysis to generate 4 subbands”, which in example of system of FIG. 22A uses fixed wavelet analysis and in the example of system of FIG. 22B performs adaptive wavelet analysis) and the resulting four subbands (LL, HL, LH, and HH) of one-quarter size may each be stored in corresponding sub-frame stores (at operations labeled “¼ Size 9b LL/HL/LH/HH subband subframe store”). The LL band may be encoded by an AVST encoder (at the operation labeled “AVST Intra Encode LL Band Tiles/Blocks”), while HL, LH and HH subbands may be encoded by AVST* encoders (at operations labeled “AVST* Intra Encode HL/LH/HH Band Tiles/Blocks”). The resulting bitstreams are multiplexed with headers (at the operation labeled “Encode headers, encode single layer/scalable info, encode wavelet filter set indicator, multiplex to generate WAVST/AWAVST Intra Bitstream”, in case of system of FIG. 22B headers also carry wavelet filter set selection information) and the final scalable bitstream (“ATWAT/ATAWAT Intra bitstream”) is ready for storage or transmission.

FIG. 23B illustrates a flowchart of an example process 2302 for ATWAT/ATAWAT Intra Decoding that inverts the process performed by ATWAT/ATAWAT Intra encoding, arranged in accordance with at least some implementations of the present disclosure. As shown, a bitstream (“WAVST/AWAVST Intra Bitstream”) may be received and headers may be decoded to determine if the bitstream is a single layer AVST bitstream or a wavelet coded (WAVST or AWAVST) bitstream (at the operation labeled “Decode headers, decode single layer/scalable info, decode wavelet filter set indicator, demultiplex”). If it is determined to be an AVST bitstream, the bitstream may be sent for decoding at an AVST intra decoder that decodes the bitstream (at the operations labeled “Entropy decode Intra single layer bitstream” and “AVST Intra Decode of Tiles/Blocks”) and generates a reconstructed Intra frame (at the operation labeled “Assemble Reconstructed Intra Frame”) that is a candidate for display depending on the user input or system parameters.

If it is determined from headers that the decoded bitstream is of a wavelet type, the four embedded bitstreams may be determined from it (at operations labeled “Entropy decode Intra single layer bitstream” and “Entropy decode Intra scalable wavelet bitstream”) and the LL band bitstream is input to an LL band AVST decoder (at operations labeled “Entropy decode Intra single layer bitstream”), the reconstructed quarter resolution output of which is stored in LL band subframe store (at the operation labeled “¼ Size 9b LL subband subframe store”) and can be optionally upsampled (at the operation labeled “Upsample Filter by 2 in each dimension”) and forms a second candidate for display depending on the user input or system parameters or the like. Assuming per user input or system parameters or the like a full resolution wavelet decoded intra video frame needs to be displayed then the other three (e.g., HL, LH, and HH) band bitstreams are input to corresponding decoders such as HL band AVST* decoder, LH band AVST* decoder, and HH band AVST* decoder (at operations labeled “AVST Intra Decode HL/LH/HH Band Tiles/Blocks”), and the respective decoded sub-frames may be output to HL subband sub-frame store, LH subband sub-frame store, and HH subband sub-frame store, respectively (at operations labeled “¼ Size 9b HL/LH/HH subband subframe store”). The decoded LL, HL, LH, and HH subbands from the four sub-frame may undergo frame synthesis using fixed synthesis filters or adaptive synthesis filtering (at the operation labeled “Perform fixed/adaptive wavelet synthesis to generate recon frame”) to reverse fixed analysis or adaptive analysis filtering performed at the encoder that is signaled via the bitstream as that combines the decoded subbands resulting in full reconstructed video/image frame that can be output as a third candidate to display.

As shown, one of the three candidate reconstructed frames or images may be provided for display. A determination may be made as to which candidate to provide (at the decision operation labeled “Wavelet coded full res output?”) and the corresponding frame may be provided for display (“No, pixel domain full res”, “No, wavelet low res”, or “Yes, wavelet full res”). The decoding flowchart of FIG. 23B may assume that either the entire frame was coded as is by AVST without wavelet coding or coded by AVST wavelet coding, and as such can decode either of the two types of encoded bitstreams.

As discussed herein, AVST Intra coding may use both square and rectangular partitioning and possibly both square and rectangular transforms of large number of block sizes. Furthermore, AVST may use a parametric transform such as the PHT transform of multiple block sizes such as 4×4, 8×4, 4×8, 8×8 etc. Furthermore, AVST Intra coding may use spatial prediction (that uses DC, planar, and many directional prediction) and a variation that may be used without prediction is provided. That variation of AVST is referred to as AVST* Intra coding. Use of wavelet analysis may generate 4 or more subbands by wavelet decomposition followed by use of block based coding of block based AVST and AVST* coding of higher bit depth (9 bits instead of 8 bits) dependent on the subband to be coded (e.g., whether it is a LL subband, or HL subband or an LH subband, or an HH subband). One way AVST coding is adapted (by using AVST* instead of AVST) to the needs of a particular subband has to do with shapes of transforms, another way it is adapted is direction of scanning of transform blocks. Another way AVST coding is adapted to HL, LH, and HH bands is by use of AVST* coder that turns off spatial prediction for non-LL bands. Wavelet analysis filtering may be fixed or adaptive. Content characteristics, bitrates, and application parameters (frame resolution and others) may be used to select from available wavelet filter sets in some examples. When wavelet analysis filtering is adaptive, the bitstream may carry information regarding wavelet filter sets used so that matching complimentary filters can be used at the decoder for wavelet synthesis (by decoding the bitstream and determining which filter were used for analysis). Thus wavelet synthesis filtering is also adaptive in response to chosen wavelet analysis filters. A hybrid approach that combines both the transform coding per AVST and wavelet based AVST coding (WAVST/AWAVST) to generate ATWAT/ATAWAT coding is also discussed. Several variations are provided including both AVST Intra or WAVST/AWAVST Intra applied on a frame, AVST Intra applied on a local (Tile or block) basis with AVST inter (not discussed here) applied for remaining tiles and blocks, and WAVST/WAVST Intra applied for other Intra frames. For example, AVST Intra may be applied on a local (tile or block) basis with WAVST/AWAVST applied on remaining tiles.

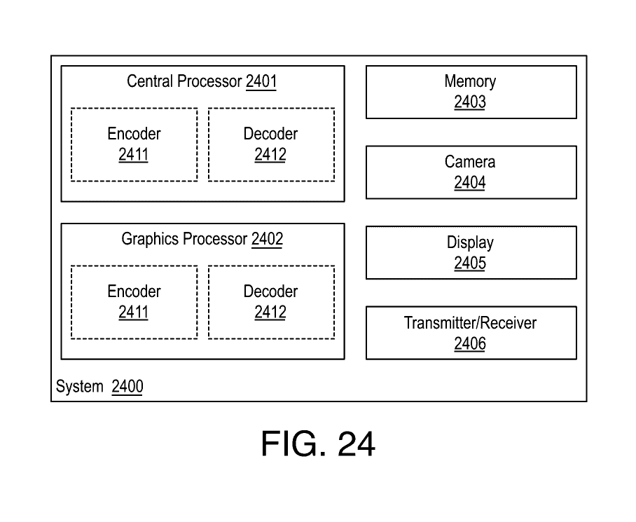

FIG. 24 is an illustrative diagram of an example system 2400 for encoding and/or decoding, arranged in accordance with at least some implementations of the present disclosure. As shown in FIG. 24, system 2400 may include a central processor 2401, a graphics processor 2402, a memory 2403, a camera 2404, a display 2405, and a transmitter/receiver 2406. In some embodiments system 2400 may not include camera 2404, display 2405, and/or transmitter/receiver 2406. As shown central processor 2401 and/or graphics processor 2402 may implement an encoder 2411 and/or decoder 2412. Encoder 2411 and decoder 2412 may include any encoder or decoder as discussed herein or combinations thereof. In some embodiments, system 2400 may not implement encoder 2411 or decoder 2402. In the example of system 2400, memory 2403 may store frame data, image data, or bitstream data or any related data such as any other data discussed herein.

As shown, in some embodiments, encoder and/or decoder 2412 may be implemented via central processor 2401. In other embodiments, one or more or portions of encoder and/or decoder 2412 may be implemented via graphics processor 2402. In yet other embodiments, encoder and/or decoder 2412 may be implemented by an image processing unit, an image processing pipeline, a video processing pipeline, or the like. In some embodiments, encoder and/or decoder 2412 may be implemented in hardware as a system-on-a-chip (SoC).

Graphics processor 2402 may include any number and type of graphics processing units that may provide the operations as discussed herein. Such operations may be implemented via software or hardware or a combination thereof. For example, graphics processor 2402 may include circuitry dedicated to manipulate and/or analyze images or frames obtained from memory 2403. Central processor 2401 may include any number and type of processing units or modules that may provide control and other high level functions for system 2400 and/or provide any operations as discussed herein. Memory 2403 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 2403 may be implemented by cache memory. In an embodiment, one or more or portions of encoder and/or decoder 2412 may be implemented via an execution unit (EU) of graphics processor 2402 or another processor. The EU may include, for example, programmable logic or circuitry such as a logic core or cores that may provide a wide array of programmable logic functions. In an embodiment, one or more or portions of encoder and/or decoder 2412 may be implemented via dedicated hardware such as fixed function circuitry or the like. Fixed function circuitry may include dedicated logic or circuitry and may provide a set of fixed function entry points that may map to the dedicated logic for a fixed purpose or function. Camera 2404 may be any suitable camera or device that may obtain image or frame data for processing such as encode processing as discussed herein. Display 2405 may be any display or device that may present image or frame data such as decoded images or frames as discussed herein. Transmitter/receiver 2406 may include any suitable transmitter and/or receiver that may transmit or receive bitstream data as discussed herein.

System 2400 may implement any devices, systems, encoders, decoders, modules, units, or the like as discussed herein. Furthermore, system 2400 may implement any processes, operations, or the like as discussed herein.

Various components of the systems described herein may be implemented in software, firmware, and/or hardware and/or any combination thereof. For example, various components of the devices or systems discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the devices or systems, or any other module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

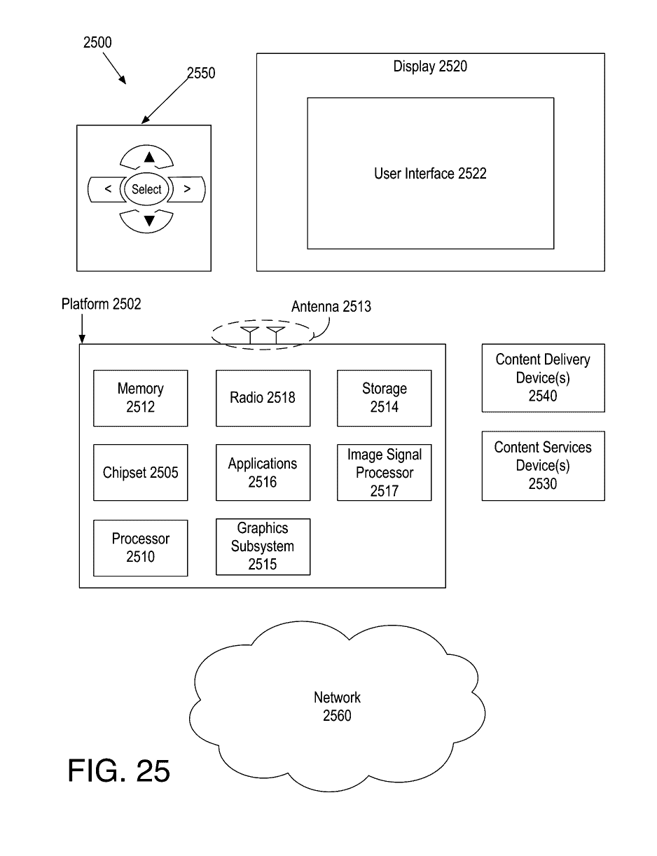

FIG. 25 is an illustrative diagram of an example system 2500, arranged in accordance with at least some implementations of the present disclosure. In various implementations, system 2500 may be a mobile device system although system 2500 is not limited to this context. For example, system 2500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile interne device (MID), messaging device, data communication device, cameras (e.g. point-and-shoot cameras, super-zoom cameras, digital single-lens reflex (DSLR) cameras), and so forth.

In various implementations, system 2500 includes a platform 2502 coupled to a display 2520. Platform 2502 may receive content from a content device such as content services device(s) 2530 or content delivery device(s) 2540 or other content sources such as image sensors 2519. For example, platform 2502 may receive image data as discussed herein from image sensors 2519 or any other content source. A navigation controller 2550 including one or more navigation features may be used to interact with, for example, platform 2502 and/or display 2520. Each of these components is described in greater detail below.

In various implementations, platform 2502 may include any combination of a chipset 2505, processor 2510, memory 2511, antenna 2513, storage 2514, graphics subsystem 2515, applications 2516, image signal processor 2517 and/or radio 2518. Chipset 2505 may provide intercommunication among processor 2510, memory 2511, storage 2514, graphics subsystem 2515, applications 2516, image signal processor 2517 and/or radio 2518. For example, chipset 2505 may include a storage adapter (not depicted) capable of providing intercommunication with storage 2514.

Processor 2510 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 2510 may be dual-core processor(s), dual-core mobile processor(s), and so forth.

Memory 2511 may be implemented as a volatile memory device such as, but not limited to, a Random Access Memory (RAM), Dynamic Random Access Memory (DRAM), or Static RAM (SRAM).

Storage 2514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 2514 may include technology to increase the storage performance enhanced protection for valuable digital media when multiple hard drives are included, for example.

Image signal processor 2517 may be implemented as a specialized digital signal processor or the like used for image processing. In some examples, image signal processor 2517 may be implemented based on a single instruction multiple data or multiple instruction multiple data architecture or the like. In some examples, image signal processor 2517 may be characterized as a media processor. As discussed herein, image signal processor 2517 may be implemented based on a system on a chip architecture and/or based on a multi-core architecture.

Graphics subsystem 2515 may perform processing of images such as still or video for display. Graphics subsystem 2515 may be a graphics processing unit (GPU) or a visual processing unit (VPU), for example. An analog or digital interface may be used to communicatively couple graphics subsystem 2515 and display 2520. For example, the interface may be any of a High-Definition Multimedia Interface, DisplayPort, wireless HDMI, and/or wireless HD compliant techniques. Graphics subsystem 2515 may be integrated into processor 2510 or chipset 2505. In some implementations, graphics subsystem 2515 may be a stand-alone device communicatively coupled to chipset 2505.

The image and/or video processing techniques described herein may be implemented in various hardware architectures. For example, image and/or video functionality may be integrated within a chipset. Alternatively, a discrete graphics and/or video processor may be used. As still another implementation, the image and/or video functions may be provided by a general purpose processor, including a multi-core processor. In further embodiments, the functions may be implemented in a consumer electronics device.

Radio 2518 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 2518 may operate in accordance with one or more applicable standards in any version.

In various implementations, display 2520 may include any television type monitor or display. Display 2520 may include, for example, a computer display screen, touch screen display, video monitor, television-like device, and/or a television. Display 2520 may be digital and/or analog. In various implementations, display 2520 may be a holographic display. Also, display 2520 may be a transparent surface that may receive a visual projection. Such projections may convey various forms of information, images, and/or objects. For example, such projections may be a visual overlay for a mobile augmented reality (MAR) application. Under the control of one or more software applications 2516, platform 2502 may display user interface 2522 on display 2520.

In various implementations, content services device(s) 2530 may be hosted by any national, international and/or independent service and thus accessible to platform 2502 via the Internet, for example. Content services device(s) 2530 may be coupled to platform 2502 and/or to display 2520. Platform 2502 and/or content services device(s) 2530 may be coupled to a network 2560 to communicate (e.g., send and/or receive) media information to and from network 2560. Content delivery device(s) 2540 also may be coupled to platform 2502 and/or to display 2520.

Image sensors 2519 may include any suitable image sensors that may provide image data based on a scene. For example, image sensors 2519 may include a semiconductor charge coupled device (CCD) based sensor, a complimentary metal-oxide-semiconductor (CMOS) based sensor, an N-type metal-oxide-semiconductor (NMOS) based sensor, or the like. For example, image sensors 2519 may include any device that may detect information of a scene to generate image data.

In various implementations, content services device(s) 2530 may include a cable television box, personal computer, network, telephone, Internet enabled devices or appliance capable of delivering digital information and/or content, and any other similar device capable of uni-directionally or bi-directionally communicating content between content providers and platform 2502 and/display 2520, via network 2560 or directly. It will be appreciated that the content may be communicated uni-directionally and/or bi-directionally to and from any one of the components in system 2500 and a content provider via network 2560. Examples of content may include any media information including, for example, video, music, medical and gaming information, and so forth.

Content services device(s) 2530 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 2502 may receive control signals from navigation controller 2550 having one or more navigation features. The navigation features of navigation controller 2550 may be used to interact with user interface 2522, for example. In various embodiments, navigation controller 2550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 2550 may be replicated on a display (e.g., display 2520) by movements of a pointer, cursor, focus ring, or other visual indicators displayed on the display. For example, under the control of software applications 2516, the navigation features located on navigation controller 2550 may be mapped to virtual navigation features displayed on user interface 2522, for example. In various embodiments, navigation controller 2550 may not be a separate component but may be integrated into platform 2502 and/or display 2520. The present disclosure, however, is not limited to the elements or in the context shown or described herein.

In various implementations, drivers (not shown) may include technology to enable users to instantly turn on and off platform 2502 like a television with the touch of a button after initial boot-up, when enabled, for example. Program logic may allow platform 2502 to stream content to media adaptors or other content services device(s) 2530 or content delivery device(s) 2540 even when the platform is turned “off.” In addition, chipset 2505 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 2500 may be integrated. For example, platform 2502 and content services device(s) 2530 may be integrated, or platform 2502 and content delivery device(s) 2540 may be integrated, or platform 2502, content services device(s) 2530, and content delivery device(s) 2540 may be integrated, for example. In various embodiments, platform 2502 and display 2520 may be an integrated unit. Display 2520 and content service device(s) 2530 may be integrated, or display 2520 and content delivery device(s) 2540 may be integrated, for example. These examples are not meant to limit the present disclosure.

In various embodiments, system 2500 may be implemented as a wireless system, a wired system, or a combination of both. When implemented as a wireless system, system 2500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 2500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 2502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 25.

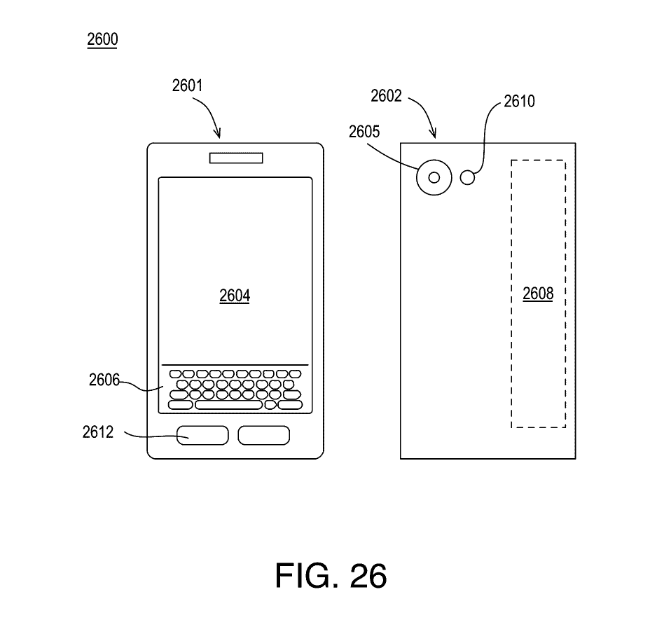

As described above, system 2500 may be embodied in varying physical styles or form factors. FIG. 26 illustrates an example small form factor device 2600, arranged in accordance with at least some implementations of the present disclosure. In some examples, system 2500 may be implemented via device 2600. In various embodiments, for example, device 2600 may be implemented as a mobile computing device having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 26, device 2600 may include a housing with a front 2601 and a back 2602. Device 2600 includes a display 2604, an input/output (I/O) device 2606, and an integrated antenna 2608. Device 2600 also may include navigation features 2611. I/O device 2606 may include any suitable I/O device for entering information into a mobile computing device. Examples for I/O device 2606 may include an alphanumeric keyboard, a numeric keypad, a touch pad, input keys, buttons, switches, microphones, speakers, voice recognition device and software, and so forth. Information also may be entered into device 2600 by way of microphone (not shown), or may be digitized by a voice recognition device. As shown, device 2600 may include a camera 2605 (e.g., including a lens, an aperture, and an imaging sensor) and a flash 2610 integrated into back 2602 (or elsewhere) of device 2600. In other examples, camera 2605 and/or flash 2610 may be integrated into front 2601 of device 2600 and/or additional cameras (e.g., such that device 2600 has front and back cameras) may be provided.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one or more first embodiments, a computer-implemented method for image or video coding comprises receiving an original image, frame, or block of a frame for intra coding, partitioning the original image, frame, or block into a plurality of transform partitions including at least a square partition and a rectangular partition, and performing an adaptive parametric transform or an adaptive hybrid parametric transform on at least a first transform partition of the plurality of transform partitions and a discrete cosine transform on at least a second transform partition of the plurality of transform partitions to produce corresponding first and second transform coefficient partitions, wherein the adaptive parametric transform or the adaptive hybrid parametric transform comprises a base matrix derived from decoded pixels neighboring the first transform partition.

Further to the first embodiments, the first transform partition comprises a partition size that is within a small partition size subset of available partition sizes and the second transform partition has a partition size that is within the available partition sizes.

Further to the first embodiments, the first transform partition has a size of 4×4 pixels, 8×4 pixels, 4×8 pixels, or 8×8 pixels.

Further to the first embodiments, the first transform partition has a size not greater than 8×8 pixels and the second transform partition has a size not less than 8×8 pixels.

Further to the first embodiments, the method further comprises quantizing the first and second transform coefficient partitions to produce quantized first and second transform coefficient partitions and scanning and entropy encoding the quantized first and second transform coefficient partitions into a bitstream.

Further to the first embodiments, the method further comprises partitioning the original image, the frame, or the block into a plurality of partitions for prediction including at least a square partition and a rectangular partition.

Further to the first embodiments, the method further comprises partitioning the original image, the frame, or the block into a plurality of partitions for prediction including at least a square partition and a rectangular partition and differencing each of the partitions for prediction with corresponding predicted partitions to generate corresponding prediction difference partitions, wherein the transform partitions comprise partitions of the prediction difference partitions, and wherein the transform partitions are of equal or smaller size with respect to their corresponding prediction difference partitions.

Further to the first embodiments, the transform partitions comprise partitions of the original image, frame, or block.

In one or more second embodiments, a system for image or video coding comprises a memory to store an original image, frame, or block of a frame for intra coding and a processor coupled to the memory, the processor to partition the original image, frame, or block into a plurality of transform partitions including at least a square partition and a rectangular partition and to perform an adaptive parametric transform or an adaptive hybrid parametric transform on at least a first transform partition of the plurality of transform partitions and a discrete cosine transform on at least a second transform partition of the plurality of transform partitions to produce corresponding first and second transform coefficient partitions, wherein the adaptive parametric transform or the adaptive hybrid parametric transform comprises a base matrix derived from decoded pixels neighboring the first transform partition.

Further to the second embodiments, the first transform partition comprises a partition size that is within a small partition size subset of available partition sizes and the second transform partition has a partition size that is within the available partition sizes.

Further to the second embodiments, the processor is further to partition the original image, the frame, or the block into a plurality of partitions for prediction including at least a square partition and a rectangular partition.

Further to the second embodiments, the processor is further to difference each of the partitions for prediction with corresponding predicted partitions to generate corresponding prediction difference partitions, wherein the transform partitions comprise partitions of the prediction difference partitions, and wherein the transform partitions are of equal or smaller size with respect to their corresponding prediction difference partitions.

In one or more third embodiments, a computer-implemented method for image or video decoding comprises receiving a plurality of transform coefficient partitions including at least a square partition and a rectangular partition, performing an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions, wherein the inverse adaptive parametric transform or the inverse adaptive hybrid parametric transform comprises a base matrix derived from decoded pixels neighboring the first transform partition, and generating a decoded image, frame or block based at least in part on the first and second transform partitions.

Further to the third embodiments, the first transform partition comprises a partition size that is within a small partition size subset of available partition sizes and the second transform partition has a partition size that is within the available partition sizes.

Further to the third embodiments, the first transform partition has a size of 4×4 pixels, 8×4 pixels, 4×8 pixels, or 8×8 pixels.

Further to the third embodiments, the first transform partition has a size not greater than 8×8 pixels and the second transform partition has a size not less than 8×8 pixels.

Further to the third embodiments, a plurality of transform partitions comprise the first and second transform partitions and the method further comprises adding each of the transform partitions with corresponding predicted partitions to generate reconstructed partitions, assembling the reconstructed partitions, and performing deblock filtering or de-ringing to the reconstructed partitions to generate a reconstructed frame.

In one or more fourth embodiments, a system for image or video decoding comprises a memory to store a plurality of transform coefficient partitions including at least a square partition and a rectangular partition and a processor coupled to the memory, the processor to perform an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions, wherein the inverse adaptive parametric transform or the inverse adaptive hybrid parametric transform comprises a base matrix derived from decoded pixels neighboring the first transform partition, and to generate a decoded image, frame or block based at least in part on the first and second transform partitions.

Further to the fourth embodiments, the first transform partition comprises a partition size that is within a small partition size subset of available partition sizes and the second transform partition has a partition size that is within the available partition sizes.

Further to the fourth embodiments, the first transform partition has a size of 4×4 pixels, 8×4 pixels, 4×8 pixels, or 8×8 pixels.

Further to the fourth embodiments, the first transform partition has a size not greater than 8×8 pixels and the second transform partition has a size not less than 8×8 pixels.

Further to the fourth embodiments, a plurality of transform partitions comprise the first and second transform partitions and the processor is further to add each of the transform partitions with corresponding predicted partitions to generate reconstructed partitions, assemble the reconstructed partitions, and perform deblock filtering or de-ringing to the reconstructed partitions to generate a reconstructed frame.

In one or more fifth embodiments, a computer-implemented method for image or video coding comprises receiving an original image or frame for intra coding, performing wavelet decomposition on the original image or frame to generate a plurality of subbands of the original image or frame, partitioning a first subband of the plurality of subbands into a plurality of partitions for prediction, differencing each of the partitions for prediction with corresponding predicted partitions to generate corresponding prediction difference partitions, partitioning the prediction difference partitions into a plurality of first transform partitions for transform coding, wherein the first transform partitions are of equal or smaller size with respect to their corresponding prediction difference partitions, and partitioning at least a second subband of the plurality of subbands into a plurality of second transform partitions for transform coding.

Further to the fifth embodiments, the wavelet decomposition comprises wavelet analysis filtering.

Further to the fifth embodiments, the plurality of partitions for prediction comprise at least a square partition and a rectangular partition.

Further to the fifth embodiments, the plurality of first transform partitions comprise at least a square partition and a rectangular partition.

Further to the fifth embodiments, the first subband comprises an LL subband and the second subband comprises at least one of an HL, LH, or HH subband.

Further to the fifth embodiments, the method further comprises transforming a first transform partition of the second transform partitions and scanning coefficients of the transformed first transform partition, wherein when the second subband comprises an HL subband, scanning the coefficients comprises scanning the coefficients in a zigzag pattern from a bottom-left corner to a top-right corner of the transformed first transform partition, when the second subband comprises an LH subband, scanning the coefficients comprises scanning the coefficients in a zigzag pattern from a top-right corner to a bottom-left corner of the transformed first transform partition, and when the second subband comprises an HH subband, scanning the coefficients comprises scanning the coefficients in a zigzag pattern from a bottom-right corner to a top-left corner of the transformed first transform partition.

Further to the fifth embodiments, the first and second subbands have a bit depth of 9 bits when the original image or frame has a bit depth of 8 bits.

Further to the fifth embodiments, the wavelet decomposition filtering comprises fixed wavelet analysis filtering.

Further to the fifth embodiments, the wavelet decomposition comprises adaptive wavelet analysis filtering based on at least one of content characteristics of the original image or frame, a target resolution, or an application parameter comprising a target bitrate.

Further to the fifth embodiments, the wavelet decomposition comprises adaptive wavelet analysis filtering based on at least one of content characteristics of the original image or frame, a target resolution, or an application parameter comprising a target bitrate and the adaptive wavelet analysis filtering comprises selection of a selected wavelet filter set from a plurality of available wavelet filter sets.

Further to the fifth embodiments, the wavelet decomposition comprises adaptive wavelet analysis filtering based on at least one of content characteristics of the original image or frame, a target resolution, or an application parameter comprising a target bitrate and the adaptive wavelet analysis filtering comprises selection of a selected wavelet filter set from a plurality of available wavelet filter sets, and the method further comprises inserting a selected wavelet filter set indicator associated with the selected wavelet filter set for the original image or frame being intra coded, into a bitstream

In one or more sixth embodiments, a system for image or video coding comprises a memory to store an original image or frame for intra coding and a processor coupled to the memory, the processor to receive an original image or frame for intra coding, to perform wavelet decomposition on the original image or frame to generate a plurality of subbands of the original image or frame, to partition a first subband of the plurality of subbands into a plurality of partitions for prediction, to difference each of the partitions for prediction with corresponding predicted partitions to generate corresponding prediction difference partitions, to partition the prediction difference partitions into a plurality of first transform partitions for transform coding, wherein the first transform partitions are of equal or smaller size with respect to their corresponding prediction difference partitions, and to partition at least a second subband of the plurality of subbands into a plurality of second transform partitions for transform coding.

Further to the sixth embodiments, the plurality of partitions for prediction comprise at least a square partition and a rectangular partition.

Further to the sixth embodiments, the plurality of first transform partitions comprise at least a square partition and a rectangular partition.

Further to the sixth embodiments, the processor is further to perform an adaptive parametric or adaptive hybrid parametric transform on at least a first transform partition of the plurality of first transform partitions and a discrete cosine transform on at least a second transform partition of the plurality of first transform partitions, wherein the first transform partition is smaller than the second transform partition, and wherein the adaptive parametric transform or the adaptive hybrid parametric transform comprises a base matrix derived from decoded pixels neighboring the first transform partition.

Further to the sixth embodiments, the processor is further to transforming a first transform partition of the second transform partitions and to scan coefficients of the transformed first transform partition, wherein when the second subband comprises an HL subband, to scan the coefficients comprises to scan the coefficients in a zigzag pattern from a bottom-left corner to a top-right corner of the transformed first transform partition, when the second subband comprises an LH subband, to scan the coefficients comprises to scan the coefficients in a zigzag pattern from a top-right corner to a bottom-left corner of the transformed first transform partition, and when the second subband comprises an HH subband, to scan the coefficients comprises to scan the coefficients in a zigzag pattern from a bottom-right corner to a top-left corner of the transformed first transform partition.

Further to the sixth embodiments, the adaptive wavelet analysis filtering comprises selection of a selected wavelet filter set from a plurality of available wavelet filter sets.

In one or more seventh embodiments, a computer-implemented method for image or video decoding comprises demultiplexing a scalable bitstream to generate a plurality of bitstreams each associated with a subband of a plurality of wavelet subbands, generating a plurality of transform coefficient partitions for a first subband of the plurality of wavelet subbands including at least a square partition and a rectangular partition, performing an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions, and generating a decoded image, frame or block based at least in part on the first and second transform partitions.

Further to the seventh embodiments, the method further comprises decoding the first subband based at least in part on the first and second transform partitions, decoding remaining subbands of the plurality of wavelet subbands, and performing wavelet synthesis filtering on the first and the remaining subbands to generate a reconstructed image or frame.

Further to the seventh embodiments, the method further comprises decoding the first subband based at least in part on the first and second transform partitions, decoding remaining subbands of the plurality of wavelet subbands, and performing wavelet synthesis filtering on the first and the remaining subbands to generate a reconstructed image or frame and the first subband comprises an LL subband and the remaining subbands comprise at least one of an HL, LH, or HH subband.

Further to the seventh embodiments, the adaptive parametric transform or the adaptive hybrid parametric transform comprises a base matrix derived from decoded pixels neighboring the first transform partition.

Further to the seventh embodiments, the wavelet synthesis filtering comprises fixed wavelet synthesis filtering.

Further to the seventh embodiments, the wavelet synthesis filtering comprises adaptive wavelet synthesis filtering based on a selected wavelet filter set indicator in the scalable bitstream and associated with a selected wavelet filter set from a plurality of available wavelet filter sets.

Further to the seventh embodiments, the method further comprises determining an output selection associated with the decoded image, frame, or block, the output selection comprises at least one of low resolution or full resolution, and generating decoded image, frame, or block is responsive to the output selection.

Further to the seventh embodiments, the method further comprises determining an output selection associated with the decoded image, frame, or block, the output selection comprises at least one of low resolution or full resolution, and generating decoded image, frame, or block is responsive to the output selection and the output selection comprises full resolution and generating the decoded image, frame, or block comprises decoding the first and remaining subbands and performing wavelet synthesis filtering on the first and the remaining subbands to generate a reconstructed image or frame.

Further to the seventh embodiments, the method further comprises determining an output selection associated with the decoded image, frame, or block, the output selection comprises at least one of low resolution or full resolution, and generating decoded image, frame, or block is responsive to the output selection, the output selection comprises low resolution and generating the decoded image, frame, or block consists of decoding the first subband.

In one or more eighth embodiments, a system for image or video decoding comprises a memory to store a scalable bitstream and a processor coupled to the memory, the processor to demultiplex the scalable bitstream to generate a plurality of bitstreams each associated with a subband of a plurality of wavelet subbands, to generate a plurality of transform coefficient partitions for a first subband of the plurality of wavelet subbands including at least a square partition and a rectangular partition, to perform an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions, and to generate a decoded image, frame or block based at least in part on the first and second transform partitions.

Further to the eighth embodiments, the processor is further to decode the first subband based at least in part on the first and second transform partitions, to decode remaining subbands of the plurality of wavelet subbands, and to perform wavelet synthesis filtering on the first and the remaining subbands to generate a reconstructed image or frame.

Further to the eighth embodiments, the adaptive parametric transform or the adaptive hybrid parametric transform comprises a base matrix derived from decoded pixels neighboring the first transform partition.

Further to the eighth embodiments, the wavelet synthesis filtering comprises adaptive wavelet synthesis filtering based on a selected wavelet filter set indicator in the scalable bitstream and associated with a selected wavelet filter set from a plurality of available wavelet filter sets.

Further to the eighth embodiments, the processor is further to determine an output selection associated with the decoded image, frame, or block, wherein the output selection comprises at least one of low resolution or full resolution, and wherein generating decoded image, frame, or block is responsive to the output selection.

Further to the eighth embodiments, the processor is further to determine an output selection associated with the decoded image, frame, or block, wherein the output selection comprises at least one of low resolution or full resolution, and wherein generating decoded image, frame, or block is responsive to the output selection, wherein the output selection comprises full resolution and the processor to generate the decoded image, frame, or block comprises the processor to decode the first and remaining subbands and to perform wavelet synthesis filtering on the first and the remaining subbands to generate a reconstructed image or frame.

Further to the eighth embodiments, the processor is further to determine an output selection associated with the decoded image, frame, or block, wherein the output selection comprises at least one of low resolution or full resolution, and wherein generating decoded image, frame, or block is responsive to the output selection, wherein the output selection comprises low resolution and the processor to generate the decoded image, frame, or block consists of the processor to decode the first subband.

In one or more ninth embodiments, a computer-implemented method for video coding comprises receiving a plurality of frames, wherein at least a portion of a frame of the plurality of frames is to be intra coded, determining, for a first frame of the plurality of frames, to perform wavelet decomposition based coding for the first frame and, for a second frame of the plurality of frames, to perform spatial domain based coding for the second frame, partitioning the second frame into a plurality of partitions for prediction, differencing the partitions for prediction with corresponding predicted partitions to generate prediction difference partitions, and partitioning the prediction difference partitions into a plurality of transform partitions, and performing wavelet decomposition on the first frame to generate a plurality of subbands of the first frame, partitioning a first subband of the plurality of subbands into a plurality of second partitions for prediction, differencing the second partitions for prediction with corresponding second predicted partitions to generate second prediction difference partitions, and partitioning the second prediction difference partitions into a plurality of second transform partitions, and partitioning at least a second subband of the plurality of subbands into a plurality of third transform partitions.

Further to the ninth embodiments, the plurality of partitions for prediction comprise at least a square partition and a rectangular partition.

Further to the ninth embodiments, the method further comprises performing an adaptive parametric transform or an adaptive hybrid parametric transform on at least a first transform partition of the plurality of transform partitions and a discrete cosine transform on at least a second transform partition of the plurality of transform partitions, wherein the adaptive parametric transform or the adaptive hybrid parametric transform comprises a base matrix derived from decoded pixels neighboring the first transform partition.

Further to the ninth embodiments, the method further comprises performing an adaptive parametric transform or an adaptive hybrid parametric transform on at least a first transform partition of the plurality of transform partitions and a discrete cosine transform on at least a second transform partition of the plurality of transform partitions, wherein the adaptive parametric transform or the adaptive hybrid parametric transform comprises a base matrix derived from decoded pixels neighboring the first transform partition, wherein the first transform partition is smaller than the second transform partition.

Further to the ninth embodiments, the plurality of transform partitions comprise at least a square partition and a rectangular partition.

Further to the ninth embodiments, the method further comprises determining, for a third frame of the plurality of intra frames, to perform hybrid wavelet analysis filter and spatial domain based coding for the third frame.

Further to the ninth embodiments, the method further comprises determining, for a third frame of the plurality of intra frames, to perform hybrid wavelet analysis filter and spatial domain based coding for the third frame and partitioning a first tile or block of the third frame into a plurality of third partitions for prediction, differencing the third partitions for prediction with associated third predicted partitions to generate third prediction difference partitions, and partitioning the third prediction difference partitions into a plurality of third transform partitions.

Further to the ninth embodiments, the method further comprises determining, for a third frame of the plurality of intra frames, to perform hybrid wavelet analysis filter and spatial domain based coding for the third frame and performing wavelet decomposition on a first tile or block of the third frame to generate a second plurality of subbands, partitioning a first subband of the second plurality of subbands into a plurality of third partitions for prediction, differencing the third partitions for prediction with associated third predicted partitions to generate third prediction difference partitions, and partitioning the third prediction difference partitions into a plurality of third transform partitions, and partitioning at least a second subband of the second plurality of subbands into a plurality of fourth transform partitions.

Further to the ninth embodiments, the method further comprises determining, for a third frame of the plurality of intra frames, to perform hybrid wavelet analysis filter and spatial domain based coding for the third frame and performing wavelet decomposition on a first tile or block of the third frame to generate a second plurality of subbands, partitioning a first subband of the second plurality of subbands into a plurality of third partitions for prediction, differencing the third partitions for prediction with associated third predicted partitions to generate third prediction difference partitions, and partitioning the third prediction difference partitions into a plurality of third transform partitions, and partitioning at least a second subband of the second plurality of subbands into a plurality of fourth transform partitions, wherein the wavelet decomposition on the first tile or block comprises adaptive wavelet analysis filtering.

Further to the ninth embodiments, the wavelet decomposition comprises adaptive wavelet analysis filtering based on at least one of content characteristics of the first frame, a target bitrate, or an application parameter comprising a target bitrate.

Further to the ninth embodiments, the wavelet decomposition comprises adaptive wavelet analysis filtering based on at least one of content characteristics of the first frame, a target bitrate, or an application parameter comprising a target bitrate and the adaptive wavelet analysis filtering comprises selection of a selected wavelet filter set from a plurality of available wavelet filter sets.

In one or more tenth embodiments, a system for video coding comprises a memory to store a plurality of frames, wherein at least a portion of a frame of the plurality of frames is to be intra coded and a processor coupled to the memory, the processor to determine to perform wavelet decomposition based coding for a first frame of the plurality of frames and to perform spatial domain based coding for a second frame of the plurality of frames, to partition the second frame into a plurality of partitions for prediction, to difference the partitions for prediction with corresponding predicted partitions to generate prediction difference partitions, and to partition the prediction difference partitions into a plurality of transform partitions, and to perform wavelet decomposition on the first frame to generate a plurality of subbands of the first frame, to partition a first subband of the plurality of subbands into a plurality of second partitions for prediction, to difference the second partitions for prediction with corresponding second predicted partitions to generate second prediction difference partitions, and to partition the second prediction difference partitions into a plurality of second transform partitions, and to partition at least a second subband of the plurality of subbands into a plurality of third transform partitions.

Further to the tenth embodiments, the processor is further to perform an adaptive parametric transform or an adaptive hybrid parametric transform on at least a first transform partition of the plurality of transform partitions and a discrete cosine transform on at least a second transform partition of the plurality of transform partitions, wherein the adaptive parametric transform or the adaptive hybrid parametric transform comprises a base matrix derived from decoded pixels neighboring the first transform partition.

Further to the tenth embodiments, the processor is further to determine, for a third frame of the plurality of intra frames, to perform hybrid wavelet analysis filter and spatial domain based coding for the third frame.

Further to the tenth embodiments, the processor is further to determine, for a third frame of the plurality of intra frames, to perform hybrid wavelet analysis filter and spatial domain based coding for the third frame and to partition a first tile or block of the third frame into a plurality of third partitions for prediction, to difference the third partitions for prediction with associated third predicted partitions to generate third prediction difference partitions, and to partition the third prediction difference partitions into a plurality of third transform partitions.

Further to the tenth embodiments, the processor is further to determine, for a third frame of the plurality of intra frames, to perform hybrid wavelet analysis filter and spatial domain based coding for the third frame and to perform wavelet decomposition on a first tile or block of the third frame to generate a second plurality of subbands, to partition a first subband of the second plurality of subbands into a plurality of third partitions for prediction, to difference the third partitions for prediction with associated third predicted partitions to generate third prediction difference partitions, and to partition the third prediction difference partitions into a plurality of third transform partitions, and to partition at least a second subband of the second plurality of subbands into a plurality of fourth transform partitions.

Further to the tenth embodiments, the processor is further to determine, for a third frame of the plurality of intra frames, to perform hybrid wavelet analysis filter and spatial domain based coding for the third frame and to perform wavelet decomposition on a first tile or block of the third frame to generate a second plurality of subbands, to partition a first subband of the second plurality of subbands into a plurality of third partitions for prediction, to difference the third partitions for prediction with associated third predicted partitions to generate third prediction difference partitions, and to partition the third prediction difference partitions into a plurality of third transform partitions, and to partition at least a second subband of the second plurality of subbands into a plurality of fourth transform partitions, wherein the wavelet decomposition on the first tile or block comprises adaptive wavelet analysis filtering.

In one or more eleventh embodiments, a computer-implemented method for video decoding comprises demultiplexing a bitstream into a plurality of bitstreams including a plurality of first bitstreams corresponding to a first frame, wherein each of the first bitstreams are associated with a subband of a plurality of wavelet subbands, and a second bitstream corresponding to a second frame, wherein the second bitstream is a spatial domain based coding bitstream, decoding the plurality of first bitstreams to generate the plurality of wavelet subbands, preforming wavelet synthesis filtering on the plurality of wavelet subbands to reconstruct the first frame, and reconstructing the second frame using spatial domain based decoding.

Further to the eleventh embodiments, the plurality of partitions for prediction comprise at least a square partition and a rectangular partition.

Further to the eleventh embodiments, the method further comprises reconstructing a third frame based on hybrid wavelet synthesis filter and spatial domain based coding for the third frame.

Further to the eleventh embodiments, the method further comprises reconstructing a third frame based on hybrid wavelet synthesis filter and spatial domain based coding for the third frame and generating a second plurality of subbands for a first tile or block of the third frame and performing wavelet synthesis filtering on the second plurality of subbands to generate at least a portion of the third frame.

Further to the eleventh embodiments, the method further comprises reconstructing a third frame based on hybrid wavelet synthesis filter and spatial domain based coding for the third frame and generating a second plurality of subbands for a first tile or block of the third frame and performing wavelet synthesis filtering on the second plurality of subbands to generate at least a portion of the third frame, wherein the wavelet synthesis filtering of the first tile or block comprises adaptive wavelet analysis filtering.

In one or more twelfth embodiments, a system for image or video decoding comprises a memory to store a bitstream and a processor coupled to the memory, the processor to demultiplex the bitstream into a plurality of bitstreams including a plurality of first bitstreams corresponding to a first frame, wherein each of the first bitstreams are associated with a subband of a plurality of wavelet subbands, and a second bitstream corresponding to a second frame, wherein the second bitstream is a spatial domain based coding bitstream, to decode the plurality of first bitstreams to generate the plurality of wavelet subbands, to preform wavelet synthesis filtering on the plurality of wavelet subbands to reconstruct the first frame, and to reconstruct the second frame using spatial domain based decoding.

Further to the twelfth embodiments, the processor is further to reconstruct a third frame based on hybrid wavelet synthesis filter and spatial domain based coding for the third frame.

Further to the twelfth embodiments, the processor is further to reconstruct a third frame based on hybrid wavelet synthesis filter and spatial domain based coding for the third frame and to generate a second plurality of subbands for a first tile or block of the third frame and to perform wavelet synthesis filtering on the second plurality of subbands to generate at least a portion of the third frame.

Further to the twelfth embodiments, the processor is further to reconstruct a third frame based on hybrid wavelet synthesis filter and spatial domain based coding for the third frame and to generate a second plurality of subbands for a first tile or block of the third frame and to perform wavelet synthesis filtering on the second plurality of subbands to generate at least a portion of the third frame, wherein the wavelet synthesis filtering of the first tile or block comprises adaptive wavelet analysis filtering.

In one or more thirteenth embodiments, at least one machine readable medium may include a plurality of instructions that, in response to being executed on a computing device, cause the computing device to perform a method according to any one of the above embodiments.

In one or more fourteenth embodiments, an apparatus or a system may include means for performing a method or any functions according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A computer-implemented method for image or video coding comprising:
receiving an original image, frame, or block of a frame for intra coding;
partitioning the original image, frame, or block into a plurality of transform partitions including at least a square partition and a rectangular partition; and
performing an adaptive parametric transform or an adaptive hybrid parametric transform on at least a first transform partition of the plurality of transform partitions and a discrete cosine transform on at least a second transform partition of the plurality of transform partitions to produce corresponding first and second transform coefficient partitions, wherein the adaptive parametric transform or the adaptive hybrid parametric transform comprises a base matrix derived from decoded pixels neighboring the first transform partition.

2. The method of claim 1, wherein the first transform partition comprises a partition size that is within a small partition size subset of available partition sizes and the second transform partition has a partition size that is within the available partition sizes.

3. The method of claim 1, wherein the first transform partition has a size of 4×4 pixels, 8×4 pixels, 4×8 pixels, or 8×8 pixels.

4. The method of claim 1, wherein the first transform partition has a size not greater than 8×8 pixels and the second transform partition has a size not less than 8×8 pixels.

5. The method of claim 1, further comprising:
quantizing the first and second transform coefficient partitions to produce quantized first and second transform coefficient partitions; and
scanning and entropy encoding the quantized first and second transform coefficient partitions into a bitstream.

6. The method of claim 1, further comprising:
partitioning the original image, the frame, or the block into a plurality of partitions for prediction including at least a square partition and a rectangular partition.

7. The method of claim 6, further comprising:
differencing each of the partitions for prediction with corresponding predicted partitions to generate corresponding prediction difference partitions, wherein the transform partitions comprise partitions of the prediction difference partitions, and wherein the transform partitions are of equal or smaller size with respect to their corresponding prediction difference partitions.

8. The method of claim 1, wherein the transform partitions comprise partitions of the original image, frame, or block.

9. At least one machine readable medium comprising a plurality of instructions that, in response to being executed on a device, cause the device to perform image or video coding by:
receiving an original image, frame, or block of a frame for intra coding;
partitioning the original image, frame, or block into a plurality of transform partitions including at least a square partition and a rectangular partition; and
performing an adaptive parametric transform or an adaptive hybrid parametric transform on at least a first transform partition of the plurality of transform partitions and a discrete cosine transform on at least a second transform partition of the plurality of transform partitions to produce corresponding first and second transform coefficient partitions, wherein the adaptive parametric transform or the adaptive hybrid parametric transform comprises a base matrix derived from decoded pixels neighboring the first transform partition.

10. The machine readable medium of claim 9, wherein the first transform partition comprises a partition size that is within a small partition size subset of available partition sizes and the second transform partition has a partition size that is within the available partition sizes.

11. The machine readable medium of claim 9, wherein the first transform partition has a size of 4×4 pixels, 8×4 pixels, 4×8 pixels, or 8×8 pixels.

12. The machine readable medium of claim 9, wherein the first transform partition has a size not greater than 8×8 pixels and the second transform partition has a size not less than 8×8 pixels.

13. The machine readable medium of claim 9, further comprising instructions that, in response to being executed on the device, cause the device to perform image or video coding by:
quantizing the first and second transform coefficient partitions to produce quantized first and second transform coefficient partitions; and
scanning and entropy encoding the quantized first and second transform coefficient partitions into a bitstream.

14. The machine readable medium of claim 9, further comprising instructions that, in response to being executed on the device, cause the device to perform image or video coding by:
partitioning the original image, the frame, or the block into a plurality of partitions for prediction including at least a square partition and a rectangular partition.

15. The machine readable medium of claim 14, further comprising instructions that, in response to being executed on the device, cause the device to perform image or video coding by:
differencing each of the partitions for prediction with corresponding predicted partitions to generate corresponding prediction difference partitions, wherein the transform partitions comprise partitions of the prediction difference partitions, and wherein the transform partitions are of equal or smaller size with respect to their corresponding prediction difference partitions.

16. The machine readable medium of claim 9, wherein the transform partitions comprise partitions of the original image, frame, or block.

17. A computer-implemented method for image or video decoding comprising:
receiving a plurality of transform coefficient partitions including at least a square partition and a rectangular partition;
performing an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions, wherein the inverse adaptive parametric transform or the inverse adaptive hybrid parametric transform comprises a base matrix derived from decoded pixels neighboring the first transform partition; and
generating a decoded image, frame or block based at least in part on the first and second transform partitions.

18. The method of claim 17, wherein the first transform partition comprises a partition size that is within a small partition size subset of available partition sizes and the second transform partition has a partition size that is within the available partition sizes.

19. The method of claim 17, wherein the first transform partition has a size of 4×4 pixels, 8×4 pixels, 4×8 pixels, or 8×8 pixels.

20. The method of claim 17, wherein the first transform partition has a size not greater than 8×8 pixels and the second transform partition has a size not less than 8×8 pixels.

21. The method of claim 17, wherein a plurality of transform partitions comprise the first and second transform partitions, the method further comprising:
adding each of the transform partitions with corresponding predicted partitions to generate reconstructed partitions;
assembling the reconstructed partitions; and
performing deblock filtering or de-ringing to the reconstructed partitions to generate a reconstructed frame.

22. A system for image or video decoding comprising:
a memory to store a plurality of transform coefficient partitions including at least a square partition and a rectangular partition; and
a processor coupled to the memory, the processor to perform an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions, wherein the inverse adaptive parametric transform or the inverse adaptive hybrid parametric transform comprises a base matrix derived from decoded pixels neighboring the first transform partition, and to generate a decoded image, frame or block based at least in part on the first and second transform partitions.

23. The system of claim 22, wherein the first transform partition comprises a partition size that is within a small partition size subset of available partition sizes and the second transform partition has a partition size that is within the available partition sizes.

24. The system of claim 22, wherein the first transform partition has a size of 4×4 pixels, 8×4 pixels, 4×8 pixels, or 8×8 pixels.

25. The system of claim 22, wherein the first transform partition has a size not greater than 8×8 pixels and the second transform partition has a size not less than 8×8 pixels.

26. The system of claim 22, wherein a plurality of transform partitions comprise the first and second transform partitions, and wherein the processor is further to add each of the transform partitions with corresponding predicted partitions to generate reconstructed partitions, assemble the reconstructed partitions, and perform deblock filtering or de-ringing to the reconstructed partitions to generate a reconstructed frame.

27. A computer-implemented method for image or video coding comprising:
receiving an original image or frame for intra coding;
performing wavelet decomposition on the original image or frame to generate a plurality of subbands of the original image or frame;
partitioning a first subband of the plurality of subbands into a plurality of partitions for prediction;
differencing each of the partitions for prediction with corresponding predicted partitions to generate corresponding prediction difference partitions;
partitioning the prediction difference partitions into a plurality of first transform partitions for transform coding, wherein the first transform partitions are of equal or smaller size with respect to their corresponding prediction difference partitions; and
partitioning at least a second subband of the plurality of subbands into a plurality of second transform partitions for transform coding.

28. The method of claim 27, wherein the wavelet decomposition comprises wavelet analysis filtering.

29. The method of claim 27, wherein the plurality of partitions for prediction comprise at least a square partition and a rectangular partition.

30. The method of claim 27, wherein the plurality of first transform partitions comprise at least a square partition and a rectangular partition.

31. The method of claim 27, wherein the first subband comprises an LL subband and the second subband comprises at least one of an HL, LH, or HH subband.

32. The method of claim 27, further comprising:
performing an adaptive parametric or adaptive hybrid parametric transform on at least a first transform partition of the plurality of first transform partitions and a discrete cosine transform on at least a second transform partition of the plurality of first transform partitions, wherein the first transform partition is smaller than the second transform partition, and wherein the adaptive parametric transform or the adaptive hybrid parametric transform comprises a base matrix derived from decoded pixels neighboring the first transform partition.

33. The method of claim 27, wherein the first and second subbands have a bit depth of 9 bits when the original image or frame has a bit depth of 8 bits.

34. The method of claim 27, wherein the wavelet decomposition filtering comprises fixed wavelet analysis filtering.

35. The method of claim 27, further comprising:
transforming a first transform partition of the second transform partitions; and
scanning coefficients of the transformed first transform partition, wherein:
when the second subband comprises an HL subband, scanning the coefficients comprises scanning the coefficients in a zigzag pattern from a bottom-left corner to a top-right corner of the transformed first transform partition,
when the second subband comprises an LH subband, scanning the coefficients comprises scanning the coefficients in a zigzag pattern from a top-right corner to a bottom-left corner of the transformed first transform partition, and
when the second subband comprises an HH subband, scanning the coefficients comprises scanning the coefficients in a zigzag pattern from a bottom-right corner to a top-left corner of the transformed first transform partition.

36. The method of claim 27, wherein the wavelet decomposition comprises adaptive wavelet analysis filtering based on at least one of content characteristics of the original image or frame, a target resolution, or an application parameter comprising a target bitrate.

37. The method of claim 36, wherein the adaptive wavelet analysis filtering comprises selection of a selected wavelet filter set from a plurality of available wavelet filter sets.

38. The method of claim 37, further comprising:
inserting a selected wavelet filter set indicator associated with the selected wavelet filter set for the original image or frame being intra coded, into a bitstream.

39. At least one machine readable medium comprising a plurality of instructions that, in response to being executed on a device, cause the device to perform image or video coding by:
receiving an original image or frame for intra coding;
performing wavelet decomposition on the original image or frame to generate a plurality of subbands of the original image or frame;
partitioning a first subband of the plurality of subbands into a plurality of partitions for prediction;
differencing each of the partitions for prediction with corresponding predicted partitions to generate corresponding prediction difference partitions;
partitioning the prediction difference partitions into a plurality of first transform partitions for transform coding, wherein the first transform partitions are of equal or smaller size with respect to their corresponding prediction difference partitions; and
partitioning at least a second subband of the plurality of subbands into a plurality of second transform partitions for transform coding.

40. The machine readable medium of claim 39, wherein the plurality of partitions for prediction comprise at least a square partition and a rectangular partition.

41. The machine readable medium of claim 39, wherein the plurality of first transform partitions comprise at least a square partition and a rectangular partition.

42. The machine readable medium of claim 39, further comprising instructions that, in response to being executed on the device, cause the device to perform image or video coding by:
performing an adaptive parametric or adaptive hybrid parametric transform on at least a first transform partition of the plurality of first transform partitions and a discrete cosine transform on at least a second transform partition of the plurality of first transform partitions, wherein the first transform partition is smaller than the second transform partition, and wherein the adaptive parametric transform or the adaptive hybrid parametric transform comprises a base matrix derived from decoded pixels neighboring the first transform partition.

43. The machine readable medium of claim 39, further comprising instructions that, in response to being executed on the device, cause the device to perform image or video coding by:
transforming a first transform partition of the second transform partitions; and
scanning coefficients of the transformed first transform partition, wherein:
when the second subband comprises an HL subband, scanning the coefficients comprises scanning the coefficients in a zigzag pattern from a bottom-left corner to a top-right corner of the transformed first transform partition,
when the second subband comprises an LH subband, scanning the coefficients comprises scanning the coefficients in a zigzag pattern from a top-right corner to a bottom-left corner of the transformed first transform partition, and
when the second subband comprises an HH subband, scanning the coefficients comprises scanning the coefficients in a zigzag pattern from a bottom-right corner to a top-left corner of the transformed first transform partition.

44. The machine readable medium of claim 39, wherein the adaptive wavelet analysis filtering comprises selection of a selected wavelet filter set from a plurality of available wavelet filter sets.

45. A computer-implemented method for image or video decoding comprising:
demultiplexing a scalable bitstream to generate a plurality of bitstreams each associated with a subband of a plurality of wavelet subbands;
generating a plurality of transform coefficient partitions for a first subband of the plurality of wavelet subbands including at least a square partition and a rectangular partition;
performing an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions; and
generating a decoded image, frame or block based at least in part on the first and second transform partitions.

46. The method of claim 45, further comprising:
decoding the first subband based at least in part on the first and second transform partitions;
decoding remaining subbands of the plurality of wavelet subbands; and
performing wavelet synthesis filtering on the first and the remaining subbands to generate a reconstructed image or frame.

47. The method of claim 46, wherein the first subband comprises an LL subband and the remaining subbands comprise at least one of an HL, LH, or HH subband.

48. The method of claim 45, wherein the adaptive parametric transform or the adaptive hybrid parametric transform comprises a base matrix derived from decoded pixels neighboring the first transform partition.

49. The method of claim 45, wherein the wavelet synthesis filtering comprises fixed wavelet synthesis filtering.

50. The method of claim 45, wherein the wavelet synthesis filtering comprises adaptive wavelet synthesis filtering based on a selected wavelet filter set indicator in the scalable bitstream and associated with a selected wavelet filter set from a plurality of available wavelet filter sets.

51. The method of claim 45, further comprising:
determining an output selection associated with the decoded image, frame, or block, wherein the output selection comprises at least one of low resolution or full resolution, and wherein generating decoded image, frame, or block is responsive to the output selection.

52. The method of claim 51, wherein the output selection comprises full resolution and generating the decoded image, frame, or block comprises:
decoding the first and remaining subbands; and
performing wavelet synthesis filtering on the first and the remaining subbands to generate a reconstructed image or frame.

53. The method of claim 51, wherein the output selection comprises low resolution and generating the decoded image, frame, or block consists of decoding the first subband.

54. A system for image or video decoding comprising:
a memory to store a scalable bitstream; and
a processor coupled to the memory, the processor to demultiplex the scalable bitstream to generate a plurality of bitstreams each associated with a subband of a plurality of wavelet subbands, to generate a plurality of transform coefficient partitions for a first subband of the plurality of wavelet subbands including at least a square partition and a rectangular partition, to perform an inverse adaptive parametric transform or an inverse adaptive hybrid parametric transform on at least a first transform coefficient partition of the plurality of transform partitions and an inverse discrete cosine transform on at least a second transform coefficient partition of the plurality of transform partitions to produce corresponding first and second transform partitions, and to generate a decoded image, frame or block based at least in part on the first and second transform partitions.

55. The system of claim 54, wherein the processor is further to decode the first subband based at least in part on the first and second transform partitions, to decode remaining subbands of the plurality of wavelet subbands, and to perform wavelet synthesis filtering on the first and the remaining subbands to generate a reconstructed image or frame.

56. The system of claim 54, wherein the adaptive parametric transform or the adaptive hybrid parametric transform comprises a base matrix derived from decoded pixels neighboring the first transform partition.

57. The system of claim 54, wherein the wavelet synthesis filtering comprises adaptive wavelet synthesis filtering based on a selected wavelet filter set indicator in the scalable bitstream and associated with a selected wavelet filter set from a plurality of available wavelet filter sets.

58. The system of claim 54, wherein the processor is further to determine an output selection associated with the decoded image, frame, or block, wherein the output selection comprises at least one of low resolution or full resolution, and wherein generating decoded image, frame, or block is responsive to the output selection.

59. The system of claim 58, wherein the output selection comprises full resolution and the processor to generate the decoded image, frame, or block comprises the processor to decode the first and remaining subbands and to perform wavelet synthesis filtering on the first and the remaining subbands to generate a reconstructed image or frame.

60. The system of claim 58, wherein the output selection comprises low resolution and the processor to generate the decoded image, frame, or block consists of the processor to decode the first subband.
